(19) United States
(12) Patent Application Publication
(10) Pub. No.: US 2004/0186765 A1
(43) Pub. Date: Sep. 23, 2004

(54) Business profit improvement support system

(76) Inventor: Isaburou Kataoka, Tokyo (JP)

Correspondence Address: BURNS DOANE SWECKER & MATHIS L L P, POST OFFICE BOX 1404, ALEXANDRIA, VA, 22313-1404, US

(21) Appl. No.: 10/480,993

(22) PCT Filed: Oct. 24, 2002
(86) PCT No.: PCT/JP02/11049

(30) Foreign Application Priority Data
Mar. 22, 2002 (WO) PCT/JP02/02746

(51) Int. Cl. G06F 17/60

(52) U.S. Cl. 705/10

(57) ABSTRACT

A business profit improvement support system, which prompts a user to perform a market analysis evaluation of business and supports profit improvement of the business, comprises an input part for inputting prescribed information, a processing part for calculating a value of a prescribed parameter based on the prescribed information inputted by the input part and determining a ranking of the prescribed parameter based on the value calculated, and a display part for prompting the user to input the prescribed information by the input part, displaying the ranking of the prescribed parameter determined by the processing part in a graph, and prompting the user to perform the market analysis evaluation of the business.

### TECHNICAL FIELD

The present invention relates to making a structure (method and procedure) of a company aiming at business profit improvement and continuous business development. The present invention relates to an integrated system of intrafirm basic business, and a basic business system of interfirm transactions. The present invention relates to a support system for a reform of product producing business.

### BACKGROUND ART

Conventionally, business profit improvement in a company has been in a form responsive to the flow of the economic growth period, based on an original technology and know-how of each company. Moreover, since such improvement became a model not opened to the public, it has been difficult to perform analysis, adjustment, and support, from the outside, for an evaluation and an assessment of the model. Although there is only open data as the one concerning a profit-and-loss management or a balance sheet, it is just a result of activities having been practiced, and it could not be a business analysis activity based on real time data. Therefore, this has been revealed in a remarkable form of sudden “bankruptcy” called a business failure, at present.

Meanwhile, as the employment market has become rather liquid, it is required to make a structure which can develop individuality and also contribute to a business profit. However, actually, it is important to recognize there is a big wall between “understanding what should be done” and “carrying it out effectively”, and to make a structure by which people and an organization can be properly, speedily, and certainly moved towards the execution.

As long as each company executes a business profit improvement by a self-righteous and random method (the method used in the growing economy period), it is impossible for the company to survive in a global and maturing economy period.

In the conventional growing economy period, even if management was performed directing its attention to only sales volume, it was possible to overcome a critical situation such as a debt default. However, in the mature economy period like today, it becomes a severe environment where companies are discriminated between winners indicating only a handful of companies to be survived and losers indicating a large number of companies to be screened out. In order to win competitions and to maintain business, an analysis and a strategy for winning and an activity for carrying out the strategy are needed. Thus, it becomes the most important issue to make a structure which can perform business transformation and reproduction instantly responsive to a hot market change.

Particularly, presuming that the global competition in the twenty-first century depends upon “superiority or inferiority in intellectual productivity”, it is required to make an environment where the management centering on “people” is shifted to the management centering on “structure”, and where, on the basis of the structure aiming at the profit growth, people concentrate on polishing wisdom, knowledge, and technology for the purpose of creating a value which produces a profit.

In the conventional intrafirm basic business systems, most of them utilize a system peculiar to each company by utilizing a host computer or a package software (ERP) on the market.

In the conventional basic business system utilizing the host computer, when reacting to various needs, there are a lot of obstacles in development costs and development period. In the system utilizing the package software on the market, it is required to correctly understand the structure based on the culture where the software is born. Therefore, human resources and time are needed for applying this system. In addition, customizing operation is necessary for needs outside the standard, and a huge amount of expense is needed for a suitable development.

Thus, existing systems have the method of performing development based on a certain specific business, and applying and expanding the developed one, as a basis, to a basic business of wide area. Accordingly, it is not easy to make a customer know the structure of the whole of the basic business, and it is difficult for the customer to understand the structure in a short time and freely add and construct needs.

It is the first object of the present invention to realize a system of projecting a suitable plan for various business activities, measuring a performance based on actual result management in order to achieve the plan, and effectively and efficiently performing business cooperation under a consistent plan management from the upper flow to the lower flow.

It is the second object to provide a system of seeking an object of various business activities, i.e. “something”, in product composition management models, and structuring various plan management with making the product composition management model as a core.

It is the third object to provide a system, in promoting business, of making activities of “annual•plan management” of the upper flow through “equipment operation•plan management” of the lower flow cooperated in a consistent form, and connecting them to an effective activity in real time, under recognizing a difference of actual result information based on the plan data.

It is the fourth object to structure a flexible system in which a data item to be managed can be arbitrarily selected and registered by properly defining an item of various activities and management data, for each of various plan management, in order not to depend on forced data items.

It is the fifth object to cooperate with a management model of the top rank, to regard “gross profit growth (improvement) and cash flow CF improvement” as an action idea for “aiming at continuous profit growth” which is a common target in management models, and to reflect concrete measures and activities in management data in real time, as an actual result directly linking to the improvement.

### DISCLOSURE OF THE INVENTION

According to a business profit improvement support system of the present invention, it is a feature that the business profit improvement support system which prompts a user to perform a market analysis evaluation of business and supports profit improvement of the business comprises:

an input part for inputting prescribed information;

a processing part for calculating a value of a prescribed parameter based on the prescribed information inputted by the input part, and determining a ranking of the prescribed parameter based on the value calculated, and

a display part for prompting the user to input the prescribed information by the input part, displaying the ranking of the prescribed parameter determined by the processing part in a graph, and prompting the user to perform the market analysis evaluation of the business.

It is a feature that the prescribed parameter includes, with reference to the business, a competitive dominance degree and a market growth degree.

It is a feature that the prescribed information includes, with reference to the business, ranking information on a sales volume growth degree and ranking information on a profit growth degree, and

the processing part calculates a value of the market growth degree, by using the ranking information on the sales volume growth degree and the ranking information on the profit growth degree and depending upon a prescribed standard, and determines ranking of the market growth degree based on a calculated value.

It is a feature that the prescribed information includes, with reference to the business, ranking information on a plurality of sales volume growth degrees and ranking information on a plurality of profit growth degrees,

the input part inputs ranking information on one sales volume growth degree in the ranking information on the plurality of sales volume growth degrees and ranking information on one profit growth degree in the ranking information on the plurality of profit growth degrees,

the processing part allots a prescribed value to each of the ranking information on the plurality of sales volume growth degrees, the ranking information on the plurality of profit growth degrees, ranking information on each sales volume growth degree in the ranking information on the plurality of sales volume growth degrees, and ranking information on each profit growth degree in the ranking information on the plurality of profit growth degrees respectively,

obtains an added value by adding a multiplied value calculated by multiplying a value allotted to the ranking information on the plurality of sales volume growth degrees by a value allotted to the ranking information on the one sales volume growth degree inputted by the input part, and a multiplied value calculated by multiplying a value allotted to the ranking information on the plurality of profit growth degrees by a value allotted to the ranking information on the one profit growth degree inputted by the input part, and

ranks the market growth degree at a position to which the added value belongs.

It is a feature that the prescribed information includes, with reference to the business, ranking information on a customer evaluation, ranking information on cash flow, and ranking information on a profit improvement rate, and

the processing part calculates a value of the competitive dominance degree by using the ranking information on the customer evaluation, the ranking information on the cash flow, and the ranking information on the profit improvement rate and depending upon a prescribed standard, and determines a ranking of the competitive dominance degree based on a calculated value.

It is a feature that the prescribed information includes, with reference to the business, ranking information on a plurality of customer quality evaluations, ranking information on a plurality of customer costs evaluations, ranking information on a plurality of customer delivery deadline evaluations, ranking information on a plurality of cash flow, and ranking information on a plurality of profit improvement rates,

the input part inputs ranking information on one customer quality evaluation in the ranking information on the plurality of customer quality evaluations, ranking information on one customer costs evaluation in the ranking information on the plurality of customer costs evaluations, ranking information on one customer delivery deadline evaluation in the ranking information on the plurality of customer delivery deadline evaluations, ranking information on one cash flow in the ranking information on the plurality of cash flow and ranking information on one profit improvement rate in the ranking information on the plurality of profit improvement rates, and

the processing part allots a prescribed value to each of the ranking information on the plurality of customer quality evaluations, ranking information on each customer quality evaluation in the ranking information on the plurality of customer quality evaluations, the ranking information on the plurality of customer costs evaluations, ranking information on each customer costs evaluation in the ranking information on the plurality of customer costs evaluations, the ranking information on the plurality of customer delivery deadline evaluations, ranking information on each customer delivery deadline evaluation in the ranking information on the plurality of customer delivery deadline evaluations, the ranking information on the plurality of cash flow, ranking information on each cash flow in the ranking information on the plurality of cash flow, the ranking information on the plurality of profit improvement rates, and ranking information on each profit improvement rate in the ranking information on the plurality of profit improvement rates respectively,

obtains an added value by adding a multiplied value calculated by multiplying a value allotted to the ranking information on the plurality of customer quality evaluations by a value allotted to the ranking information on the one customer quality evaluation inputted by the input part,

a multiplied value calculated by multiplying a value allotted to the ranking information on the plurality of customer costs evaluations by a value allotted to the ranking information on the one customer costs evaluation inputted by the input part,

a multiplied value calculated by multiplying a value allotted to the ranking information on the plurality of customer delivery deadline evaluations by a value allotted to the ranking information on the one customer delivery deadline evaluation inputted by the input part,

a multiplied value calculated by multiplying a value allotted to the ranking information on the plurality of cash flow by a value allotted to the ranking information on the one cash flow inputted by the input part, and

a multiplied value calculated by multiplying a value allotted to the ranking information on the plurality of profit improvement rates by a value allotted to the ranking information on the one profit improvement rate inputted by the input part, and

ranks the competitive dominance degree at a position to which the added value belongs.

It is a feature that the business profit improvement support system further comprises:

a memory part for storing a first holonic information which improves throughput of business, a second holonic information which improves assets turnover of the business, a third holonic information which reforms a process of the business, and a fourth holonic information which reforms a product of the business, wherein

the input part inputs a current value corresponding to at least one of the first through the fourth holonic information stored in the memory part from an external apparatus, and inputs a target value corresponding to the current value, from a user, and

the processing part calculates an improvement value corresponding to the current value and the target value, based on the current value and the target value inputted by the input part.

It is a feature that the first holonic information includes, with reference to the business, at least one of part material cost reduction information, production process improvement information, and sales volume growth information based on a sales promotion,

the second holonic information includes, with reference to the business, at least one of production process lead time improvement information, inventory improvement information based on a production plan adjustment, and funds collection information,

the third holonic information includes, with reference to the business, at least one of reform process domain range information, process lead time reduction information, and business costs reform information based on a process cost reduction, and

the fourth holonic information includes, with reference to the business, at least one of product development strategy information, continuous development information, and new development information.

It is a feature that the display part prompts a user to perform a business profit improvement activity based on the first through the fourth holonic Information corresponding to the target value, and to input progress information based on the business profit improvement activity,

the input part inputs the progress information, and

the processing part calculates a target value corresponding to the progress information, based on the progress information inputted by the input part.

It is a feature that the processing part calculates, based on the current value inputted by the input part and a calculated target value corresponding to the progress information, an improvement value corresponding to the current value and the calculated target value corresponding to the progress information.

It is a feature that the display part displays a calculated target value corresponding to the progress information and calculated by the processing part, and prompts a user to input recognition information for a displayed target value corresponding to the progress information,

the input part inputs the recognition information from the user, and

the processing part converts the current value inputted by the input part into the calculated target value corresponding to the progress information, based on the recognition information inputted by the input part.

It is a feature that the display part displays a converted current value converted by the processing part and a calculated improvement value corresponding to the current value and the calculated target value corresponding to the progress information.

It is a feature that the business profit improvement support system supports profit improvement of the business, based on a production plan of a product corresponding to the business,

the business profit improvement support system further comprises:

a production plan adjustment control part for controlling the production plan, based on at least one of demand information, component material information, production load information, and physical distribution information.

It is a feature that the production plan adjustment control part calculates a production throughput value of the product, based on at least one of the component material information, the production load information, and the physical distribution information, and when a plurality of the products exist, controls the production plan to give priority to the product with a calculated production throughput value being large.

It is a feature that the component material information includes part procurement lead time information,

the production load information includes lead time information on a plurality of production processes, and restriction time information on between a production process and a production process in the plurality of production processes,

the physical distribution information includes delivery time information, and

the production plan adjustment control part calculates the production throughput value of the product, based on the part procurement lead time information, the lead time information on the plurality of production processes, the restriction time information on between a production process and a production process in the plurality of production processes, and the delivery time information.

It is a feature that the business profit improvement support system supports profit improvement of the business based on investment measures corresponding to the business, and the business profit improvement support system further comprises

an investment adjustment control part for controlling the investment measures, based on investment amount information and accumulated profit information.

It is a feature that the business profit improvement support system allots a prescribed value to be corresponding to a plurality of periods in progression and each of the plurality of periods,

the input part inputs an investment amount and a profit amount corresponding to each of the plurality of periods,

the investment adjustment control part calculates an accumulated profit amount which accumulates, per period, a multiplied value calculated by multiplying the profit amount corresponding to each of the plurality of periods by the prescribed value corresponding to the plurality of periods, and

the display part displays the plurality of periods, an investment amount corresponding to each of the plurality of periods, and the accumulated profit amount calculated by the investment adjustment control part.

It is a feature that the display part displays the plurality of periods, the investment amount corresponding to each of the plurality of periods, and the accumulated profit amount calculated by the investment adjustment control part, in a second dimension coordinate in which one is a time axis and another is an investment amount axis and accumulated profit amount axis.

It is a feature that the first holonic information includes, with reference to the business, at least one of defect removal rate improvement information and software development man-day improvement information, and

the second holonic information includes, with reference to the business, at least one of software part circulation number-of-times information and funds collection information.

It is a feature that the business profit improvement support system further comprises:

a memory part for storing a first holonic information which improves throughput of the business, a second holonic information which improves assets turnover of the business, a third holonic information which reforms a process of the business, and a fourth holonic information which reforms a product of the business, wherein

the input part inputs expected risk information corresponding to at least one of the first through the fourth holonic information stored in the memory part,

the processing part calculates a prescribed value based on the expected risk information inputted by the input part, and

the display part displays the prescribed value calculated by the processing part, with at least one of the first through the fourth holonic information corresponding to the prescribed value, stored in the memory part, and prompts a user to perform profit improvement of the business.

It is a feature that the expected risk information is at least one of maturity degree information on an object model and difficulty degree information on the object model.

It is a feature that the maturity degree information on the object model relates to development of software, and includes

first level information which shows a ranking indicating that, after a specification of the software having been determined, the software corresponding to the specification having been determined can be realizable by using an existing software,

second level information which shows a ranking indicating that, after a specification of the software having been determined, the software corresponding to the specification having been determined is similar to an existing software,

third level information which shows a ranking indicating that, after a specification of the software having been determined, the software corresponding to the specification having been determined needs new software development,

fourth level information which shows a ranking indicating that, after an outline of a specification of the software having been determined, the software corresponding to the outline of the specification having been determined needs new software development, and

fifth level information which shows a ranking indicating that an outline of a specification of the software has not been determined.

It is a feature that the difficulty degree information on the object model relates to development of software and includes a plurality of difficulty degree ranking information, based on a plurality of logic degree rankings of the software and a plurality of data amount rankings of the software.

It is a feature that the expected risk information includes maturity degree information on an object model, and difficulty degree information on the object model,

the maturity degree information on the object model includes a plurality of maturity degree ranking information,

the difficulty degree information on the object model includes a plurality of difficulty degree ranking information,

the input part inputs one of the plurality of maturity degree ranking information and one of the plurality of difficulty degree ranking information, and

the processing part allots a prescribed value to each of the plurality of maturity degree ranking information, allots a prescribed value to each of the plurality of difficulty degree ranking information, and calculates a value by at least multiplying a value corresponding to the one of the plurality of maturity degree ranking information inputted by the input part by a value corresponding to the one of the plurality of difficulty degree ranking information inputted by the input part.

It is a feature that the processing part includes a prescribed adjustment value for adjusting adequacy of a calculated value, and calculates a value by multiplying the value corresponding to the one of the plurality of maturity degree ranking information inputted by the input part, the value corresponding to the one of the plurality of difficulty degree ranking information inputted by the input part, and the prescribed adjustment value together.

According to a product producing business reform support system of the present invention, the product producing business reform support system comprises:

an order-receiving plan management part for managing order-receiving plan information which changes;

a production plan management part for generating production plan information based on the order-receiving plan information managed by the order-receiving plan management part, and managing the production plan information corresponding to a change of the order-receiving plan information;

a production implementation management part for generating production implementation information based on the production plan information managed by the production plan management part, and managing the production implementation information corresponding to a change of the production plan information; and

a display part for displaying at least one of the order-receiving plan information managed by the order-receiving plan management part, the production plan information managed by the production plan management part, and the production implementation information managed by the production implementation management part, and for prompting a user to perform a product producing business reform.

It is a feature that the product producing business reform support system further comprises an equipment management part for generating equipment control information which controls production equipment based on the production implementation information managed by the production implementation management part, and for managing the equipment control information to be corresponding to a change of the production implementation information.

It is a feature that the product producing business reform support system further comprises a business year plan management part for managing business year plan information, and outputting managed business year plan information to the order-receiving plan management part as one order-receiving plan information in the order-receiving plan information which changes.

It is a feature that the product producing business reform support system further comprises a development plan management part for inputting the business year plan information from the business year plan management part, managing development plan information on a product based on inputted business year plan information, and outputting managed development plan information to the order-receiving plan management part.

It is a feature that the product producing business reform support system inputs a plurality of prescribed information individually from an external apparatus.

It is a feature that the product producing business reform support system comprises:

a business year plan management part for generating business year plan information based on business strategy information in a first period and managing the business year plan information in a second period within the first period;

an order-receiving plan management part for generating order-receiving plan information based on the business year plan information managed by the business year plan management part, and managing the order-receiving plan information in a third period within the second period;

a production plan management part for generating production plan information based on the order-receiving plan information managed by the order-receiving plan management part, and managing the production plan information in a fourth period within the third period;

a production implementation management part for generating production implementation information based on the production plan information managed by the production plan management part, and managing the production implementation information in a fifth period within the fourth period;

an equipment management part for generating equipment control information which controls production equipment, based on the production implementation information managed by the production implementation management part, and managing the equipment control information in a sixth period within the fifth period; and

a display part for displaying at least one of the order-receiving plan information managed by the order-receiving plan management part, the production plan information managed by the production plan management part, the production implementation information managed by the production implementation management part, and the equipment control information managed by the equipment management part, and prompting a user to perform a product producing business reform.

It is a feature that the order-receiving plan information includes expected order plan information which expects an order amount based on business year plan, market order plan information in which an order amount is undecided, and decided order plan information in which an order amount is decided, the expected order plan information changes to the market order plan information, and the market order plan information changes to the decided order plan information, and

the order-receiving plan management part manages product information, cost information and inventory information corresponding to managed order-receiving plan information, and dynamically changes the product information, the cost information, and the inventory information corresponding to the order-receiving plan information, based on a change of the order-receiving plan information, in a case of the order-receiving plan information being the expected order plan information, in a case of the order-receiving plan being the market order plan information, and in a case of the order-receiving plan being the decided order plan information.

It is a feature that the order-receiving plan information includes expected order plan information which expects an order amount based on business year plan,

the order-receiving plan management part stores an order amount, an order-not-decided amount, and a lost order amount corresponding to the expected order plan information, per prescribed unit, and

the display part displays the order amount, the order-not-decided amount, and the lost order amount stored by the order-receiving plan management part, in a graph per prescribed period, and prompts a user to perform sales reinforcement.

It is a feature that the production plan management part manages cost information corresponding to production plan information managed, and

the display part displays the production plan information and the cost information managed by the production plan management part, in a graph per prescribed period, and prompts a user to perform a product producing business reform.

It is a feature that the production plan management part manages the cost information on a product corresponding to managed production plan information per prescribed period, inputs cost actual result information on the product produced before the prescribed period managed, and

the display part displays the cost information managed by the production plan management part and the cost actual result information in a graph to be overlapped, per prescribed period, and prompts a user to perform a product producing business reform.

It is a feature that the production plan management part stores a target value of a cost amount of the product corresponding to the managed production plan information, and

the display part further displays the target value stored by the production plan management part, in the graph, and prompts a user to perform a product producing business reform.

It is a feature that the product producing business reform support system further comprises:

an input part for inputting prescribed information; and

a processing part for calculating a value of a prescribed parameter based on the prescribed information inputted by the input part, and deciding a ranking of the prescribed parameter based on the value calculated,

wherein the display part prompts a user to input the prescribed information by the input part, displays the ranking of the prescribed parameter decided by the processing part, in a graph, and prompts the user to perform a market analysis evaluation of business of the product, and

the input part inputs the target value of the cost amount of the product from a user, based on the market analysis evaluation of the business and outputs it to the production plan management part.

It is a feature that the production plan management part sets up a scheduled cost amount of the product corresponding to managed production plan information, and after receiving an order of the product, manages a cost amount required for the product, and

the display part displays warning information in the case that the costs amount managed by the production plan management part exceeds the scheduled cost amount set up by the production plan management part, and calls a user's attention.

It is a feature that the production plan information includes expected production plan information which expects a production quantity based on a business year plan and decided production plan information in which order-receiving is decided, and the expected production plan information changes to the decided production plan information, and

the production plan management part manages product information, cost information, inventory information, and manufacture lead time information corresponding to managed production plan information, and dynamically changes the product information, the cost information, the inventory information, and the manufacture lead time information corresponding to the production plan information, based on a change of the production plan information, in a case of the production plan information being the expected production plan information and in a case of the production plan information being the decided production plan information.

It is a feature that the product producing business reform support system further comprises a production plan adjustment control part for generating prescribed priority processing information for adjusting and controlling a production plan based on a prescribed priority processing standard,

wherein the production plan management part inputs the prescribed priority processing information generated by the production plan adjustment control part, and generates production plan information based on input prescribed priority processing information.

It is a feature that the product producing business reform support system further comprises:

an input part for inputting prescribed information; and

a processing part for calculating a value of a prescribed parameter based on the prescribed information inputted by the input part, and deciding a ranking of the prescribed parameter based on the value calculated,

wherein the display part prompts a user to input the prescribed information by the input part, displays the ranking of the prescribed parameter decided by the processing part, in a graph, and prompts the user to perform a market analysis evaluation of business of a product,

the input part inputs prescribed priority processing information from a user, based on the market analysis evaluation of the business, and

the production plan management part inputs the prescribed priority processing information inputted by the input part, and generates production plan information based on input prescribed priority processing information.

It is a feature that the production implementation management part includes:

an automatic planning part for automatically generating the production implementation information based on prescribed priority processing information; and

a manual adjustment part for performing a manual adjustment of the production implementation information generated by the automatic planning part, based on adjustment information inputted by a user, and

wherein the display part displays the production implementation information generated by the automatic planning part and prompts a user to input the adjustment information.

It is a feature that the production implementation management part inputs production implementation actual result information which was used when producing a product before, and

the display part displays at least one of the production implementation information generated by the automatic planning part and the production implementation information which was performed manual adjustment by the manual adjustment part, with the production implementation actual result information, on a same screen to be in a chart display.

It is a feature that the product producing business reform support system further comprises a procurement plan management part for generating procurement plan information based on the production plan information managed by the production plan management part, and managing the procurement plan information to be corresponding to a change of the production plan information.

It is a feature that the procurement plan management part inputs a procurement lead time and a work starting time/date, calculates a difference of time/date between an inputted work starting time/date and an inputted procurement lead time, and decides a procurement order date based on the difference of time/date calculated.

It is a feature that the procurement plan information includes a number of orders for a prescribed component material, an accumulated order number indicating an accumulated number of orders for the prescribed component material in a past, and a price of the prescribed component material,

the procurement plan management part changes the number of orders for the prescribed component material, the accumulated order number indicating the accumulated number of orders for the prescribed component material in the past, and the price of the prescribed component material, to be corresponding to a change of the production plan information, and

the display part displays the number of orders for the prescribed component material, the accumulated order number indicating the accumulated number of orders for the prescribed component material in the past, and the price of the prescribed component material which were changed by the procurement plan management part, and prompts a user to predict an improvement of the price of the prescribed component material, based on the number of orders for the prescribed component material and the accumulated order number indicating the accumulated number of orders for the prescribed component material in the past.

It is a feature that the product producing business reform support system further comprises an estimation plan management part for generating estimation plan information based on an annual plan information managed by the annual plan management part, and managing the estimation plan information to be corresponding to a change of the annual plan information.

It is a feature that the estimation plan management part further generates estimation plan information based on new business negotiation information.

It is a feature that the estimation plan information is revised a plurality of times, the estimation plan management part manages the estimation plan information revised the plurality of times, and the display part displays the estimation plan information managed by the estimation plan management part and revised the plurality of times, side by side in order of revision, and prompts a user to perform a service improvement relating to an estimation.

According to a business profit improvement support system of the present invention, the business profit improvement support system comprises:

a memory part for storing holonic information which reforms a process of business;

a plan management part for making sales process information, development process information, materials process information, production process information, physical distribution process information, and settlement-of-accounts process information cooperate mutually, and for performing a plan management of the process of the business by dynamically changing the sales process information, the development process information, the materials process information, the production process information, the physical distribution process information and the settlement-of-accounts process information; and

the display part for displaying the holonic information stored in the memory part, and the sales process information, the development process information, the materials process information, the production process information, the physical distribution process information and the settlement-of-accounts process information which were dynamically changed by the plan management part, and for prompting a user to perform a profit improvement of the business by way of urging a process reform of the business.

According to a product producing business reform support system of the present invention, the product producing business reform support system comprises:

a memory part for storing a prescribed product composition management model including prescribed plan data;

a plan management part for generating the sales process information, development process information, materials process information, production process information, physical distribution process information, and settlement-of-accounts process information based on the prescribed plan data included in the prescribed product composition management model stored in the memory part, and for performing a plan management for a product producing business, by way of integrating each of the prescribed plan data with generated sales process information, development process information, materials process information, production process information, physical distribution process information, and settlement-of-accounts process information to be unitary; and

a display part for displaying the sales process information, the development process information, the materials process information, the production process information, the physical distribution process information, and the settlement-of-accounts process information which were generated by the plan management part, and for prompting a user to perform a reform of the product production business.

It is a feature that the prescribed product composition management model stored in the memory part includes a plurality of original data which contains each of the prescribed plan data, and

the plan management part inputs data of a minimum item suitable for a use, corresponding to each of the prescribed plan data from the prescribed product composition management model stored in the memory part, and extends the each of the prescribed plan data based on inputted data one by one.

It is a feature that the plan management for the product producing business is a plan management applicable to development business and production business of hardware and software in common.

It is a feature that management intensity of registration of the original data of the product composition management model and each of the prescribed plan data can be adjusted by setting up a security level.

It is a feature that the plan management part performs a plan management in which it is possible to directly connect to a concrete activity in real time and in feed forward and to be reflected in profit or loss of the business, by grasping a plan value and an actual result value of the product producing business.

It is a feature that the plan management part performs a plan management which can notify a user of a deviation between a plan value and an actual result value, as an alarm, at any place and time in order to prompt the user to take an urgent action and grasp an actual result history of the urgent action.

It is a feature that the plan management part performs a plan management which can pursue a concrete activity history, in a specific item, for executing a plan.

It is a feature that the plan management part performs a plan management which can grasp actual result costs and quality costs synchronizing with a progress in a plan execution.

It is a feature that the plan management part manages a progress actual result management of the product producing business,

the prescribed product composition management model stored in the memory part includes information of direct material cost, processing cost and expense, as management basic data, and

the plan management part performs a plan management which can grasp a progress actual result management of the product producing business in hardware and software by breakdown of the direct material cost, the processing cost, and the expense, as the management basic data.

It is a feature that the plan management part manages data directly linking to a prescribed management, and

the display part issues an alarm in real time when the data, directly linking to the prescribed management and managed by the plan management part, deviates from a prescribed plan value, in order to prompt a future measure and improvement.

It is a feature that the production plan information is automatically adjusted with giving priority to a profit growth and a cash flow increase.

It is a feature that the production plan management part can make a user perform various priority processing.

It is a feature that the display part is structured to be able to present a start time/date and an end time/date of each business, in order to carry out outsourcing of various business.

It is a feature that the plan management part manages a progress actual result management of the product producing business,

the prescribed product composition management model stored in the memory part includes information of direct material cost, processing cost and expense, as management basic data, and

the plan management part performs a change management and a quality cost management which can pursue a change of specification and a change history with a plurality of users, in a case of a development process with a high risk as an investment.

It is a feature that the product producing business reform support system can be advanced to be a structure of a next-generation plan management system where sending and receiving of all item data, except for registering original data, can be thoroughly automatically performed by defining a document composition.

### BRIEF EXPLANATION OF THE DRAWINGS

FIG. 1 shows a business profit improvement support system according to Embodiment 1;

FIG. 2 shows a market analysis evaluation plot for a business analysis according to Embodiment 1;

FIG. 3 shows an automatic plot input screen;

FIG. 4 shows an example of evaluation;

FIG. 5 shows an automatic plot input screen;

FIG. 6 shows an example of an evaluation result;

FIG. 7 shows a holonic control according to Embodiment 1;

FIG. 8 shows an activity item list according to Embodiment 1;

FIG. 9 shows an example of a production plan;

FIG. 10 shows an example of a composition model (per unit);

FIG. 11 shows an example of a unit composition model;

FIG. 12 shows an example of a module composition model;

FIG. 13 shows an example of a product composition master structure;

FIG. 14 shows an example of detailed data;

FIG. 15 shows a continuation of FIG. 14;

FIG. 16 shows a process productivity indication;

FIG. 17 shows an activity progress management list according to Embodiment 1;

FIG. 18 shows an activity result registration list according to Embodiment 1;

FIG. 19 shows a revision flow of budget management data;

FIG. 20 shows a dynamic production plan adjustment control according to Embodiment 1;

FIG. 21 shows an investment risk adjustment control according to Embodiment 1;

FIG. 22 shows a product life cycle according to Embodiment 1;

FIG. 23 shows an investment collection graph according to Embodiment 1;

FIG. 24 shows an investment adjustment control according to Embodiment 1;

FIG. 25 shows a business analysis evaluation plot according to Embodiment 1;

FIG. 26 shows an architecture for describing a whole according to Embodiment 1;

FIG. 27 shows a software business holonic control according to Embodiment 5;

FIG. 28 shows a method of quantitatively estimating a risk degree in a software development according to Embodiment 5;

FIG. 29 shows a hierarchy of a business reform;

FIG. 30 shows a structure according to Embodiment 6;

FIG. 31 shows “an architecture and a plan management of an integration model” which presents a whole aspect of a plan management integrated system according to Embodiment 6;

FIG. 32 shows a “real-time cooperation-integrated system” of a plan management of a plan management integration system;

FIG. 33 shows a “product composition management master” which composes a core of a composition according to Embodiment 6;

FIG. 34A shows a “product composition management model <prototype>” used as a composition common to plan management according to Embodiment 6;

FIG. 34B shows a figure of a continuation of FIG. 34A;

FIG. 34C shows a figure of a continuation of FIG. 34B;

FIG. 34D shows a figure of a continuation of FIG. 34C;

FIG. 34E shows a figure of a continuation of FIG. 34D;

FIG. 34F shows a figure of a continuation of FIG. 34E;

FIG. 35A shows a business negotiation issue model in an annual plan and plan management (sales) according to Embodiment 6;

FIG. 35B shows a figure of a continuation of FIG. 35A;

FIG. 35C shows a figure of a continuation of FIG. 35B;

FIG. 36A shows an estimation issue information model of an estimation-plan management according to Embodiment 6;

FIG. 36B shows a figure of a continuation of FIG. 36A;

FIG. 36C shows a figure of a continuation of FIG. 36B;

FIG. 37 shows an example of an order-receiving actual result management of order-receiving-plan management according to the present invention;

FIG. 38A shows an order-receiving issue information model of an order-receiving-plan management in Embodiment 6;

FIG. 38B shows a figure of a continuation of FIG. 38A;

FIG. 38C shows a figure of a continuation of FIG. 38B;

FIG. 39A shows a manufacture issue information model of a production-plan management according to Embodiment 6;

FIG. 39B shows a figure of a continuation of FIG. 39A;

FIG. 39C shows a figure of a continuation of FIG. 39B;

FIG. 40 shows an example of an actual result cost management;

FIG. 41 shows a functional flow and an example of change adjustment of a dynamic production plan adjustment control part which performs load adjustment at the production-plan management;

FIG. 42 shows an inter-process cooperation adjustment functional model of a dynamic production plan adjustment control;

FIG. 43A shows a procurement issue information model of a procurement-plan management;

FIG. 43B shows a figure of a continuation of FIG. 43A;

FIG. 44A shows an operation issue information model of an equipment operation-plan management;

FIG. 44B shows a figure of a continuation of FIG. 44A;

FIG. 44C shows a figure of a continuation of FIG. 44B;

FIG. 45A shows a development issue information model of a development-plan management;

FIG. 45B shows a figure of a continuation of FIG. 45A;

FIG. 45C shows a figure of a continuation of FIG. 45B;

FIG. 45D shows a figure of a continuation of FIG. 45C;

FIG. 46A shows a software composition management model;

FIG. 46B shows a figure of a continuation of FIG. 46A;

FIG. 47 shows an example of a development (software) process management model;

FIG. 48 shows a development (S/W) actual result management;

FIG. 49 shows a development (S/W) quality management;

FIG. 50 shows an example of a change management model of development (software);

FIG. 51 shows a worksheet;

FIG. 52A shows various plan management composition management model maps;

FIG. 52B shows a figure of a continuation of FIG. 52A; and

FIG. 52C shows a figure of a continuation of FIG. 52B.

### BEST FORM FOR CARRYING OUT THE INVENTION

Embodiment 1

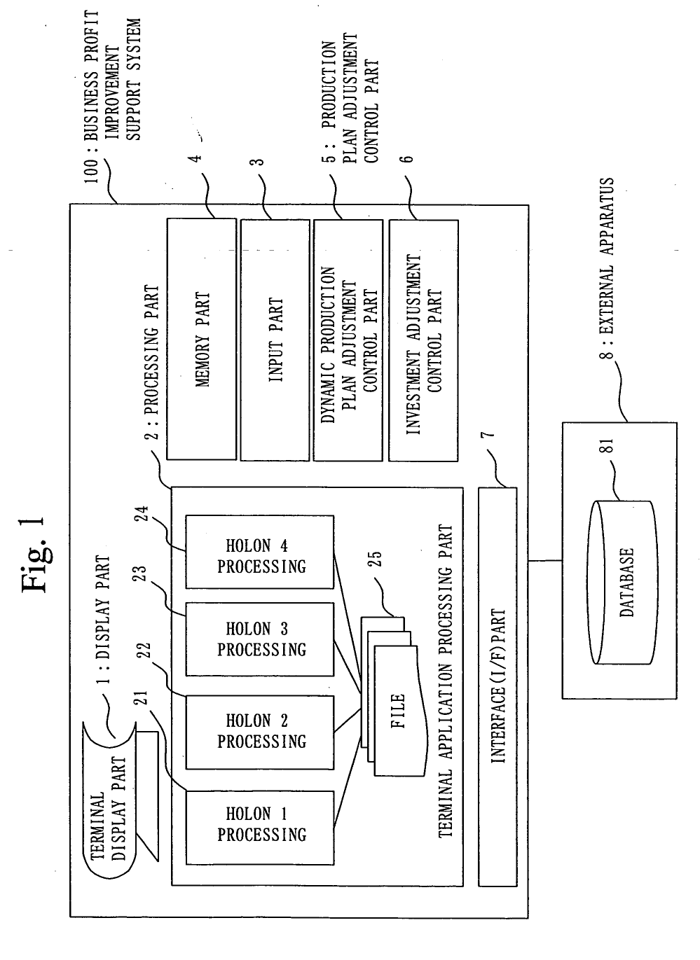

FIG. 1 shows a business profit improvement support system according to Embodiment 1. In FIG. 1, 1 denotes a terminal display part (an example of a display part), 2 denotes a terminal application processing part (an example of a processing part), 3 denotes an input part, 4 denotes a memory part, 5 denotes a dynamic production plan adjustment control part (an example of a production plan adjustment control part), 6 denotes an investment adjustment control part, 7 denotes an interface (I/F) part, 8 denotes an external apparatus, 21 denotes a holon 1 processing, 22 denotes a holon 2 processing, 23 denotes a holon 3 processing, 24 denotes a holon 4 processing, 25 denotes a file, 81 denotes a database and 100 denotes a business profit improvement support system.

The business profit improvement support system 100 includes the terminal display part 1, the terminal application processing part 2, the input part 3, the memory part 4, the dynamic production plan adjustment control part 5, the investment adjustment control part 6, and the I/F part 7.

The terminal application processing part 2 includes the holon 1 processing 21, the holon 2 processing 22, the holon 3 processing 23, the holon 4 processing 24, and the file 25. The external apparatus 8 includes the database 81. The business profit improvement support system 100 is connected to the external apparatus 8 through the I/F part 7.

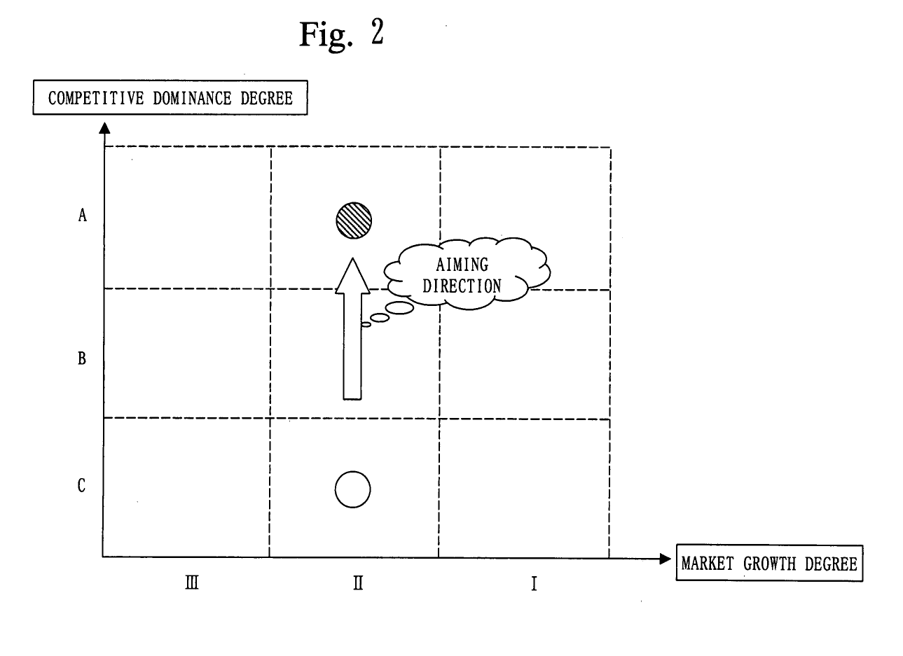

FIG. 2 shows a market analysis evaluation plot for a business analysis according to Embodiment 1. In FIG. 2, I, II, and III of the horizontal axis show divisions of growth degree, and A, B, and C of the vertical axis show divisions of degree of competitive dominance. In FIG. 2, a market ranking is largely evaluated with two axes. That is, the horizontal axis discriminates a degree of market growth (an example of a prescribed parameter), i.e., a growth rate of demand. For example, I indicates a high growth market domain of an annual rate of 30% or more, II indicates a growth market domain of an annual rate of from 10% to less than 30%, and III indicates a low growth market domain of an annual rate of less than 10%. The vertical axis discriminates a degree of competitive dominance (an example of a prescribed parameter) of the business, i.e., a ranking of competitive power. For example, A indicates the domain of the first or second in an industry segment. B indicates the domain of the third through the fifth in the industry segment, and C indicates the domain of sixth or above. Thus, these two axes are based on an objective evaluation in the market.

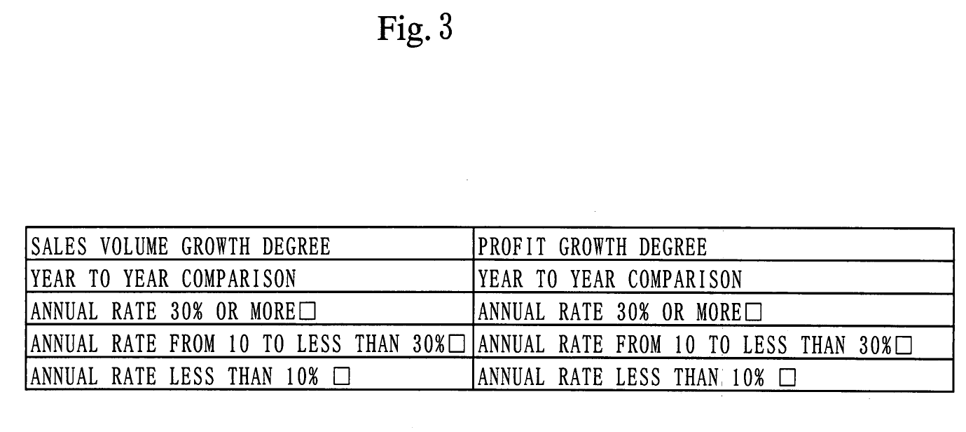

FIG. 3 shows an automatic plot input screen. According to Embodiment 1, when it is impossible to obtain a demand growth rate as market information, the present system side has a service of automatically plotting by way of a business person in charge replying to inquiries (terminal display part 1) of FIG. 3.

It is just selecting one of the year-to-year comparisons at the sales volume growth degree and the profit growth degree, at the terminal display part 1. Concretely, it indicates to select just one of an annual rate of 30% or more (it is an example of ranking information), an annual rate of from 10% to less than 30% (it is an example of ranking information), and an annual rate of less than 10% (it is an example of ranking information). Receiving a reply, the present system has a market evaluation substitution function of weighting the reply item by using the best form matching the market conditions, and performing a level comparison for the value.

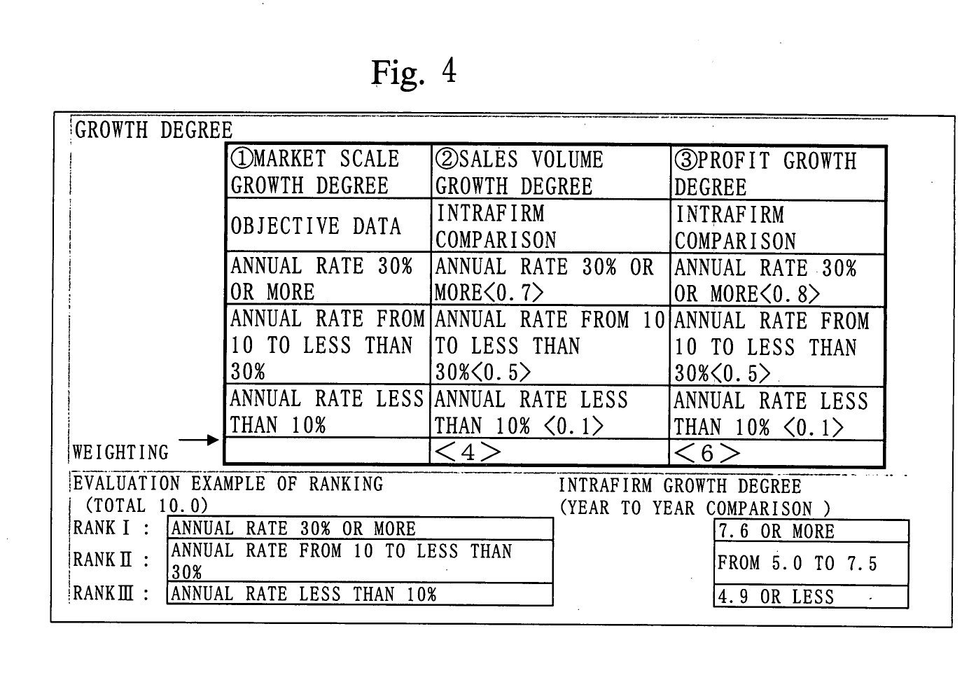

FIG. 4 shows an evaluation example. \mathring{1} is the case in which a market scale growth degree can be objectively acquired from the market conditions, and \mathring{2}, \mathring{3} are the cases in which market scale growth degrees can not be objectively acquired from the market conditions and \mathring{2}, \mathring{3} are intrafirm comparisons. \mathring{2} is a sales volume growth degree, being a year-to-year comparison, and \mathring{3} is a profit growth degree, also being a year-to-year comparison. According to the current market conditions, the weighting of \mathring{2}, \mathring{3} is portioned to be 4 to 6 (it is an example of a prescribed value). The annual rate of 30% or more of \mathring{2} is allotted to 0.7 (an example of a prescribed value), the annual rate of from 10% to less than 30% is allotted to 0.5 (an example of a prescribed value), and the annual rate of less than 10% is allotted to 0.1 (an example of a prescribed value). Further, at the \mathring{3}, allotting to 0.8, 0.5 and 0.1 (they are examples of prescribed values) is similarly performed.

Consequently, the rank I (an example of ranking of the market growth degree) is defined to be corresponding to the annual rate of 30% or more of \mathring{1}, or corresponding to 7.6 or more of the total value (an example of a value of the market growth degree) of the intrafirm growth degrees \mathring{2} and \mathring{3}. The rank II (an example of ranking of the market growth degree) is defined to be corresponding to the annual rate of from 10% to less than 30% of \mathring{1}, or corresponding to from 5.0 to 7.5 of the total value of the intrafirm growth degrees \mathring{2} and \mathring{3}. The rank III (an example of ranking of a market growth degree) is defined to be corresponding to the annual rate of less than 10% of \mathring{1}, or corresponding to 4.9 or less of the total value of the intrafirm growth degrees \mathring{2} and \mathring{3}. Thus, it is possible in the present system to set up the weighting in the form reflecting the market conditions.

Moreover, when there is no market conditions data, and when there is no intrafirm growth degree data because of the first year of a business start, a functional substitution is performed by comparing an estimation number of cases etc. with a conventional business model as objectively as possible.

Next, ranking of A, B, and C (an example of ranking of the competitive dominance degree) of the competitive dominance degree is performed.

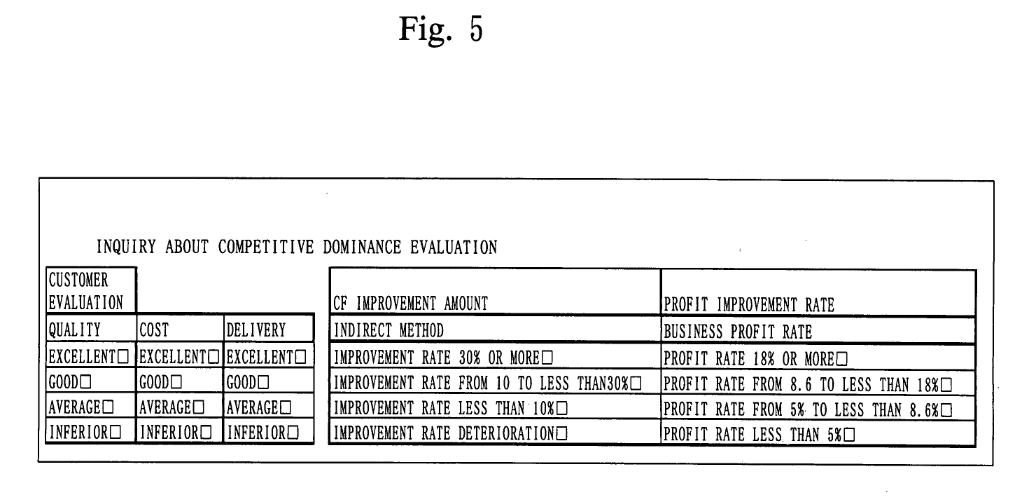

FIG. 5 shows an automatic plot input screen. According to Embodiment 1, when it is impossible to obtain a competitive dominance degree as market information, the present system side has a service of automatically plotting by way of a business person in charge replying to inquires (terminal display part 1) of FIG. 5.

It is just selecting, at the terminal display part 1, one of levels of each item: four levels in this case, about the customer evaluation, the cash flow (abbreviated to be CF hereafter) improvement amount, and the profit improvement rate. For example, the customer evaluation is evaluated at Q (Quality), C (Costs), and D (Delivery). If the evaluation level is the highest, Excellent (an example of ranking information on customer evaluation, ranking information on customer quality evaluation, ranking information on customer costs evaluation, and ranking information on customer delivery deadline evaluation) is selected. If the level is relatively high, Good (an example of the ranking information on the customer evaluation, the ranking information on the customer quality evaluation, the ranking information on the customer costs evaluation, and the ranking information on the customer delivery deadline evaluation) is selected. If the level is an average, Average (an example of the ranking information on the customer evaluation, the ranking information on the customer quality evaluation, the ranking information on the customer costs evaluation, and the ranking information on the customer delivery deadline evaluation) is selected. If the level is inferior, Inferior (an example of the ranking information on the customer evaluation, the ranking information on the customer quality evaluation, the ranking information on the customer costs evaluation, and the ranking information on the customer delivery deadline evaluation) is selected.

Next, one of the following is selected at the CF improvement amount (an indirect method is acceptable): the improvement rate of 30% or more (an example of ranking information on cash flow), the improvement rate of from 10% to less than 30% (an example of the ranking information on cash flow), the improvement rate of less than 10% (an example of the ranking information on cash flow), or the improvement rate deterioration (an example of the ranking information on cash-flow).

Then, one of the following is selected at the profit improvement rate (business profit ratio is acceptable): the profit ratio of 18% or more (an example of ranking information on profit improvement rate), the profit ratio of from 8.6% to less than 18% (an example of the ranking information on profit improvement rate), the profit ratio of from 5% to less than 8.6% (an example of the ranking information on profit improvement rate), or the profit ratio of less than 5% (an example of the ranking information on profit improvement rate).

Receiving the input, the present system has a market evaluation substitution function of weighting the reply item by using the best form matching the market conditions, and performing a level comparison for the value.

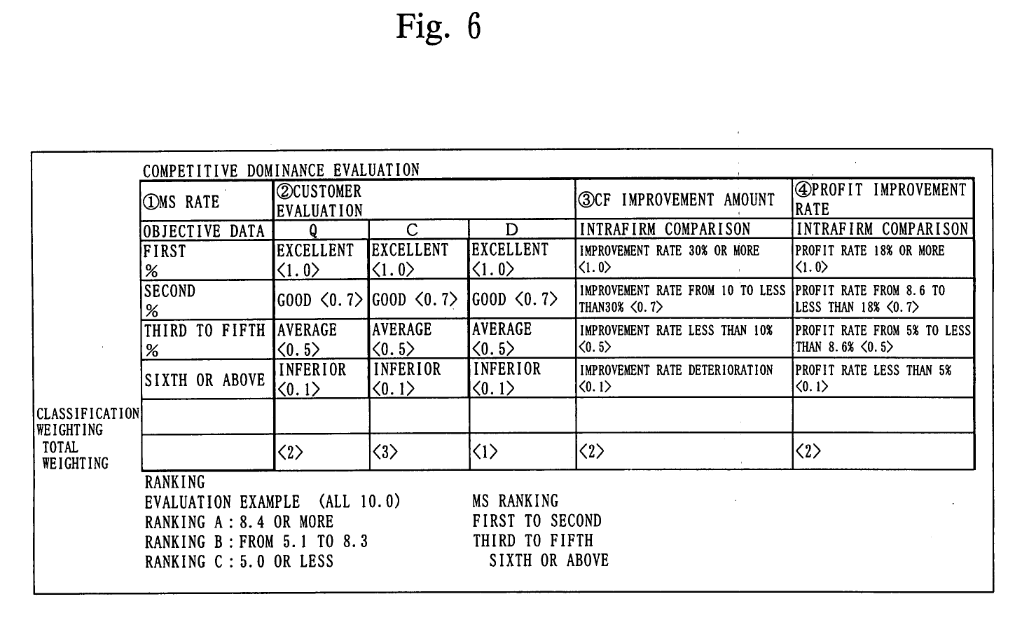

FIG. 6 shows an example of the evaluation result. \mathring{1} is the case in which a competitive dominance degree can be objectively acquired from the market conditions and a market share MS rate can be provided. \mathring{2}, \mathring{3} and \mathring{4} are the cases in which market competitive dominance degrees can not be objectively acquired from the market conditions and, \mathring{2}, \mathring{3} and \mathring{4} are intrafirm comparisons. \mathring{2} is a customer evaluation, \mathring{3} is a CF improvement amount, and \mathring{4} is a profit improvement rate. All of them are comparisons with the preceding term or the preceding year. According to the current market conditions, weighting of \mathring{2}, \mathring{3}, \mathring{4} is allotted to a customer evaluation Q, a customer evaluation C, a customer evaluation D, \mathring{3}, and \mathring{4} to be 2 to 3 to 1 to 2 to 2 (an example of a prescribed value). Further, 1.0, 0.7, 0.5 and 0.1 (an example of a prescribed value) are allotted in level order for each item. Consequently, the rank A (an example of ranking of the competitive dominance degree) is defined to be corresponding to the first or the second in competition of \mathring{1}, or corresponding to 8.4 or more of the total value of the intrafirm comparison degrees \mathring{2}, \mathring{3} and \mathring{4}. The rank B (an example of the ranking of the competitive dominance degree) is defined to be corresponding to the third through fifth in competition of \mathring{1}, or corresponding to from 5.1 to 8.3 of the total value of the intrafirm comparison degrees \mathring{2}, \mathring{3} and \mathring{4}. The rank C (an example of the ranking of the competitive dominance degree) is defined to be corresponding to the sixth or above in competition of \mathring{1}, or corresponding to 5.0 or less of the total value (an example of an added value) of the intrafirm comparison degrees \mathring{2}, \mathring{3} and \mathring{4}.

Thus, it is possible in the present system to set up the weighting in the form reflecting the market conditions. Moreover, when there is no market conditions data, and when there is no intrafirm comparison data because of the first year of a business start, a functional substitution is performed by comparing an order number ratio to an estimation number with a conventional model to perform ranking as objectively as possible.

Next, after plotting the ranking of this business in the market, by the matrix of the degree of market growth and the degree of competitive dominance, the following values in the plotting position will be assessed and evaluated.

(1) Cash flow (abbreviated to be CF hereafter) Improvement Amount

(2) Feed Forward Economical Value Added (abbreviated to be ffEVA hereafter)

It is supposed the CF improvement amount here is in the form being able to be calculated by adding or subtracting an increase or a decrease amount of what has a direct influence on the business itself, compared with the preceding term. (An indirect method of CF acceptable.) Concretely, what has a direct influence on the business itself are the following: sales volume, direct variable costs (direct material costs+direct processing costs), period fixed costs (indirect labor expenses+indirect costs), residual inventory, accounts receivable, accounts payable, depreciation costs etc. Based on this value, it becomes possible to judge in real time whether the current business including fund turnover is making an upturn or becoming worse.

The depreciation costs stated here indicates a granted amount acquired by enough examining the collection term which is calculated by the investment efficiency and the discount cash flow method, based on a viewpoint such as a product life cycle to be mentioned later.

Regarding ffEVA, it defines the general EVA (economical added value) indicator by ranking the domain of the degree of market growth and the degree of competitive dominance. ffEVA is for deciding an orientation of the business by considering and deciding a strategy and a measure for a target domain from the current position, in a vector direction and in feed-forward.

The general EVA is defined by EVA=(business profit after tax)−(capital costs). The capital costs is a consideration required by a stockholder, a creditor, etc who is a supply origin of business operating funds. The EVA indicator shows, for example, when a profit of the current business exceeds the capital costs, that it is a good business which increases business assets. Therefore, it becomes possible to select, in view of advisability, whether to further promote business strengthening or to plan a self-depreciation of the owner's equity, aiming at ROE (return on equity) improvement with considering a product life cycle to be mentioned later.

On the other hand, when it is minus, even if it is a profitable business in a statement of income, since the current business is going in the direction of running through the assets, it becomes expedient to select a direction: to prepare a business withdrawal or to prepare a new deployment towards a new business shift.

When it is difficult to obtain a suitable value of a CF improvement amount and an ffEVA as business management data, because a management period is very short for instance, the following substitution can be performed. As a representation indicator, the transition of an inventory amount or an inventory turnover number, and a trade receivable amount or a trade receivable turnover number can substitute for the CF improvement amount. A comparison of an order volume and an estimated amount (conditions of receiving orders are considered), and an order transition based on a gross profit can substitute for the value of ffEVA.

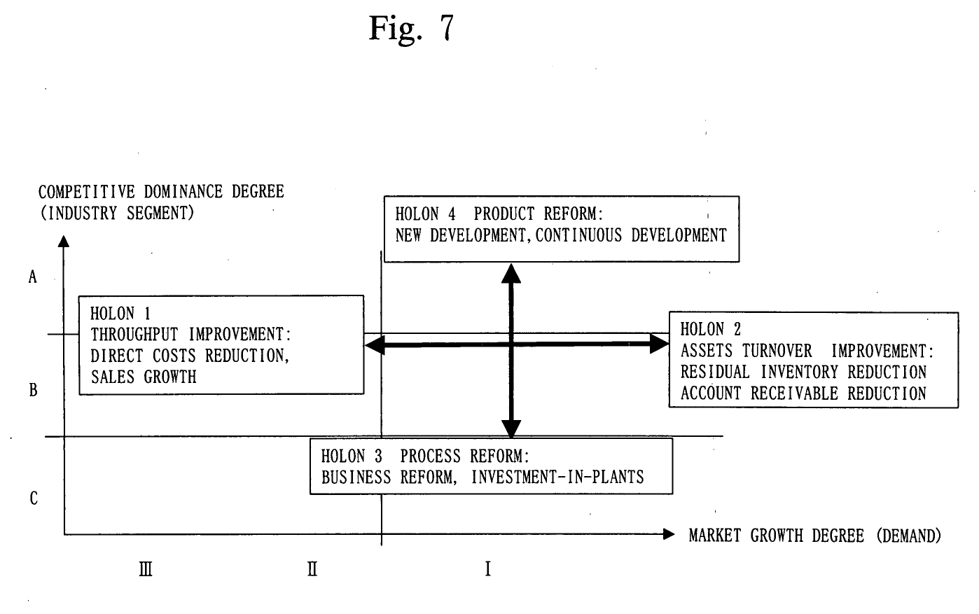

FIG. 7 shows a holonic control according to Embodiment 1. In FIG. 7, the holonic control includes a holon 1, a holon 2, a holon 3, and a holon 4. After setting up a business strategy domain aimed at from the current domain of ffEVA including the CF improvement amount of the above-mentioned business, a holonic control for a profit improvement necessary for realizing the purpose will be described.

A holon means a profit driver factor. A holon as a profit driver factor indicates an autonomous activity factor, and the results of its autonomous activity usually contribute as a business profit. Furthermore, the activity factor, as the holon, brings about a further business profit by producing a synergistic effect. In this meaning, the main activity or an activity group is called a holon.

Embodiment 1 is submitted under the thought that “competitive dominance is born by the strategy for winning, and dominance succession is born by the efforts for winning.”

In Embodiment 1, the types of holons are roughly classified into four, and they have roles.

(1) Holon 1 (an Example of the First Holonic Information): “A Throughput Improvement”

This holon is composed of factors of a cost reduction of direct material costs, direct processing costs, production cost, and distribution cost, a product mix improvement, and a sales growth. This holon indicates the one which can comparatively easily start an activity for a profit improvement by way of contriving.

The product mix is a countermeasure against an over load time in the equipment use and the human resources injection, and performs a sale shift strategy (selling price, sale amount, and profit) considering existing articles at the time of putting newly developed articles into the market. Thus, the object of the product mix at the both roles is aiming at a profit improvement by optimally utilizing management resources.

(2) Holon 2 (an Example of the Second Holonic Information): “An Assets Turnover Improvement”

This indicates a factor which aims at a profit improvement by performing fund turnover, such as turnover of residual inventory and turnover of trade receivable, at an early stage. The target is to produce the maximum profit by using the minimum funds and to minimize the debt by suppressing futile excess capacity, overstock, and over-employment, and it ultimately aims at business without any debt.

(3) Holon 3 (an Example of the Third Holonic Information): “Process Reform”

This is a business process. This first selects how much to perform operations at the own side and when to choose outsourcing. Next, this decides, in order to be effective, where to supply investment for plants and human resources at the strengthening process in the own process. Whether to perform at the own side or to utilize outsourcing should be based on an inspection of the timing of realizing an added value of differentiation from other company. Therefore, by this factor, it is possible to select either of the own side and the outsourcing, and it is aimed at a profit improvement by a process reform.

(4) Holon 4 (an Example of the Fourth Holonic Information): “Product Reform”

This includes a new development and a continuous development. In the new development, demand creation, demand growth, and a share rise are points. In the continuous development, a selection of an offensive or a retreat based on ascertaining market control power (share rise, industry segment traction as a leading company) and a product life cycle are points. By this holonic, business orientation (business transformation and reproduction) of how to perform the points and how to tie them to the profit growth can be established. This holonic is a factor for aiming at a continuous profit growth by fitting into market needs and establishing competitive dominance comparing with other company.

The improvement and the reform stated here indicate: the former indicates to contrive without supplying a new investment, and to expand the profit by mainly removing unproductiveness from the current situation, and the latter indicates to expand the profit under the competitive dominance by supplying a new investment (funds required). Accordingly, the improvement and the reform can be discriminated.

The holons 1 and 2 are improvement factors and the holons 3 and 4 are reform factors. Therefore, the holons 1 and 2 can be immediately started now, and the holons 3 and 4 are to be started after strictly assessing investment efficiency and an investment collection term, under recognition of the business top. The holons 1 through 4 are autonomous profit drivers, and at the same time, synergistic effects can be obtained.

For example, it is supposed that a reduction activity for part costs is performed for the purpose of achieving the throughput improvement of the holon 1. First, in order to reduce the current part procurement costs, the dealing method is changed. For instance, a supplier of parts is changed or a group purchasing is performed, which will result in a procurement costs improvement.

To change a supplier of parts or to change a dealing method such as a change to a group purchasing is the action of the holon 1. If part costs are improved, stock (parts, half-finished products, products) being composed of the part costs consequently becomes reducible in this ratio. This corresponds to the assets turnover improvement of the holon 2.

Furthermore, in order to promote a cost reduction of parts, it tends to cut down the number of parts and kinds of parts. Then, it develops into a common-use of a part and into modulization aiming at a compound function of a part of single function. This is connected with the product reform activities of the holon 4.

By dint of the modulization, an installing method and an inspecting method in the production process are simplified, which results in a production cost reduction. This domain serves as the process reform of the holon 3.

Even referring to the above examples, it could be understood that the improvement and reform, as a solid strategy, makes an upturn with a synergistic effect function in addition to an autonomous function. Thus, this is the reason for naming “holon”.

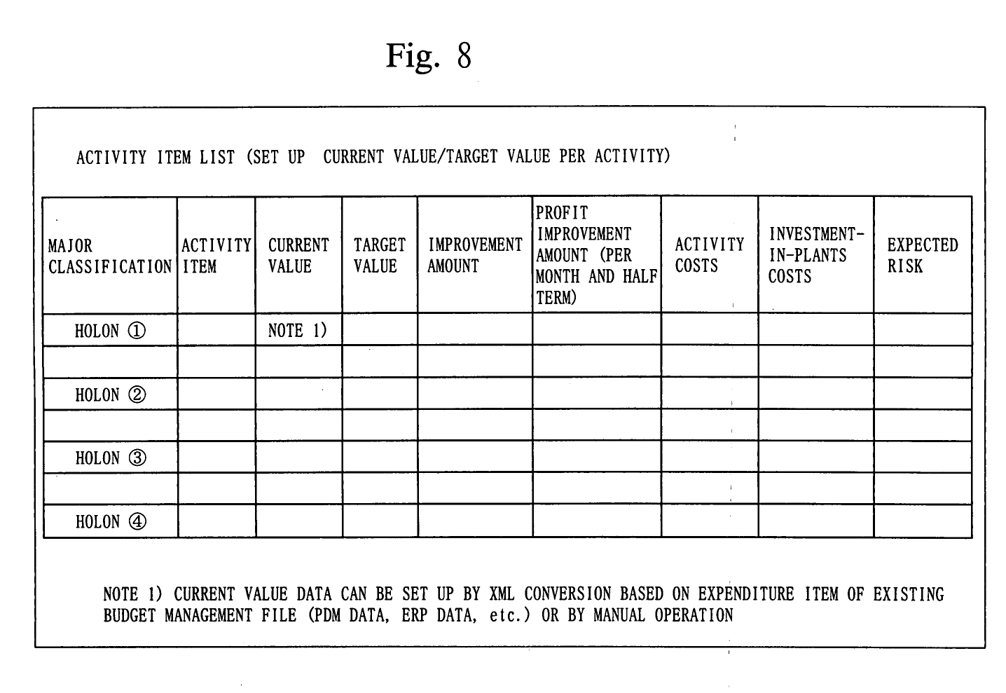

Next, an activity item list (template file) for concretely giving a breakdown and having an action based on the improvement and reform of the solid strategy of the holon 1 through the holon 4 is shown in FIG. 8.

FIG. 8 shows an activity item list according to Embodiment 1. In FIG. 8, the activity item list includes major classification, activity item, current value, target value, improvement amount, profit improvement amount, activity costs, investment-in-plants costs, and expected risk. The holons 1 through 4 are specified as activity items of the major classification in FIG. 8, and an activity item which should be started is set up per major classification.

As the activity item, a target name corresponds to a name of a specific item of a PDM (Product Data Management) file (which is composed of a product name, a structure component material name, an autonomous function software name, etc.) or an independent name already defined as an expenditure item of a basic information system (ERP (Enterprise Resource Planning), legacy). By specifying the independent name, the existing data can be automatically and logically read into the activity item list of FIG. 8 and the result can be stored in the activity item list. A target value predicted from activity results is set up on the basis of the current value in the activity item of FIG. 8.

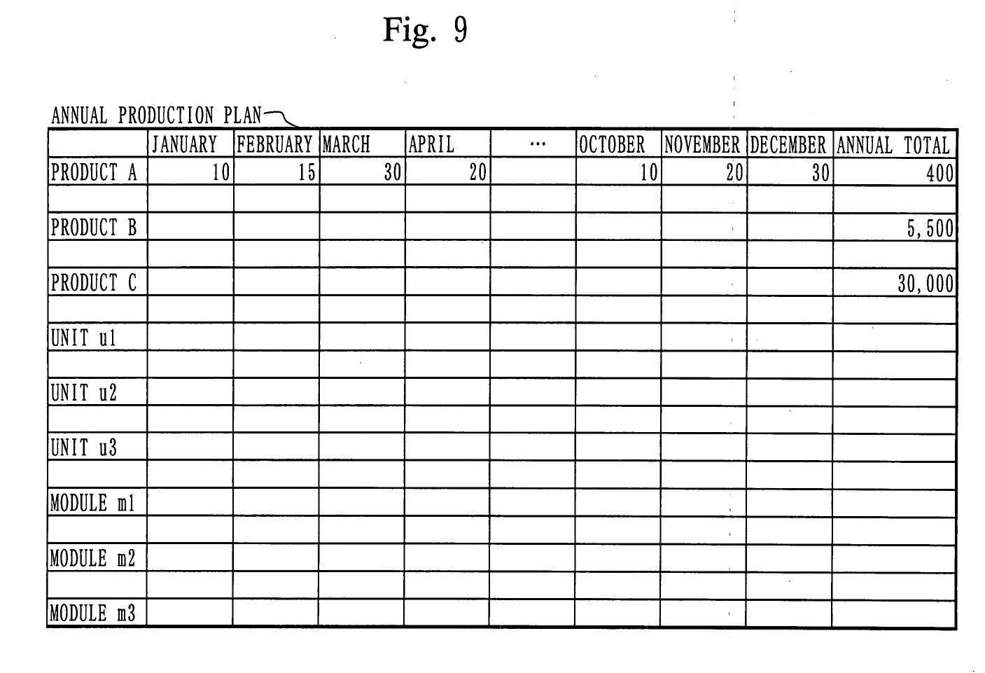

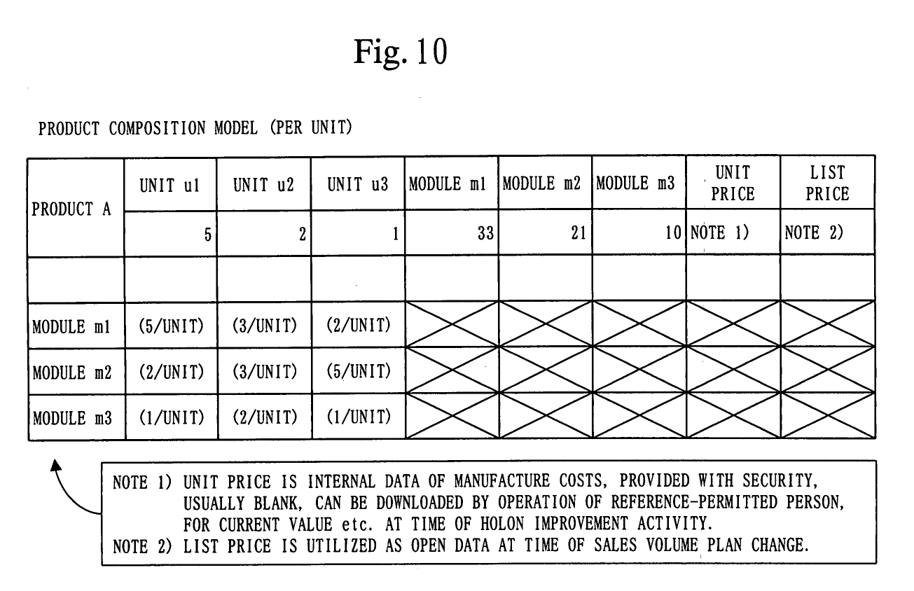

FIG. 9 shows an example of a production plan. In the file data of FIG. 8, an improvement amount per unit (an example of an improvement value) is automatically calculated from the set-up target value and the current value. The profit improvement amount per management term unit (ex. month, half term, etc.) can be calculated by extracting a product required number and a structure component material number (including unit, module, etc.) based on the production plan shown in FIG. 9 from PDM file, and by summing up to be an improvement amount per unit, based on the extracted data. The PDM file indicates FIGS. 10, 11, 12, and 13 to be explained below and their related information.

For example, based on the time when an activity result can be reflected in an actual result depending upon the product plan of FIG. 9, the present system automatically calculates how much to be realized as the profit improvement amount in the current year (this term) and in the future. Then, the calculated results can be displayed in a terminal in the form of FIG. 8, and it is possible to utilize all operations other than revision of management data, as simulation modes.

FIG. 10 shows an example of a composition model (per unit). A module in which a plurality of parts are installed defines a hardware that demonstrates a specific function. The module is also an image as a minimum unit in a classification of a lump.

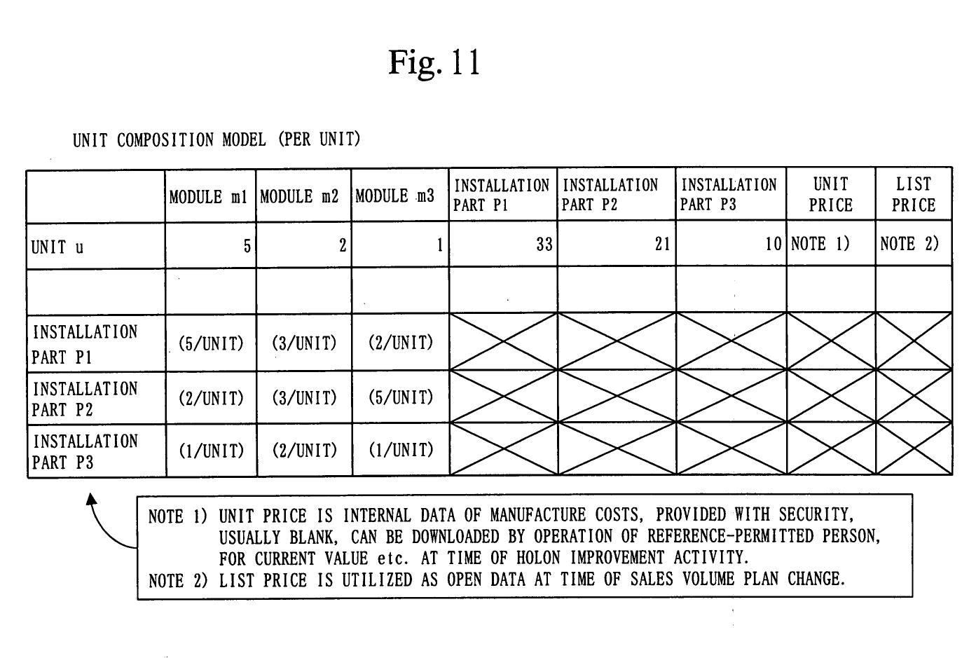

FIG. 11 shows an example of a unit composition model. The unit of FIG. 11 is defined to be composed of a plurality of installation modules, and to be an independence hardware or a lump which has a function of a specific range and a scale. Moreover, the product is defined to be composed of a plurality of installation units, and to be a completed hardware realizing a service function of a customer.

Under the above definition, a Product A is presented in a product composition model as shown in FIG. 10. The Product A is composed of five units of U1, two units of U2, and one unit of U3. Furthermore, the unit U1 is composed of five modules of m1, two modules of m2, and one module of m3. Similarly, the unit U2 is composed of three modules of m1, three modules of m2, and two modules of m3, and the unit U3 is composed of two modules of m1, five modules of m2, and one module of m3, as shown in FIG. 10 as an example. In the present system, when the above-mentioned product composition model is set up, the number of modules to be installed per module name is automatically calculated in the Product A, and presented in the composition model table of FIG. 10. The unit price in this table is distinguished from the open list price, as internal data of manufacture cost, and provided with security. Thus, the protection of closed data to which only a permitted person can refer is provided for this data.

The unit U1 is shown in the unit composition model (FIG. 11). The unit U1 is composed of five modules of m1, two modules of m2, and one module of m3. Further, the modules m1 is composed of five installation parts of p1, two installation parts of p2 and one installation part of p3. In the present system, when the above-mentioned unit composition model is set up, the number of installation parts to be installed per installation part name is automatically calculated for the unit U1, and presented in the unit composition model table of FIG. 11. The unit price in this table is distinguished from the open list price, as internal data of manufacture cost, and provided with security. Thus, the protection of closed data to which only a permitted person can refer is provided for this data.

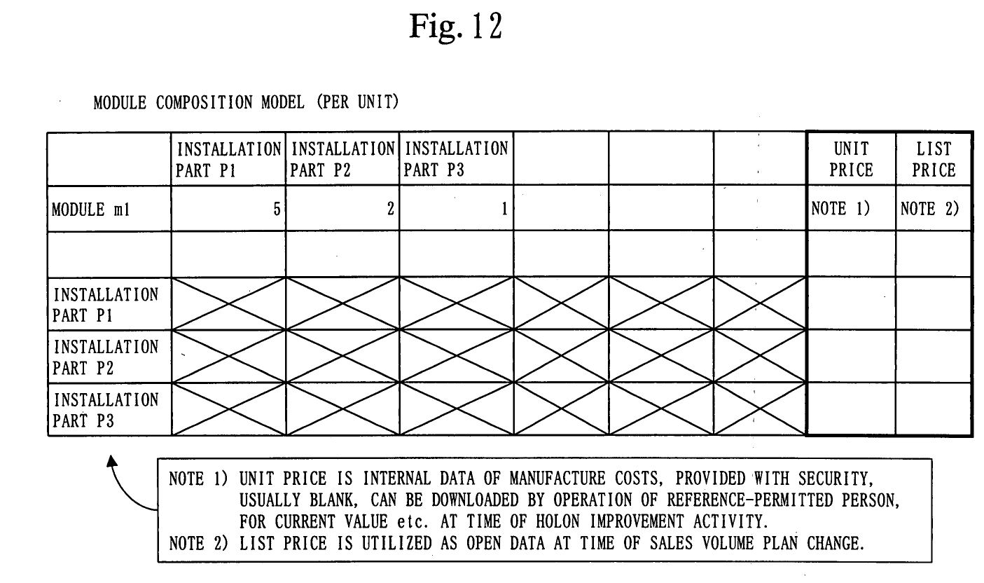

FIG. 12 shows an example of a module composition model. The module m1 is presented in the module composition model (FIG. 12). The module m1 is composed of five installation parts of p1, two installation parts of p2 and one installation part of p3. In the present system, the unit price in this table is distinguished from the open list price, as internal data of manufacture costs, and provided with security. Thus, the protection of closed data to which only a permitted person can refer is provided for this data.

As stated above, in the present system, a product-unit composition, a unit-module composition, and a module-installation part composition can be arbitrarily model-registered as a set-up of the product composition model, the unit composition model, and the module composition model of a terminal.

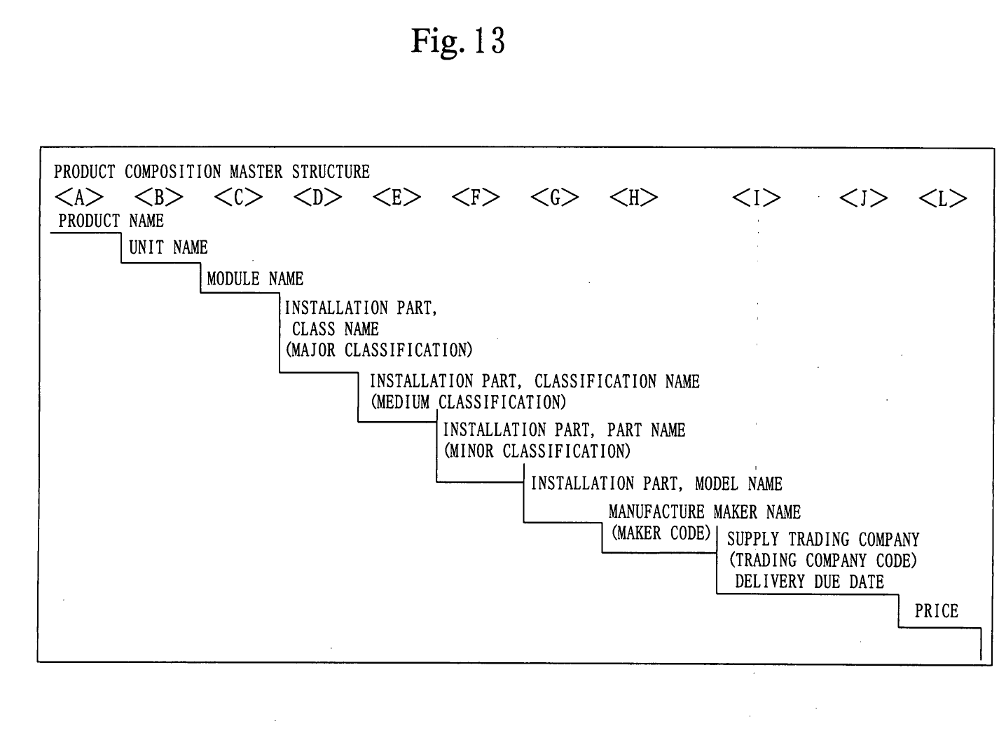

FIG. 13 shows an example of product composition master structure. The above-mentioned product composition model is made from the product composition master structure of FIG. 13. That is, it has a hierarchical structure of a product name, a unit name, a module name, and an installation part name. In addition to such information for producing, information required for procurement etc., such as a class name of an installation part, a classification name, a model name, a manufacture maker name (maker code), a procurement trading company name (trading company code), a price, a quality evaluation, etc. is structured as a series of databases. In the product composition master structure, as a material master structure, an order actual result time-quantity (details), a total number of deliveries in a year, a total number of orders in a year (not yet delivered), and others are accumulated and managed using a material code based on the installation part name, the model name, and the maker name. Using these data, with results of cost reduction activity etc. being influenced by liquidation of the achievement time, a prediction of attainability as actual results values in the current year (this term) is automatically calculated and presented in the present system.

Moreover, by dint of the hierarchical structure as shown in FIGS. 9 through 12, since the retrieval field (ex. the product composition master structure) fits quickly, it is possible to increase retrieval speed at the time of searching there, in the present system. Therefore, at the time of the retrieval operation, the method of presenting the hierarchy of the product composition master structure to a user and of selecting a fixed item per operation procedure serves as the fastest process. It is also acceptable to directly select a certain field or to directly specify a part name-model name or to directly specify a model name. In this case, however, the retrieval time becomes long according to this order.

In addition, as to the attribute (element) of the parts in FIGS. 9 through 12, it is desirable to be based on de facto or a commercial electronic catalog.

Moreover, activity costs needed for the activity and investment-in-plants costs needed for achieving results in FIG. 8 are set up in each field as an activity item. Furthermore, a risk expected to obstruct results achievement or a risk received from change of market conditions is set as an expected risk for each field.

Based on the above data, activity investment efficiency for activity costs and investment-in-plants efficiency & investment collection time for investment-in-plants costs are assessed as costs effectiveness, and priorities are given to the activity items.

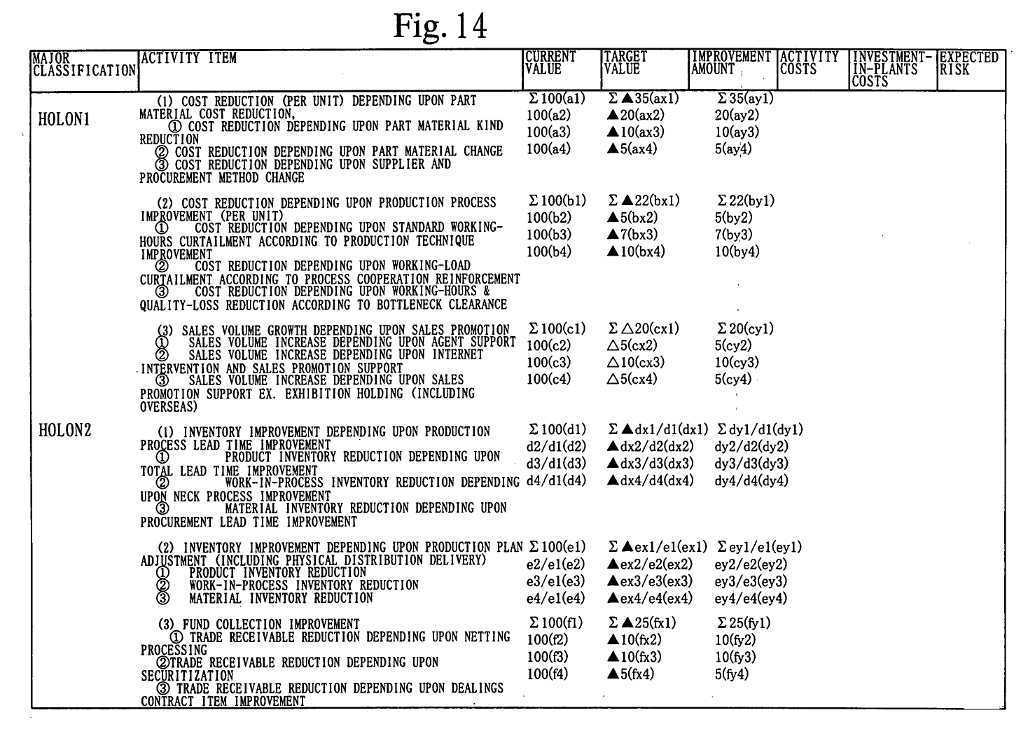

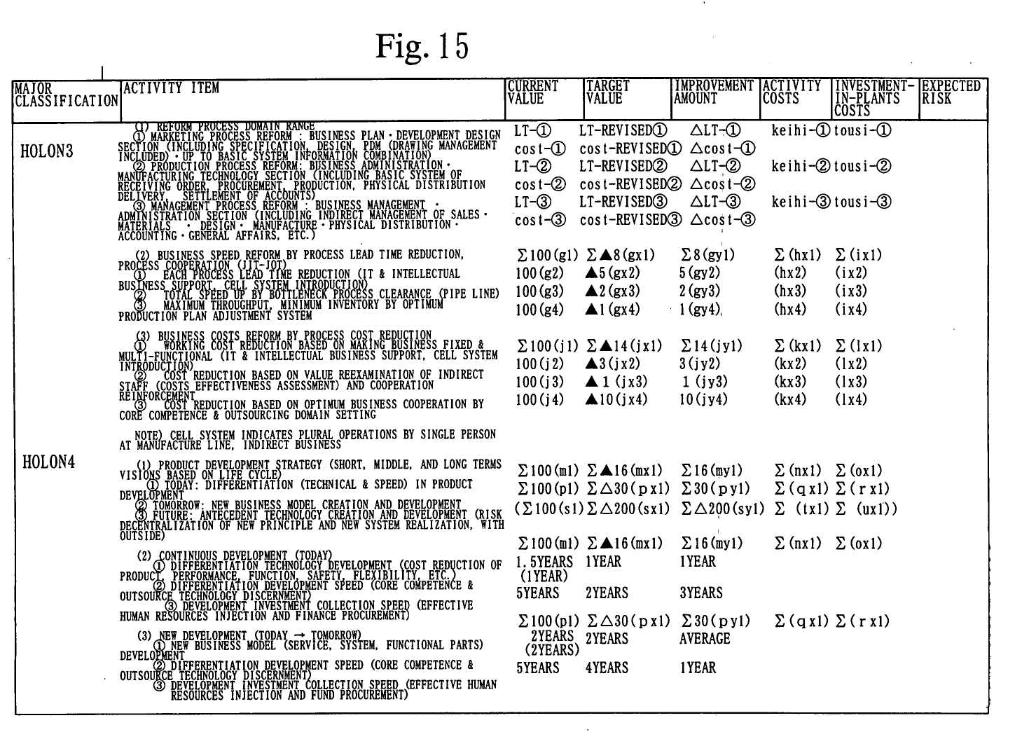

FIG. 14 shows an example of detailed data. FIG. 15 shows a continuation of FIG. 14. In FIGS. 14 and 15, the four kinds of holons as a major classification, a concrete activity item example corresponding to the holons, a current value column of costs and lead time (process time) corresponding to the activity items at the activity starting, a target value column and an improvement amount column which the activity aims at, further, an activity costs column, an investment-in-plants costs column, and an expected risk column are displayed on the terminal. A profit improvement amount column also needs to be displayed, however, it is omitted here in the explanation.

In the example of FIG. 14 and FIG. 15, “throughput improvement” of the holon 1, “assets turnover improvement” of the holon 2, “process reform” of the holon 3 and “product reform” of the holon 4 are major classifications. Then, per the major classification, three kinds ((1) through (3)) of medium classification items in the activity item, and three kinds (\mathring{1} through \mathring{3}) of minor classification items of concrete activities corresponding to the medium classification items are shown. Actually, activity items of the medium classification and the minor classification further increase to widen the range of the activity. Moreover, in the present system, detail classification activity items are defined as the ranks lower than the minor classification item, and ranked as the lowest for activities.

Explanation will be described below.

In (1) a cost reduction (per unit) depending upon a part material cost reduction of the holon 1, \mathring{1} a cost reduction depending upon a part material kind reduction, \mathring{2} a cost reduction depending upon a part material change, and \mathring{3} a cost reduction depending upon a supplier and a procurement method change are shown as minor classification activity items.

Current values of them show details of the costs of the “part material” of (1) medium classification activity item in the system, and 100 (a2), 100 (a3), and 100 (a4) show the same value.

a2 of 100 (a2) is an absolute value. Meaning of 100 is a ratio to the whole, and it here indicates a framework of 100% of the whole. When the minor classification corresponds to the details allotted from a medium classification, the system automatically calculates and presents how much % of the whole.

Therefore, Σ100 (a1) indicates the whole of the part material cost, a1 indicates the total value (absolute value) of a2, a3, and a4, and 100 indicates 100%.

Next, target values are set up at the terminal for each of the minor classification items. When a target value of ax2 is set up at \mathring{1} cost reduction depending upon part material kind reduction, the system automatically calculates the percentage of ax2 of the whole ax1. Then, if the result is 20%, ▴20 (ax2) is presented. ▴ indicates a decrease of cost or time, and Δ indicates an earning increase. If 20% reduction of the whole part material is set up for a target value, the system automatically calculates and consequently shows ▴20 (ax2), which indicates the target value 20% is ax2.

Similarly, at \mathring{2} cost reduction depending upon part material change, the current value 100 (a3), which is equivalent to 100 (a2) herein, is presented by the system. Then, after setting up an aiming target as a target value, that is a target reduction amount ax3 (10% of the whole) or setting up a target reduction percentage 10%, ▴10 (ax3) is displayed as a result, which represents that the target value is 20% of the whole and the target amount is ax3.

Similarly, in FIG. 14, at \mathring{3} cost reduction depending upon a supplier and a procurement method change, 100 (a4) (equivalent to 100 (a2) herein) as a current value, and ▴5 (ax4) as a target value are displayed. Then, the total values of them are displayed as a current value Σ100 (a1) and a target value Σ▴35 (ax1).

Next, the system automatically calculates the column of the improvement amount to display 20 (ay2), 10 (ay3), and 5 (ay4), and further their total value Σ35 (ay1). Here, since the whole ratios of \mathring{1}, \mathring{2}, \mathring{3} are the same, being 100% respectively, the target value and the improvement amount all become equivalent. Thus, the example shows that ax2=ay2, ax3=ay3, ax4=ay4, and ax1=ay1.

Next, (2) cost reduction (per unit) depending upon a production process improvement will be explained. (1) is the cost reduction of the product itself, and (2) is a cost reduction activity depending upon improvement of manufacturing process of producing a product. In the cost reduction depending upon improvement of manufacturing process, the following are defined: \mathring{1} a cost reduction depending upon a standard working-hours curtailment according to a production technique improvement, \mathring{2} a cost reduction depending upon a working load curtailment according to an inter-process cooperation reinforcement, and \mathring{3} a cost reduction depending upon a working-hours & quality-loss reduction according to a bottleneck clearance.

As to this production process, either of a process which is a limited section or a process of the whole production is acceptable. It becomes possible to select the range by specifying a registered name in the system. The example of FIG. 14 shows a certain process which is composed of a plurality of processes. Thus, in the case of performing activities of \mathring{1}, \mathring{2}, \mathring{3} occupying load (lead time) of the whole operation of the certain process, values b2, b3, b4 and b1 of the current values 100 (b2), 100 (b3), 100 (b4), and Σ100 (b1) presented by the system all become equivalent.

In FIG. 14, the total of each target value is Σ▴22 (bx1), which is calculated by adding a target percentage % (target amount) of each small item.

The total of each target value is equivalent to Σ22 (by1) being the total of improvement amounts. If the current value and the target value show the total value of the lead time, being the base of the cost reduction, and a reduction time, the value calculated by multiplying CWR (costs per hour) by bx1 becomes by1 for Σ22 (by1). Then, 22% is presented as the percentage of bx1/b1.

Next, (3) a sales volume growth depending upon a sales promotion will be explained. This (3) is the activity aiming at a sales volume growth of a product by which a gain increase can be planned, unlike the product cost reduction of (1) and (2). It presents how much sales increment amount to be made against the sales amount of the fiscal year plan.

In the example of FIG. 14, \mathring{1} a sales volume increase depending upon an agent support, \mathring{2} a sales volume increase depending upon the Internet intervention and sales promotion support, and \mathring{3} a sales volume increase depending upon a sales promotion support such as an exhibition holding (including overseas) are minor classification items. The ratio of the sales volume increase of the minor classification items to the whole sales volume is 100% in common, and in this meaning, 100 (c2), 100 (c3), 100 (c4), and 100 (c1), being the current values presented by the system, are all equivalent.

Target values Δcx2, Δcx3, and Δcx4 of \mathring{1}, \mathring{2}, and \mathring{3} present increment. 5% of Δ5 (cx2) of \mathring{1} is equivalent to the percentage of cx2/c1. Similarly in \mathring{2} and \mathring{3}, regarding cx1 in the total value ΣΔ20 (cx1), cx1=cx2+cx3+cx4 can be formed, 20% is a value added each % value of the item and is equivalent to the percentage of cx1/c1.

Next, in the “assets turnover improvement” of the holon 2, (1) an inventory improvement depending upon a production process lead time improvement, and (2) an inventory improvement depending upon a production plan adjustment (including a physical distribution delivery) are inventory reduction activities, and (3) a funds collection improvement is a trade receivable reduction activity. The expressions of the current value, the target value, and the improvement amount have the same meaning as those of “throughput improvement” of the holon 1.

A product inventory, a work-in-process inventory, and a component material inventory in (1) and (2) will be explained. The product inventory indicates a product which has been completely manufactured and is waiting for a shipment, in a product group (products A, B, and C, herein) based on the production plan of FIG. 9 mentioned above. In the present system, a current value is calculated by regarding a total value of a product group whose products are completely manufactured but have not been shipped yet at the time and date as the product inventory.

The work-in-process inventory indicates incomplete products, the processing and assembly for which were started by using material, and its current value is obtained by summing them up. The material inventory indicates materials which have arrived but the processing and assembly for which have not started yet, and its current value is obtained by summing them up. The present system has a feature that inventory can be computed and presented in real time at the time and date according to each type and each product.

Therefore, in (1) and (2), the current values (d2) and (e2) of the product inventory are equivalent, the current values (d3) and (e3) of the work-in-process inventory are equivalent, and the current values (d4) and (e4) of the material inventory are equivalent. Accordingly, the total values (d1) and (e1) of the inventory are equivalent. Consequently, d1=d2+d3+d4 is just equal to e1=e2+e3+e4. Moreover, regarding the ratio %, the product inventory current values d2/d1% and e2/e1% are equivalent, the work-in-process inventory current values d3/d1% and e3/e1% are equivalent, and the material inventory current values d4/d1% and e4/e1% are equivalent.

Next, in the case of setting up the target values of the improvement activity as the following: (1) \mathring{1} the product inventory reduction depending upon total lead time improvement is set to be ▴dx2, (1) \mathring{2} the work-in-process inventory reduction depending upon the neck process improvement is set to be ▴dx3, and (1) \mathring{3} the material inventory reduction depending upon the procurement lead time improvement is set to be ▴dx4, the present system presents the total value dx1=dx2+dx3+dx4. The system automatically calculates each ratio (1) \mathring{1} to be dx2/d2%, (1) \mathring{2} to be dx3/d3%, and (1) \mathring{3} to be dx4/d4%, and presents them. The total value % is calculated to be dx1/d1% and presented.

Next, the present system calculates the improvement amount. Being inquired by the system, it should be selected whether to compute a target value as 100% improvement amount or to perform a discount computation considering a risk. Besides, being inquired about a discount rate by the system at the time of performing a discount, the discount rate or a specific formula should be responded at the terminal. Then, the present system automatically calculates and presents it.

In the example of FIG. 14, supposing each improvement amount as dy2, dy3, and dy4, the total value as dy1=dy2+dy3+dy4, each ratio % as dy2/d2, dy3/d3, dy4/d4, and the total value as dy1/d1, the automatic calculation example will be described.

In (2) inventory improvement depending upon a production plan adjustment (including a physical distribution delivery), the setup, the automatic calculation and the presentation by the present system are similarly performed. e1 through e4, ex1 through ex4, and ey1 through ey4 are their data.

Next, in (3) funds collection improvement, \mathring{1} a trade receivable reduction depending upon a netting processing, \mathring{2} a trade receivable reduction depending upon securitization, and \mathring{3} a trade receivable reduction depending upon a dealings contract item improvement are shown as minor classification activity items. This example shows the improvement which aims at reduction of trade receivable. Therefore, the trade receivable total value f1, and f2, f3, f4 in \mathring{1} \mathring{2} \mathring{3} are all equivalent, and ratios are all 100%. When the target values in the improvement are set up to be ▴10%, ▴10%, and ▴5% respectively, fx2 is presented by calculating 10% of f1, f3 is by 10% of f1, and f4 is by 5% of f1 in the present system. 25% of the total f1 is automatically calculated and presented to be the total value fx1. Improvement amounts of them are automatically calculated and presented as fy1 through fy4.

Though the items of the activity costs and investment-in-plants costs in the holons 1 and 2 are blank in the meaning of improvement activity, if there is a case of requiring cost recovery, it is possible to set up suitably and to select a priority activity item by comparing with the profit improvement amount being more than cost recovery. An expected risk column is a hurdle in achieving target values of activity items, and is created and managed as important information which determines the adequacy of starting or executing a plan.

As the goal of carrying out the improvement activities according to the holon 1 and the holon 2 as hard as possible, there are so-called reform activities which aim at increasing competitive power even by injecting funds and aim at expanding the profit. That is, there are “process reform” of the holon 3 and “product reform” of the holon 4.

In the “process reform” in the holon 3, a vague process is roughly divided into a product development, a production sale, and a business management, and it is decided where to strengthen in them and where to be rationalized. Then, as means of the process reform, the process speed is raised and the process costs is reduced. In such forms, the reform is performed. Concretely, they are (1) a reform process domain range, (2) a process lead time reduction, and a business speed reform by process cooperation (JIT-JOT), and (3) a business costs reform by process cost reduction.

(1) In the reform process domain range, there are the following:

\mathring{1} marketing process reform: business plan•development design section (including specification, design, PDM (drawing management included)•basic system information combination),

\mathring{2} production process reform: business administration•manufacturing technology section (including a basic system of receiving orders, procurement, production, physical distribution delivery, and settlement of accounts)

\mathring{3} management process reform: business management•administration section (including indirect management of business•materials•design•manufacture•physical distribution•accounting•general affairs, etc.)

Thus, all processes required for business promotion are included.

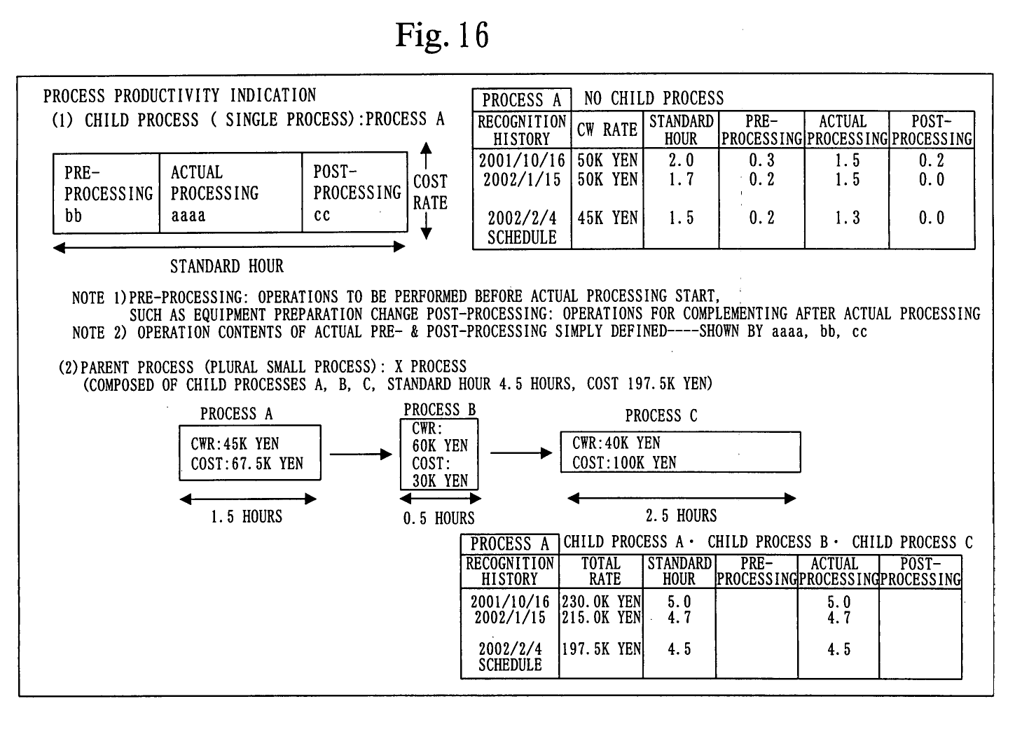

The production process reform of \mathring{2} is the process of a basic system of receiving orders, procurement, production, physical distribution delivery, and settlement of accounts, which produces an actual business value. Although there are good and bad aspects, the production process reform of \mathring{2} basically holds a standard process model for concrete execution. Therefore, current values of lead time LT-\mathring{2} and costs cost-\mathring{2} based on the model exist. (held in the system and described in FIG. 16).

FIG. 16 shows a process productivity indication. The process productivity indication which is necessary for the above processes will be explained referring to FIG. 16. In FIG. 16, (1) shows a child process (process A) being the minimum unit as a single process. In the process, the following are defined: an actual processing which is an operation for exercising a value as a process, a pre-processing which performs a preparation operation needed in advance towards the actual processing, and a post-processing which performs a complement operation for realizing the value fixed as a process after the actual processing. In this process, a cost rate (CW rate) converted into per unit time of work and a standard hour for realizing the value are included.

At the terminal of the present system, the service displaying an image of the size expressed by length of the horizontal axis as a cost rate and the vertical axis as a standard hour is provided.

The data of them will be explained using the process A. Since the process A is a child process, as a single process, it does not hold any other child process. The cost rate and the standard hour in the present system are always brushed up through the improvement/reform activities, and their history data is basically stored. Those data is important as management data, and its data recognition is executed under a strict security management. The present system provides the service by displaying and checking the recognition history at the terminal. For example, the process A shows that, on Oct. 16, 2001, the cost rate is 50 k yen, and its standard hour is 2.0 hours. The details of the standard hour is composed of 1.5 hours of actual processing, 0.3 hours of pre-processing, and 0.2 hours of post-processing. An improvement and reform was suitably performed for this process. On Jan. 15, 2002, the cost rate is 50 k yen and the standard hour is shortened to 1.7 hours. Further, on Feb. 4, 2002, the cost rate is reduced to 45 k yen, the standard hour is shortened to 1.5 hours, and the data will be used as the latest version as from February 4. The revised place is discriminated by a net. In order to reduce the cost rate and the standard hour, it is necessary to standardize operations to be in the form requiring no specialty (technology and skill) and to increase the degree of work maturity by education.

In FIG. 16, (2) shows a parent process. Now, an example of the parent process which is composed of a plurality of processes will be explained. The parent process here is called an X process, and an example of the X process being composed of the child process A, a child process B, and a child process C will be described.

The process A has a cost rate of 45 k yen, a standard hour of 1.5 hours, and consequently, a cost of 67.5 k yen. The process B has a cost rate of 60 k yen, a standard hour of 0.5 hours, and consequently, a cost of 30 k yen. The process C has a cost rate of 40 k yen, a standard hour of 2.5 hours, and consequently, a cost of 100 k yen.

At the terminal of the present system, the composition of the X process is presented in analog by the relation with the child processes, their cost rates and standard hours. Moreover, chasing and checking the revised history can be performed by the history display of Oct. 16, 2001, Jan. 15, 2002, and Feb. 4, 2002.

In FIG. 16, it can be consequently known that it is based on the revision of the process A, and an improvement and reform has not been performed for the processes B and C.

In the terminal of the present system, at the time of appointing “parent process (“X process” in the example)”, the present system automatically shows segment information of child processes A, B, and C. At a change schedule, the present system automatically presents an inquiry “Cost rate? or Standard hour?”. In the example, the actual processing of the child process A is revised to “1.5”, and the CW rate is revised to “45 k yen”. Then, at the time of set-up completion, “2002/2/4 schedule” is displayed in the column of the recognition history, the standard hour is computed to be “1.5” and it is discernibly displayed (flicker display etc.). At the same time, the message of “There is a schedule change in X process, Is it necessary to display it?” is displayed. When answering Yes in the screen, “2002/2/4 schedule” in the recognition history of the X process, “197.5 k yen” in the CW rate column, “4.5” in the standard hour column, and further, “4.5” are automatically computed and discernibly displayed (flicker display etc.) in the actual processing column of the revision part. After completing a check of a series of the revised displays, an inquiry “Revision check O.K.?” is displayed in the terminal. Then, when Yes is performed in the screen, “2002/2/4 schedule” in the recognition history column is changed to “2002/2/4”, and simultaneously the flicker display disappears. This is a series of procedures in the process productivity indication.

Again, it goes back to activity items of the holon 3 in FIG. 15.

LT-revised \mathring{2} and cost-revised \mathring{2} of the target value which indicate an aim of the profit reform from the current value are set up by a terminal operation. Based on those data, the present system can automatically calculate and present an improvement amount. It becomes ΔLT-\mathring{2} and Δcost-\mathring{2}.

In (1), a reform activity progress in concrete processes of (2) and (3) being concrete activities is summarized: a reform activity in the order-receiving domain, the procurement domain, the production domain (some cases include design engineering domain), the physical distribution delivery domain, or the settlement of accounts domain. It is possible to automatically present a target value and an improvement amount in that domain by performing a selection operation of a total value or domain specification at the terminal.

Activity costs and investment-in-plants costs needed for the process reform are keihi-\mathring{2} and tousi-\mathring{2}. Similarly, it is possible to present the activity costs and the investment-in-plants costs in that domain by performing a selection operation of a total value or domain specification at the terminal.

An expected risk column is a hurdle in achieving the target values of activity items, and is created and managed as important information which determines the adequacy of starting or executing the plan.

Marketing process reform of \mathring{1} is composed of business plan•development design section and is a process for creating a business value.

The present system realizes to seamlessly combine the output (results contents) at this point with the production process system of \mathring{2}.

In this domain, a lead time and costs for the productivity progress in the CAE-CAD-PDM-production system exist as reinforcement of engineering environment, and the lead time and the costs are the current values of LT-\mathring{1} and cost-\mathring{1} (held in the system). The proposition to reduce the lead time and the process costs in the engineering domain is common to other domains. The reform is performed by various standardization activities etc., and target values of the reform are LT-revised \mathring{1} and cost-revised \mathring{1}. In the case of referring to details of the LT-revised \mathring{1} and the cost-revised \mathring{1}, the target value and the improvement amount in the corresponding domain can be presented by performing a selection operation of a total value or a domain specification at the terminal. Based on those data, the present system can automatically calculate and present the improvement amount. The improvement amounts become ΔLT-\mathring{1} and Δcost-\mathring{1}. The activity costs and the investment-in-plants costs needed for the process reform of \mathring{1} are keihi-\mathring{1} and tousi-\mathring{1}.

Similarly, activity costs and investment-in-plants costs in the corresponding domain can be presented by performing a selection operation of a total value or a domain specification at the terminal.

Based on the activity costs, the investment costs of the investment-in-plants costs, and the expected risk information, it is possible to timely determine the execution adequacy of starting and progress circumstances of the current activity.

Next, \mathring{3} management process reform indicates a reform in an administration section/indirect section. Comparing with the roles of business plan•development design of \mathring{1}, and value creation/value production of the production process of \mathring{2}, this management process may be a cost rising factor. Though management needs to aim at low-cost operation at the present-day in which the economy is going down, the management process could be a factor of obstructing the low-cost operation. The management process reform can be regarded as a reform process domain in the largest object region of BPR. In this domain, there is management indirect business, such as sales, materials, design, manufacture, physical distribution, accounting, and general affairs. It is a key how much of business speed (including fixed independent business and cooperation between the business) and business costs can be reduced. Defining activities for the former to be (2) and for the latter to be (3), the reform activity BPR is performed. At this stage, (2) corresponding to a business speed increase based on making business fixed and versatile and (3) corresponding to a business cost reduction exercise the effect most.

It is requested to aim at productivity UP by IT practical use and inter-business cooperation strengthening (introduce a cell system). Further, in order to perform a value reexamination (cost effectiveness assessment) of indirect staffs and to guide business value against business cost to the maximum, it is requested for a top administrator to effectively work with related well-informed persons, such as an external consultant. As a premise, it is needed to define models of various business and have philosophy of giving priority to business value precedence over organization precedence.

A framework of a business model is held in the present system, and it contributes to a value reexamination of indirect staffs. In pursuing the value reexamination, it becomes necessary to select outsourcing (business outsourcing). Of course, performing the outsourcing needs a strategic determination considering effects and risks of cost reduction and business speed.

Therefore, in (2) and (3), by specifying a parent process composed of a plurality of child processes at the indirect staff domain or specifying a child process as a limited business region, at the terminal of the present system, current values of the lead time and the process cost of the parent process and the child process can be extracted from an external basic system (ERP, legacy) and presented/used, through the present system or the present system interface (abbreviated I/F hereinafter).

The example in (2) and (3) is the case in which the region specified at the terminal is regarded to be 100% as the whole. Data of current values, target values and improvement amounts at the parent process, the child process, and \mathring{1}, \mathring{2}, \mathring{3} of (2) and (3) are shown by g1 (gx1, gy1) through g4 (gx4, gy4), and j1 (jx1, jy1) through j4 (jx4, jy4).

In the present system, investment activity costs and investment-in-plants costs for achieving the target are presented as hx1 through hx4, ix1 through ix4, kx1 through kx4, and lx1 through lx4. Furthermore, a description of the risk which obstructs the target achievement is presented. Looking at the information and a transition of the information, an administrator can determine the adequacy of executing the activity at the time and date in real time.

In the present system, one reason for discriminating the reform process domain range of (1) into \mathring{1} marketing process, \mathring{2} production process, and \mathring{3} management process is to propose a reform from a different viewpoint (value evaluation) of a different business region, to have a feeling of strain mutually, and to work hard by competing with each other, in order to enhance a synergistic effect.

Next, the holon 4 “product reform” will be explained.

(1) a product development strategy (short term, middle term, and long term visions based on a life cycle) is necessary for the product reform. As shown in FIG. 15, in the present system, \mathring{1} Today: a strategy for differentiation (technique & speed) in product development is planned in the short term. \mathring{2} Tomorrow: a strategy for creating and developing a new business model is planned in the middle term. \mathring{3} Future: a strategy for creating and developing (a new principle and a new system realization by risk decentralization with the outside) an antecedent technology and development is planned in the long term. By planning a strategy, it is possible to clarify the guide needed for carrying out business continuation over a long period.

First, as a product development in a short period, differentiation development is the main for strengthening a competitive power of the present product, which is (2) continuous development. In order to perform the differentiation, activities are planned based on the following: \mathring{1} differentiation technology development (cost reduction, performance, function, safety, flexibility, etc. of a product), \mathring{2} differentiation development speed (core competence & outsource technology discernment), and \mathring{3} development investment collection speed (effective human resources injection and funds procurement).

\mathring{1} In the differentiation technical development, development activities for differentiation from other company, such as a cost reduction of the present product, performance, function, safety, and flexibility are performed. The example of \mathring{1} shows the cost reduction development, and the present system presents Σ100 (m1) indicating that cost per product unit is m1 and indicating 100%, as a current value.

In the case of setting up the cost reduction target to be 16% at the terminal (▴16%), the present system automatically calculates and presents Σ▴16 (mx1) as the cost reduction target per unit, in which mx1 is calculated by multiplying m1 by 16%, in the terminal. Then, the present system adds a completion due date of cost reduction development with a planned quantity of annual product plan which were registered in the terminal. Further, the present system presents Σ16 (my1) as an expected improvement amount. Similarly, activity costs Σ(nx1) required for the cost reduction development and required investment-in-plants costs Σ(ox1) are set up at the terminal. The expected risk at this point is also set up for alert in order that the present system may support a service for appropriately giving an instruction of the cost reduction development in real time. Concretely, the instruction of the cost reduction development in real time is whether the activity has been carried out according to the target or not, whether further investment addition is required for achieving the target or not, etc.

Moreover, as the market changes very much today, the life cycle of products becomes short. Therefore, it is necessary to hurry the development, and to hasten the collection of the funds having been injected into the development, which is \mathring{2} differentiation development speed and \mathring{3} development investment collection speed.

As to the \mathring{2} development speed, it becomes important to discern whether it is possible to win the competition by promoting the conventional fixed development line-up, and also becomes important to timely carry out outsourcing in quest of cooperation when necessary, in order to acquire dominance in the competition.

Henceforth, in order to effectively utilize business management resources, it becomes important to have a strategic development strategy. For instance, the strategy is to know what is the core competence (competitive dominance technology) or to know whether or not the risk can be avoided when performing outsourcing.

In the example of (2), the conventional development speed is 1.5 years as an actual result (plan 1 year). When it is planned at the current value to shorten it to 1 year as a target value, the present system, taking the numerical value of the activity costs and the expected risk into consideration, provides information on the adequacy of the plan. Regarding the activity costs in the example of (2), though Σ(nx1) is the total value, an outsourcing costs can also be registered in the present system. The outsourcing costs can be presented by a specification operation at the terminal.

Moreover, as an activity of the development investment collection speed \mathring{3}, it is necessary to effectively utilize the development speed and the management resources (procurement inside and outside) at the effective human resources injection and the effective funds procurement.

In the example of the \mathring{3}, the collection has conventionally been planned to be five years (the current value), but now the collection is planned to be two years (target value), which indicates an improvement of three years.

Next, \mathring{3} new development (Today→Tomorrow) as a middle term, at least the following are needed: \mathring{1} a new business model (service, system, functional parts) development, \mathring{2} a differentiation development speed (core competence & outsource technology discernment), and \mathring{3} a development investment collection speed (effective human resources injection and funds procurement).

In the above new development, it is practical (investment, risk consideration) to develop a business model by which market can grow based on a holding technical base. Similarly, the present system also supports the activity in the new development. A data example is shown, but explanation is omitted.

Next, in the long-term development (1) \mathring{3}, antecedent technology creation and development are needed as a Future business, in which a new principle and new system realization are required and it is predicted that a development costs and a risk become very large. Therefore, it is desirable to perform promotion based on risk decentralization such as approaching a national project from the first stage and cooperating with an external company. Depending upon the above development as a base, the present system supports a plan and a progressive management of the present technology, antecedent technology, applied technology, product, antecedent technology (basic-application-commercialization) realization time, development injection resources, and funds procurement method.

As mentioned above, according to the present system, it is possible to predict and present an improvement amount in real time, based on a target value and a realization time set up of the concrete activity depending upon the holon 1 through the holon 4. Moreover, the present system supports to decide whether to start and execute the activity, based on the injected funds concerning the activity and the expected risk information.

Furthermore, in addition to supporting the plan of the above activity, the present system performs a progressive management support of the activity and a series of supports in which results of the activity execution are revised as the data of the basic system (ERP, legacy).

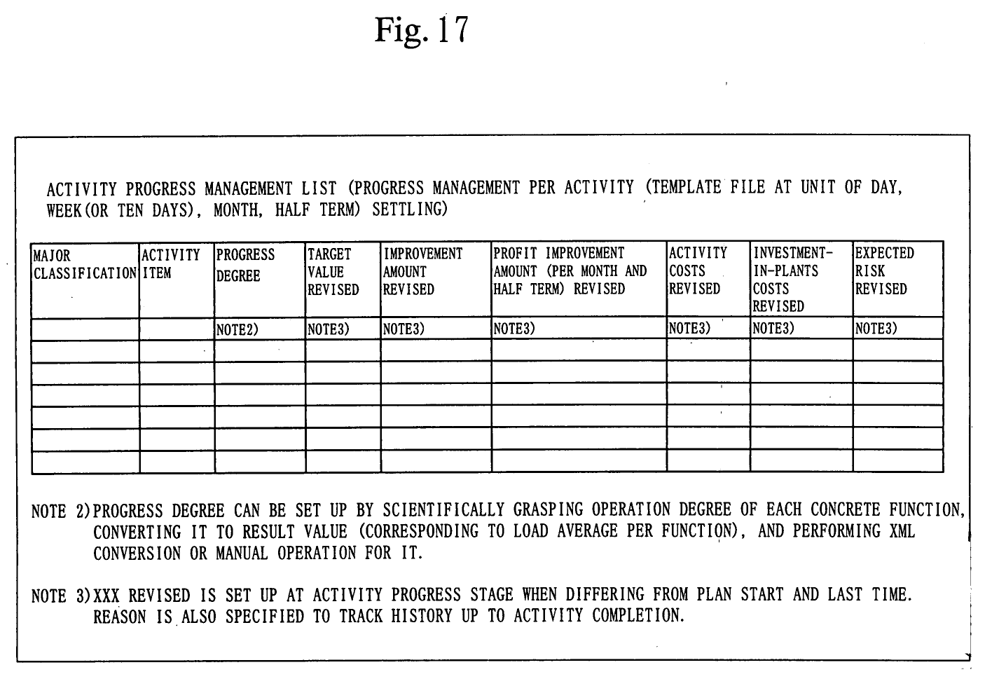

FIG. 17 shows an activity progress management list according to Embodiment 1. In FIG. 17, the activity progress management list includes: major classification, activity item, progress degree, target value revised, improvement amount revised, profit improvement amount, activity costs revised, investment-in-plants costs revised, and generation risk revised. FIG. 17 shows the progress management list per activity in FIG. 8. In FIG. 17, as to the management unit period, plan settling and management are performed based on a template file, with required real-time values of a unit of a day, a week (or ten days), a month, and a half term. Though FIG. 17 has the form being almost the same as that of FIG. 8, the degree of progress is added and a progress execution degree (it is an example of progress information) of every progress management term is shown. Moreover, through the course, in the case of a situation happening to revise the original target value, the target value is set up to be a target value revised (it is an example of the target value corresponding to progress information) at that time, and an improvement amount revised (it is an example of an improvement value) and a profit improvement amount revised are automatically calculated responsive to the set up.

Similarly, at the time of a difference occurrence, being different from the last time, the activity costs revised, the investment costs revised, and the generating risk revised are revised in real time, and it can be promptly judged whether the activity should be continued or not at that time.

The activity progress management list is set up and revised in the case of the stage of the activity progress being different from the first planning time and the last time. For the reference service, in the present system, a general list is presented at the call title of the terminal, through a project name in the activity progress management list. The list can be specified and referred by clicking “time and date” identified in the general list to acquire the specified information. At the time of information being registered in a xxx revised column of the activity progress management list or the time of clicking “revision storage” of the terminal display part, the time information is written and accumulated in the database of the present system.

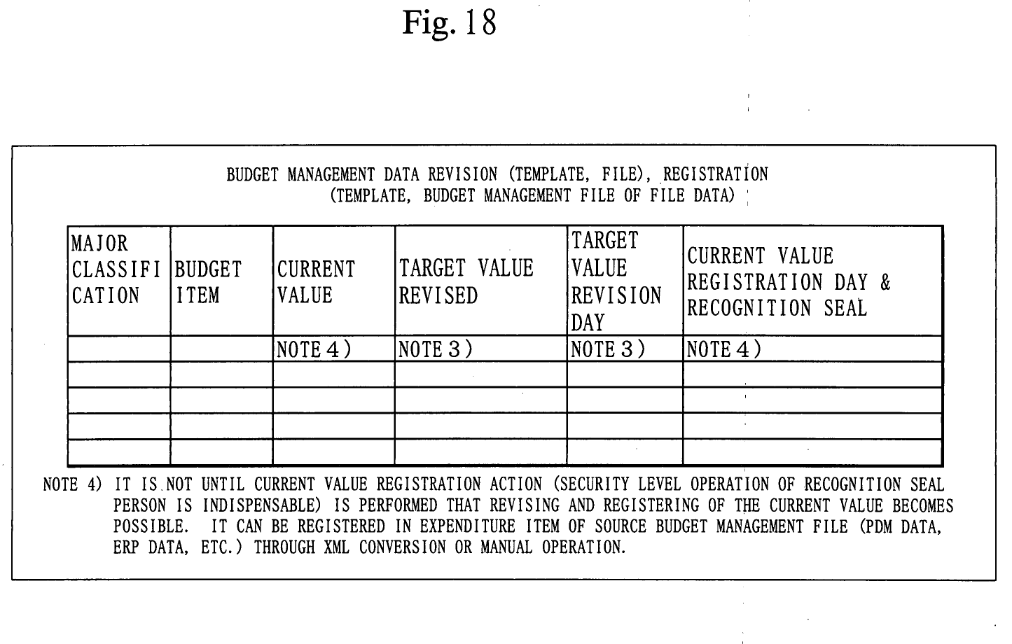

FIG. 18 shows an activity results registration list according to Embodiment 1. In FIG. 18, the activity results registration list includes: major classification, budget item, current value, target value revised, target value revision day, and current value registration day & recognition seal. The template file of FIG. 18 indicates the template file in the case that activity results after the activity completion are registered and converted into the current values of the corresponding expenditure items which serve as the original data of a source budget management file, such as PDM and ERP (basic information system).

At this time, the current value usually becomes the original data of the source budget management file, i.e., the expenditure item data before registration, which becomes different from the target value. The current value registration day & recognition seal shows a value older (past) than the present moment.

At completion of the activity, when becoming executable at the latest value of the target value revised (for example, when a request to register the target value revised into the original data of the source budget management file is sent to a person in charge, in the workflow), by the action of recognition seal (an example of recognition information) operation of the person in charge, data of the target value revised of the template file is transferred to the original data of the source budget management file and the current value of the template file, or is updated (registered) by a manual operation. At the same time, a registration completion date is recorded (registered).

It is not until the current value registration action (security level operation of a seal-of-approval person is indispensable) is performed that revising and registering of the current value become executable. Then, through an XML (extended Markup Language) conversion or a manual operation, it can be registered in the item of expenditure of the source budget management file (PDM data, ERP data, etc.).

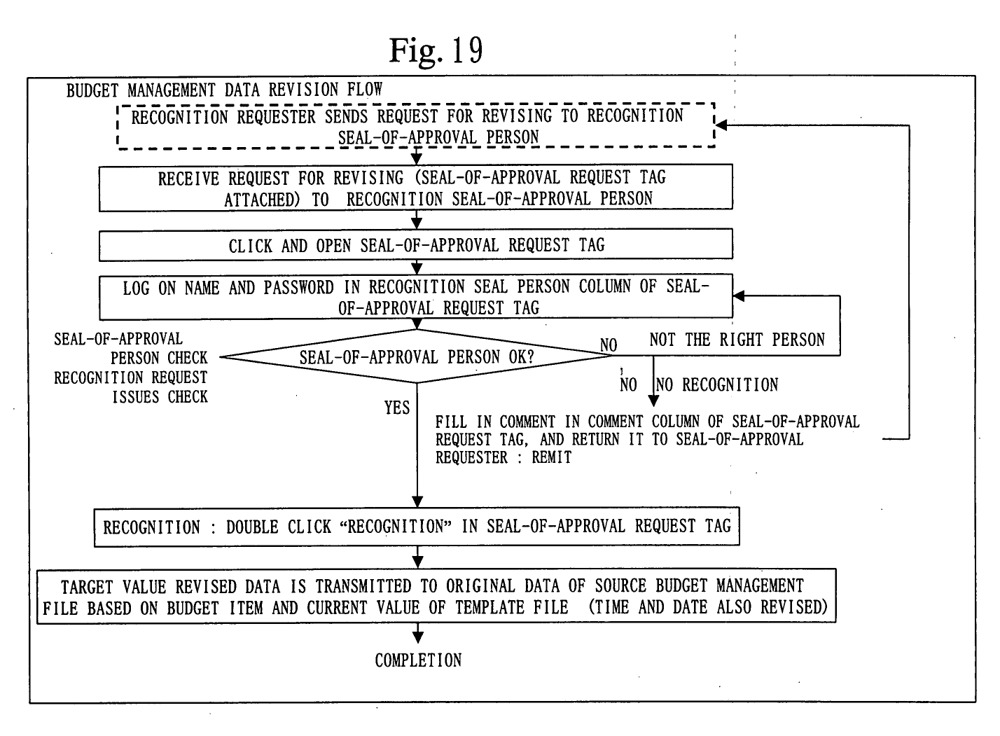

FIG. 19 shows a revision flow of budget management data. Now, at the completion of the activity, it is shown a series of flow of procedures from sending an action for obtaining recognition of formally registering the target value revised in the budget management (the existing basic system data) to receiving it and completing the recognition by a recognition seal-of-approval person.

(1) A recognition seal-of-approval person receives a request for revising (seal-of-approval request tag attached).

(2) Click and open the seal-of-approval request tag.

(3) Log on a name and a password in a recognition seal person column of the seal-of-approval request tag.

(4) Receiving (3), the present system checks the recognition seal-of-approval person, and, when recognizing that it is the right person, the present system checks issues requested to recognize. When there is no problem in the contents of the issues requested to be recognize, it is displayed in the terminal.

(5) Recognition: Double-click the icon of “RECOGNITION” in the seal-of-approval request tag to show the intention of recognition. At the procedure completion of (5), the present system transfers the target value revised data to the original data of the source budget management file based on the budget item and the current value of the template file. (time and date is also revised) (this is (6))

According to the above procedure, the target value is certainly registered in the expenditure item in the existing basic system. Then, various processing will be performed utilizing the data from now on.

In the case of the person not being recognized as the right person in (4) (at the time of “NO RECOGNITION)), it returns to (3). Then, (3) (4) (5) (6) is repeated. Moreover, in discovering imperfection in the recognition issues at (4) and asking a recognition request person for a reply, it is remitted to the requester because of “No Recognition”.

Next, “dynamic production plan adjustment control” and “investment risk adjustment control”, which are deeply related to the holons 1 through 4 and important factors for expanding and realizing the results of the holons, will be explained.

The former is a functional role of (2) (FIG. 14) of the holon 2 and (2) \mathring{3} (FIG. 15) of the holon 3, and the latter functions on decision of the activity costs (FIG. 15) and investment-in-plants costs (FIG. 15) of the holon 3 and the holon 4. Furthermore, in this connection, the expected risk (FIG. 15) functions on making a decision of the adequacy of starting the activity plan or continuing the activity plan execution.

As a fundamental view of the present invention, in order to aim at “continuous profit growth”, the following subjects are common to all of the business:

(1) Efforts to convert time into profit by removing unproductiveness and loss

(2) Efforts to more scientifically quest for corroboration of investment collection

(3) Efforts towards risk control

In order to overcome the subjects of (1) through (3), the “dynamic production plan adjustment control” and the “investment risk adjustment control” serve as important keys.

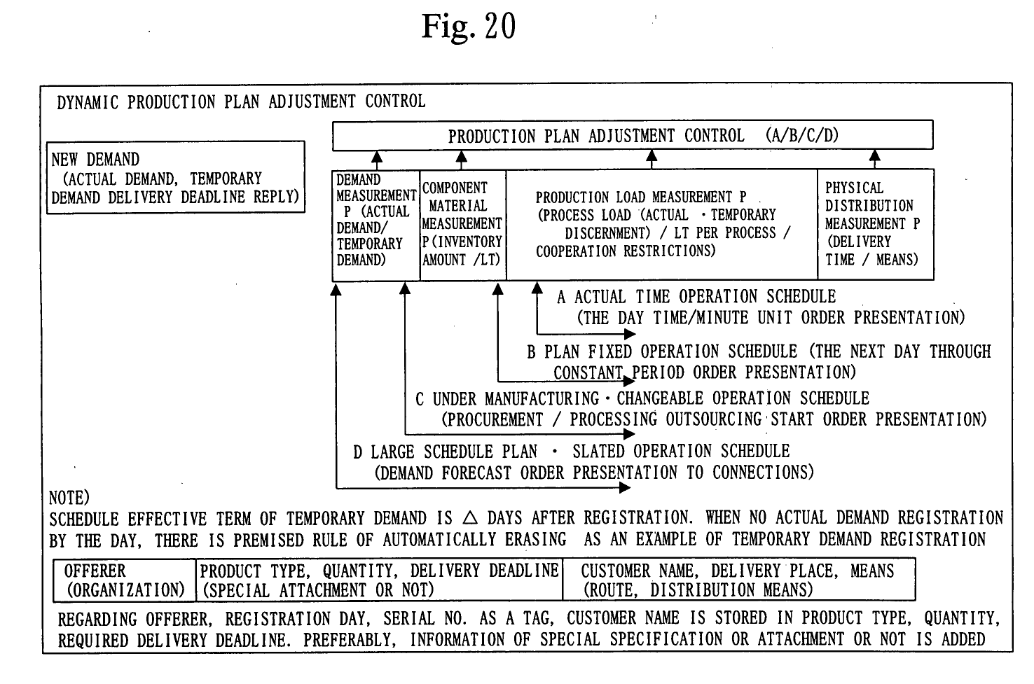

FIG. 20 shows a dynamic production plan adjustment control according to Embodiment 1. In FIG. 20, the dynamic production plan adjustment control includes: production plan adjustment control (A/B/C/D), demand measurement P, component material measurement P, production load measurement P, physical distribution measurement P, A actual time operation schedule, B plan fixed operation schedule, C working in processing•changeable operation schedule, D large schedule plan•operation slated schedule, a new demand (actual demand and temporary demand delivery deadline reply), and its format.

In FIG. 20, under the production plan adjustment control (A/B/C/D), the following are determined: A actual time operation schedule (the day time/minute unit order presentation), B plan fixed operation schedule (the next day through constant period order presentation), C under manufacturing changeable operation schedule (procurement/processing outsourcing start order presentation) and D large schedule plan/operation slated schedule (demand forecast order presentation to connections).

When deciding these schedules A through D, by performing the demand measurement P, the component material measurement P, the production load measurement P, and the physical distribution measurement P, exact adjustment data (an example of demand information, component material information, production load information, and physical distribution information) is supplied to the production plan adjustment control (A/B/C/D). (P is an abbreviation for process, and executes a role operation. For example, it indicates an autonomous functional software module.)

When receiving information of an actual demand (order receiving contract) or a temporary demand (temporary contract) as a new demand from a customer (including an agency, trading company, and other agencies which mediate a maker and a customer), a delivery deadline reply is needed as a response. In the information, a product type, quantity, and delivery deadline (including information on there being attachment or not) are presented. Therefore, in order to calculate a Product LT (lead time) by counting backward from the delivery deadline specified by the customer, the production plan adjustment control (A/B/C/D) performs the following to decide the optimum scheduling:

receive an inventory amount of component material used for composing products, and a procurement LT (an example of part procurement lead time information) for replenishing, from the component material measurement P;

accumulate production LT (an example of the lead time information of the production process) on the load of necessary production process;

considering the restriction conditions (an example of restriction time information) in cooperation between processes, receive from the production load measurement P; and

furthermore, receive delivery LT (delivery means and delivery time) from the physical distribution measurement P based on the information of the specified delivery place.

Simultaneously, required costs until the delivery to a customer is calculated, and it is possible to present it as an estimated value. Furthermore, an example of the case of temporary demand is described at notes in FIG. 20. In principle, an actual demand and a temporary demand are processed based on the same logic as to the production plan adjustment control (A/B/C/D). A different respect is that the schedule effective term of the temporary demand is regulated on a rule, and in the case of there being no actual demand specification in the period, it is automatically canceled and erased from the schedule. The dynamic production plan adjustment control part 5 automatically sends an inquiry of “for or against” the erasure to a demander, and it is also possible to add a more accurate order acceptance confirmation process. Moreover, at the time of over load in the demand beyond the production capacity, a product mix function of the dynamic production plan adjustment control part 5 operates. Usually, a gross profit or a marginal profit for every demanded product is automatically divided by a production lead time per product or a lead time of a process being a bottleneck. Then, being given a priority, a product having a large throughput value is automatically included in the production schedule. Because it is necessary to incorporate democratic processing so that the profit may not be obstructed by priority extortion by an offerer (an agency, sales business, etc.). However, a function of compulsorily setting up delivery deadline priority by manual operation is also added to the above-mentioned product mix function. Therefore, service of high flexibility is realized to select either of them.

Next, the “investment risk adjustment control” aiming at profit growth by making an investment will be explained.

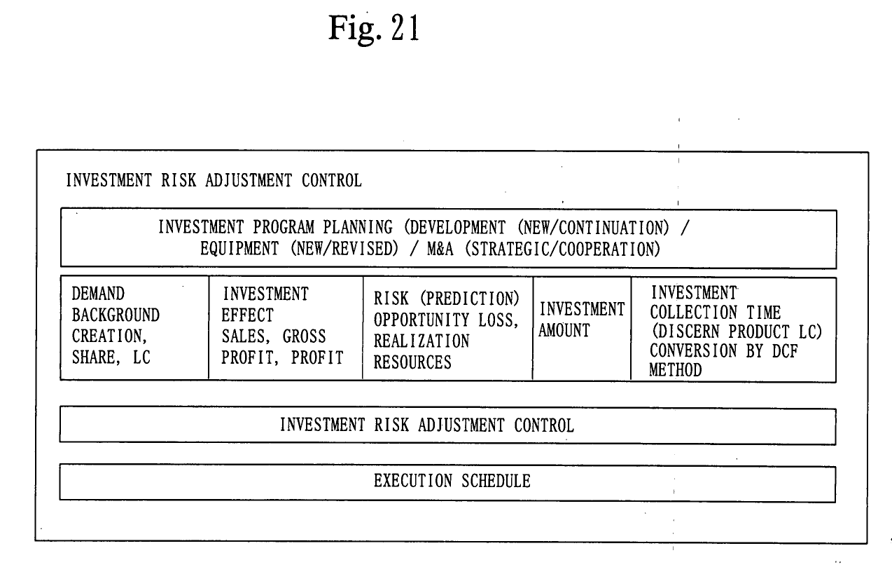

FIG. 21 shows an investment risk adjustment control according to Embodiment 1. The investment risk adjustment control of FIG. 21 includes: investment program planning, demand background, investment effect, risk (prediction), investment amount, and investment collection time & investment risk adjustment control, and execution schedule.

As to the investment, there are an investment for product development (including service), an investment-in-plants for enhancing the productivity, and M&A (merger and acquisition) for efficiently obtaining management resources for business growth etc. As to the product development, there are a product development which starts completely newly and a continuous development in existing business. In the new case, a new plot decision of ffEVA is required, and in the continuous case, it is necessary to decide what domain is to be aimed at from the plot region of the last ffEVA. As to the investment-in-plants, there are a new case and a revising case. The revising case indicates to partly add revision to equipment for which investment has been already made, and serves as a method of raising assets efficiency by repair or reuse of the existing product. As to M&A, there are cases of compulsorily merging or buying out other companies or other business objects as a business strategy, or of cooperating with others to strengthen management resources to be immediately useful. It is necessary for them to be presented as an investment program plan. For making a decision, after distinguishing the cases whether to be newly creating a market as a demand background or to aim at a market share-up in the existing business, the LC (product life cycle) at this moment must be specified.

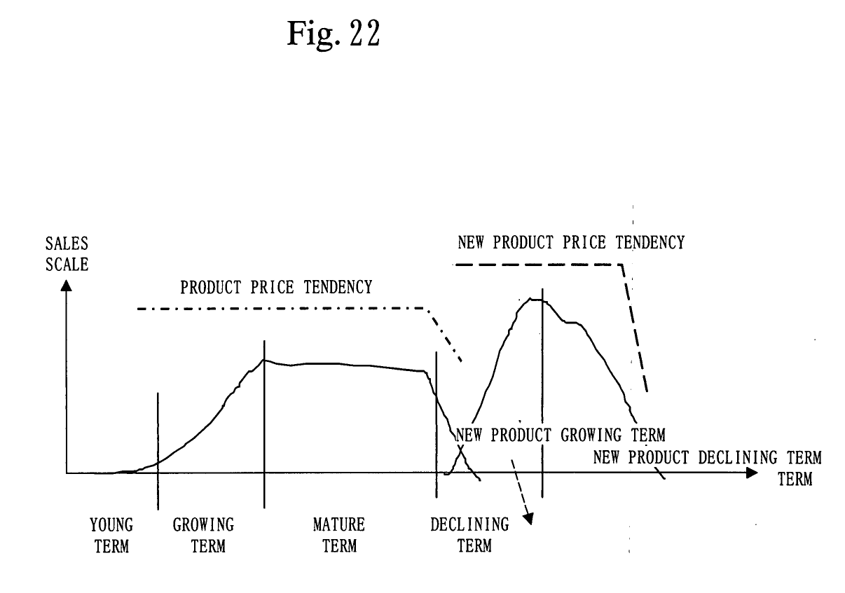

FIG. 22 shows a product life cycle according to Embodiment 1. In FIG. 22, the following are included: term, sales volume scale, product price tendency, and new product price tendency. In FIG. 22, the horizontal axis of the product life cycle (LC) indicates a period of a life cycle, and is divided into a young term, a growing term, a mature term, and a declining term (an example of a plurality of feedback) of a product. Generally, the market demand of each term shows the curve of sales scale as shown in FIG. 22. The product price tendency as merchandise can be shown as a chain line, and this becomes a universal characteristic as a general price of merchandise or as a product price per company.

Of course, since the price is dependent on the market principle determined according to the degree of demand against supply, the price is comparatively expensive in the term where the demand is growing against the supply (mature term) and in the term being flat (growing term). Then, the price tends to drop in an attenuation term (declining term).

Next, regarding an injection of a new product, it similarly passes: the young term, the growing term, the mature term, and the declining term. Usually, the initial value of a price is determined in connection with the existing product. In FIG. 22, a dotted line shows a new product price tendency.

The management indicator and the investment measure which should be concentrated on in each term of this product life cycle become important. That is, in the young term, an investment reinforcement adjustment is performed based on whether there is a tendency that the investment measure for every segment based on a sales volume growth rate exceeds the collection plan or not. In the growing term, an investment reinforcement adjustment is performed based on whether there is a tendency that the investment profit based on a sales volume & profit growth rate and a market share (customer satisfaction) exceeds the collection plan or not.

In the next mature term, with predicting a decline time and especially with estimating a degree of funds based on cash flow, it is preferable to perform a limited investment according to the prospect of short-term collection. Moreover, simultaneously, a demand situation is assessed enough, a market research and such is performed to know whether further demand growth can be expected by further development investment or not, ffEVA is plotted, reinforcement of continuous development investment (business transformation) or its business withdrawal is predicted, and it is determined whether to advance management shift preparation towards a new business (business reproduction) or not.

In the next declining term, it becomes a key that switching from an existing product to a new product is well performed from the viewpoint of profit growth.

The product mix strategy has been described above. As a premise, this strategy must have an evaluation of customer sufficiency degree (habitual using) which shows whether orders can be continuously received from a customer or not.

In the above product life cycle, it needs to discern the type of investment as follows: an investment fundamentally made in order to create demand by a “demand change promptitude” type control, an investment made to increase share, or an investment made to grow profit. By dint of discerning the above, the activity is clearly purified and can be realized by a prompt action. Moreover, in management in the market rapidly changing, it is more important than before to hasten the development investment, the investment-in-plants and the investment collection time at M&A.

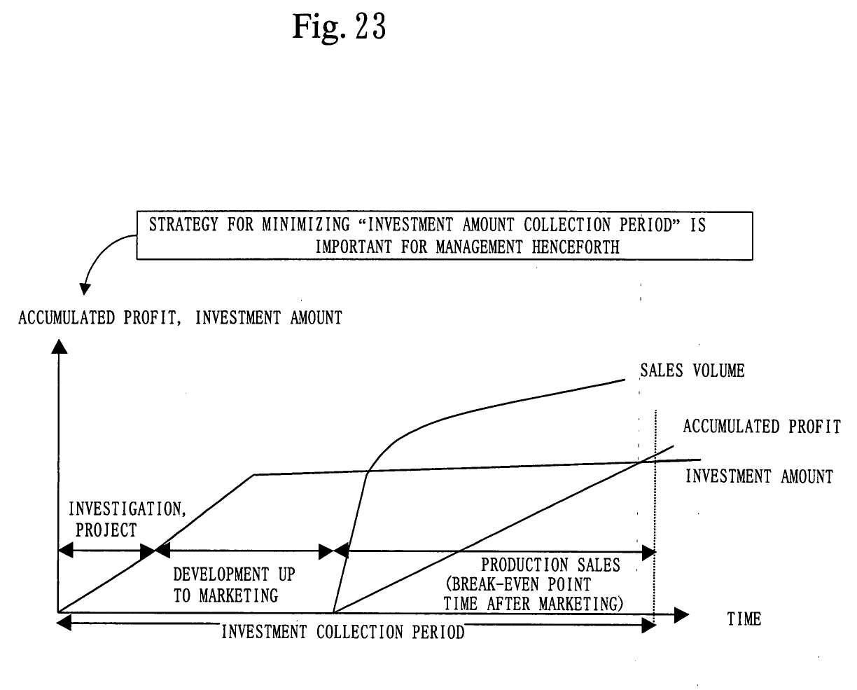

An investment collection graph is shown in FIG. 23. FIG. 23 shows an investment collection graph according to Embodiment 1. FIG. 23 includes: time, investment amount, sales volume, and an accumulated profit. The investment collection period indicates an investigation•project activity period, a development period up to marketing, and an investment injection period, such as continuous development that occurs after appearing on the market and investment-in-plants. The investment collection period indicates time including a break-even point time after marketing. An investment adjustment is needed for minimizing the time.

Now, it returns to FIG. 21. The investment effect is generally evaluated based on the sales volume against the investment amount, a gross profit and a profit amount. However, it is an indicator here that the investment collection period has a margin considering the product life cycle, and the investment against effect is supported by the period. That is, the present system has the function in which investment increase or decrease can be adjusted considering a market change and a transition of the accumulated profit amount as an investment effect.

In the risk (prediction), the following are included: with manifest conditions, a calculation of loss amount in estimating how much opportunity-loss occurs in the case of not making an investment, and a predicted risk in the management resources for realizing the execution in accomplishing a target through the investment. The predicted risk is, for example, an estimate of opportunity loss amount by the delay of market injection time generated in the quality and quantity of resources, etc. These are included in the investment adjustment control part 6.

Although the investment collection term has been described above, the point is adopting a discount cash flow (DCF) method in which a value calculated by adding the depreciation based on investment to the business profit is performed discount-conversion into a present value. Then, an investment total amount is deducted from the converted current value. The reason is it is possible to strictly evaluate the profit generated in the time lag in a preceding injection funds.

Consequently, as shown in FIG. 23, the time of the accumulated profit exceeding the investment amount is the investment collection time.

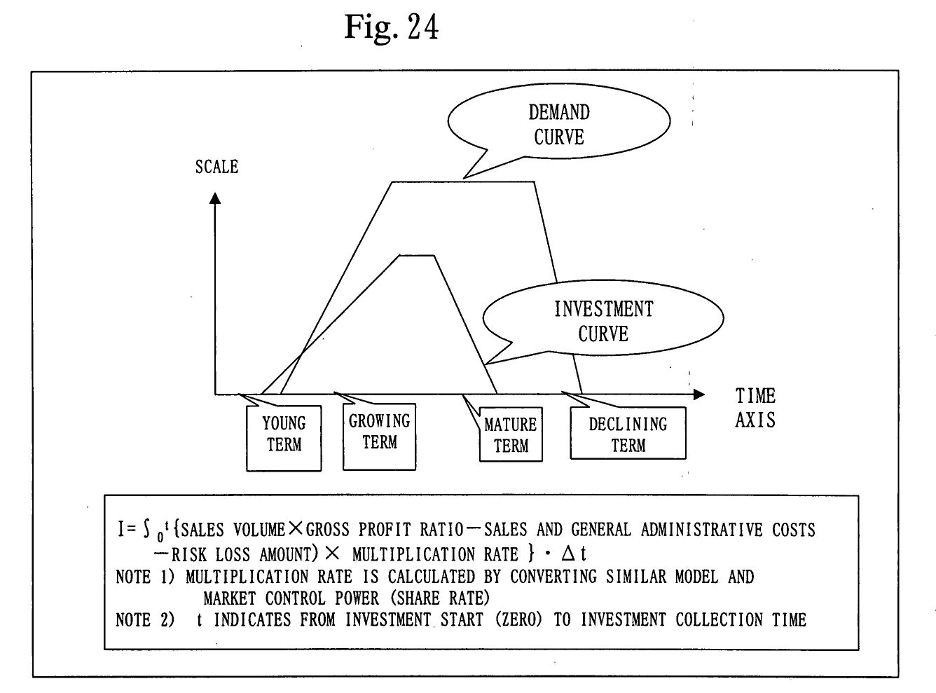

FIG. 24 shows an investment adjustment control according to Embodiment 1. In FIG. 24, a time-axis, a demand scale, an investment scale, and an investment amount are included. For example, the investment amount valuation calculation I can be obtained by multiplying a multiplication rate by an amount which is calculated by subtracting a risk loss amount from a sales profit (sales volume×gross profit ratio−sale and general administrative costs). The multiplication rate (an example of a prescribed value) is based on consideration about the location where the current point is located in young term, growing term, mature term and declining term of the product life cycle, and about the degree of competitive dominance called a market control power. Further, because of the multiplication rate, it is good that comparison consideration of a similar model can be performed.

Thus, an allowable amount of investment can be determined with grasping an actual transition (conditions are specified), which makes it possible to make a more scientific decision.

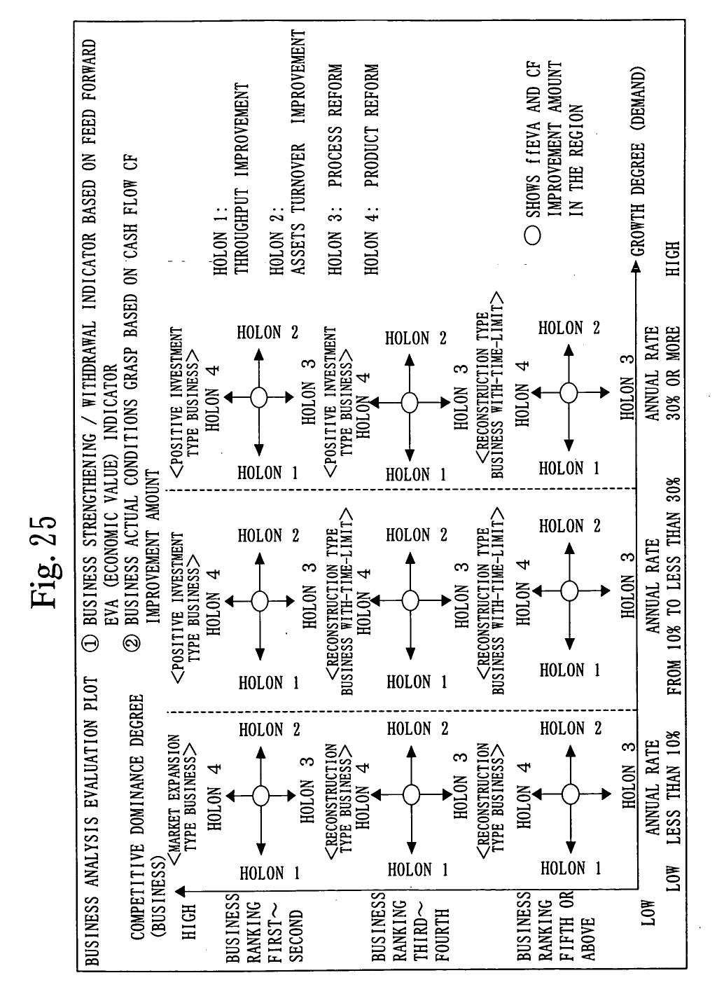

FIG. 25 shows a business analysis evaluation plot. FIG. 25 shows to which position the current business belongs, at the market growth degree (demand) axis and the competitive dominance degree (business) axis. This example shows nine zones for discrimination, and presents whether it is to be a positive investment type business, a market expansion type business, a reconstruction type business with-a-time-limit, or a reconstruction type business considering withdrawal.

Furthermore, in this plot diagram, both the orientation to the future and the business actual conditions are simultaneously measured and evaluated by judging business strengthening/withdrawal indicator based on feed forward EVA (ffEVA) indicator and by judging business actual conditions grasp based on the indicator of the CF improvement amount.

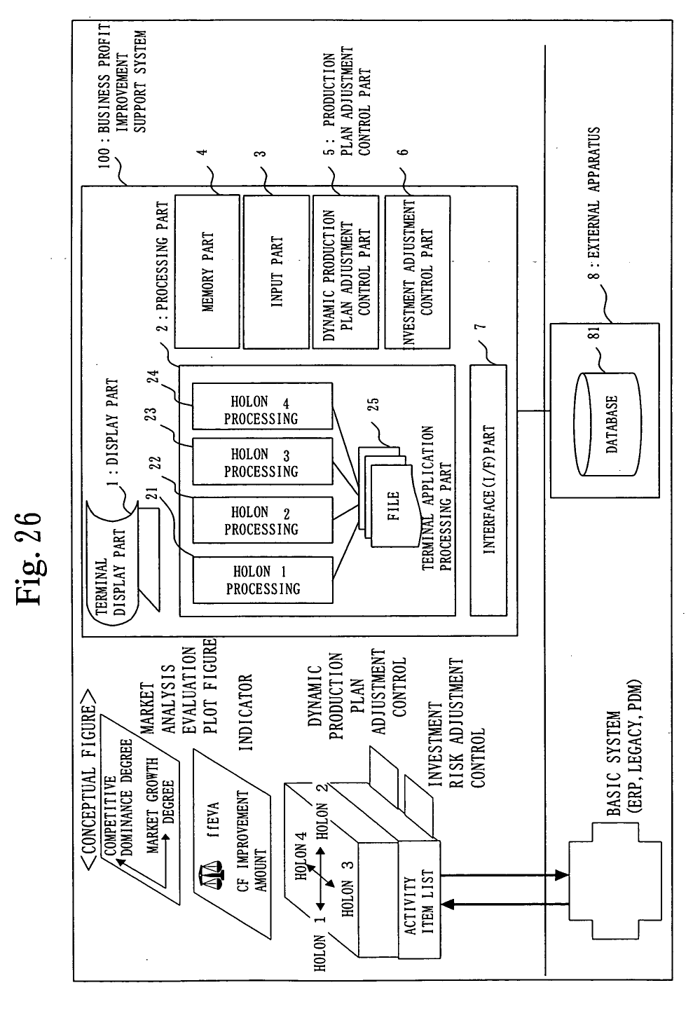

FIG. 26 shows an architecture describing the whole according to Embodiment 1. A conceptual figure and a system figure can be presented as shown in FIG. 26. Thus, by the system, a user obtains a market analysis evaluation plot figure, and performs an indicator. The present system acquires information from the basic system, and performs each Holonic control.

Embodiment 1 provides an ideal model and structure concerning how to advance a business development in a strict selective market which is changing intensively and becoming global, and in which only a handful of companies become business winners and other many companies are in the fate of fading out.

As a key proceeding towards “profit growth”, it is the most important to determine a strategy conversion, more speedily than a motion of the other company, about whether to reinforce the management resources in the current business and strengthen the competitive dominance further or to decrease the management resources in order to aim at the shift towards a new business, and also the most important to swiftly connect it to activities.

In Embodiment 1, the criterion value of the business shift (reinforcement, withdrawal) is determined as follows:

The indicator of EVA (economical added value) is introduced with being given priority over the sales volume profit on accounts.

EVA=sales profit after tax−invested capital costs=(sales profit after tax/invested capital−invested capital cost rate)×invested capital

The term of ( ) presents a qualitative factor (EVA spread) which produces EVA, and the invested capital presents a quantitative factor.

As a result, it can be judged by this formula that there is a tendency when the sales profit after tax exceeds the invested capital cost, EVA enlargement is aimed by a positive investment, and, at the time of minus, the business assets decreases in proportion to the invested capital.

An important respect is to discern a limit of positive investment or investment control responsive to the future. This limit can be reasonably determined by clarifying a growth degree of market demand and a ranking of the current business in the competitive dominance degree in the industry segment. (refer to FIG. 25).

Here, regarding the reasonableness, either can be selected to be a method of scientifically deciding a rule based on know-how of a full knowledge of the industry segment, or to be based on a management judgment by a business top.

It is also possible to convert the above-mentioned EVA formula by, for example, the sales volume profit ratio in order to assess the business evaluation as follows:

EVA≈sales volume profit ratio×0.58−invested capital cost rate

Conversion conditions: the lowest limit of the invested capital cost rate is defined to be 5%, the statutory execution tax rate is defined to be 42%, and they are applied in order to set up the next business section.

The capital cost can be a return (weighted average of the long-term credit rate etc.) at the funds offer side, and further it is possible to treat it as a factor representing a business competitive power degree corresponding to an industry segment.

Based on the above, for example, a business ranking level can be set up and evaluated as follows in order to decide an indicator.

Excellent business: sales volume profit ratio is 13.8% or more (invested capital cost rate is 8% or more)

Contributory business: sales volume profit ratio is from 8.6% to less than 13.8% (invested capital cost rate is from 5% to less than 8%)

Hazing business: sales volume profit ratio is from 3.0% to less than 8.6% (invested capital cost rate is less than 5%)

Low profit margin business: sales volume profit ratio is from 0 to less than 3%

\mathring{1} Regarding the excellent or contributory business; the life cycle at the growing, mature, and declining in the market is discerned to permit an appropriate management resources reinforcement investment.

\mathring{2} Regarding business whose sales volume profit ratio is less than 8.6%; as this business is in the bad term, it is necessary to judge whether to continue or to withdraw. Only the business whose market is in the growing or mature cycle and which can commit 8.6% or more within two years is to be continued, and other business probes into a withdrawal or a new shift.

\mathring{3} The EVA introduction time is applied in the term of growing or after the growing term in the business market cycle, and \mathring{1}, \mathring{2} are applied from the time of the EVA introduction.

ffEVA is used as a judgment indicator for a business transformation or a business regeneration. By the CF improvement amount, it is possible to judge whether funds are effectively functioning based on a business profit and expenditure. By dint of these two, a business orientation and business funds conditions can be judged. In the market, where only a handful of companies can win and remain under an intense change and where risk is larger than the conventional one, a quick decision on a strategy•activity measure and a detailed support based on various data must be prepared. Furthermore, the most optimum activity must be decided and executed on the time-axis of real time corresponding to the scene which is changing.

According to Embodiment 1, in order to accomplish the above objects, the actual conditions of the balance at the current time, the funds treatment and the reflection degree to the effective management are judged by “CF improvement amount” based on the degree of market growth and the degree of competitive dominance. In addition, a future business orientation towards the business reinforcement or withdrawal can be judged by “ffEVA”. Moreover, according to Embodiment 1, in order to perform a concrete profit improvement, a target towards profit growth can be realistically and effectively executed through costs effectiveness and a preferential activity based on an expected risk overcome, depending upon \mathring{1} throughput improvement, \mathring{2} assets management turnover improvement, \mathring{3} process reform, and \mathring{4} product reform under a solid strategy.

According to Embodiment 1, not to mention a business pursuer, a capital investor for the business (stockholder, creditor) and a fund loan lender (bank) can easily make a judgement on investment and financing, and it becomes possible to properly make a proposal for business improvement to avoid an unexpected situation in advance, which simultaneously gives merits for the above three sides.

Embodiment 2

According to Embodiment 1, the example of FIG. 25 shows the ranking of the current business is performed plotting by nine domains. It is possible to adjust the domain increase and decrease by arbitrarily classifying the degree of demand growth and the degree of competitive dominance of the market.

Embodiment 3

In the dynamic production plan adjustment control part 5, the model of production process•inter-process cooperation at the present moment is used as the base. Therein,

(1) Minimize LT (lead time) of each process.

(2) In inter-process cooperation, cut down the buffer (idle time generating or buffer processing time generating) between processes as much as possible, and promote pipelining.

(3) Minimize the lot size and the cycle time of the production plan which realizes multi-frequency production.

By structuring the best model close to ideals of the above (1), (2), and (3), the utmost of receiving-order production can be realized and the profit growth can be further promoted.

Embodiment 4

In the model of the above Embodiments, three items are shown as a concrete activity of the medium classification item and the minor classification item in the holon 1 through holon 4 of the management improvement and reform. The model describes the minimum required for achieving the improvement and the reform. According to Embodiment 4, for the competitive dominance, the activity item can be suitably expanded and assigned to the holon 1 through the holon 4 in order to arbitrarily develop.

By the way, the present invention has described the case of regarding a manufacture industry as a business promoter. However, it goes without saying that the present invention can be utilized by a physical distributor, a trading company, a service industry, and further a business from the government/autonomy. In this case, it is just needed to select or delete which is to be done at the own side and which is to be done by outsourcing, in the demand load measurement P, the component material measurement P, the production load measurement P, and the physical distribution measurement P of the “production plan adjustment control” of FIG. 20.

Embodiment 5

According to Embodiment 1, the hardware product business which typifies the manufacture base is explained as a basic model. This method can also be similarly utilized by a software product business.

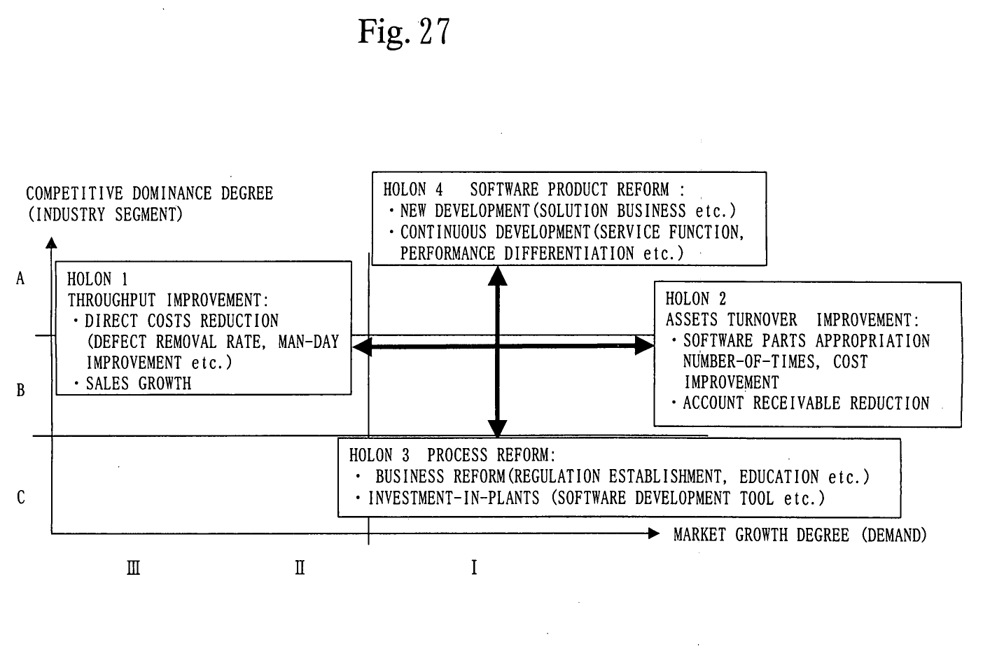

This example is shown in FIG. 27. FIG. 27 shows a software business holonic control according to Embodiment 5. In FIG. 27, a defect (bug) removal rate improvement which is a special feature of software and a man-day improvement in software development, etc. (an example of the first holonic information) are applied as the direct costs reduction in the “throughput improvement” of holon 1.

These lead to a concrete productivity improvement in software development, and, as a result, a software production surplus capability in the period is generated as well as the direct cost reduction. Moreover, it becomes possible to receive further software job, which leads to sales growth.

In the “assets turnover improvement” of holon 2, software parts being software goods, development of which has been completed, are applied as the assets. In the hardware product business in the market changing intensively, stock is a villain which presses management. In the software product business, software parts are splendid good things and assets because cost improvement can be aimed by the software parts which perform cost improvement in proportion to the number of practical use.

Therefore, the number of times of software part appropriation (an example of software part circulation number-of-times information and an example of the second holonic information) is readily reflected in the costs improvement.

Moreover, regarding the accounts receivable reduction, it is the same as that of the hardware according to Embodiment 1.

In the “process reform” of the holon 3, various reforms for the productivity improvement in a software production (including development) process are called business reforms. In this reform, regulation establishment for making a rule for establishment and education of the man in connection with the production (this is required as investment costs) are included. In addition, investment-in-plants such as software development tool etc. for increasing efficiency of software development is added.

In “software product reform” of the holon 4, as the activity of Today similar to Embodiment 1, a differentiation activity from other company by service function, performance, etc. is performed in the continuous development of the product already put in the market in order to overcome the fact.

On the other hand, in order to maintain business, the activities of Tomorrow or Future is also needed. That is the new development, in which an investment of high risk ratio requiring technology research and development of new solution business or a new business model is needed.

Next, based on the improvement and reform of the solid strategy of the above-mentioned holons 1 through 4, an activity item list (template file) for concretely giving a breakdown and taking action is shown in FIG. 8 like the case of Embodiment 1.

In this file, the holons 1 through 4 are specified as activity items of major classification, and activity items to be started are set up for each of the major classification. The following processing is the same as that of Embodiment 1.

The expected risk information shown in FIG. 8 according to Embodiment 1 is generally described in documentation as a factor of obstructing the purpose achievement. In the case of software product, how to predict the risk, predicting in a practical and appropriate form, becomes an important factor which influences the business profit.

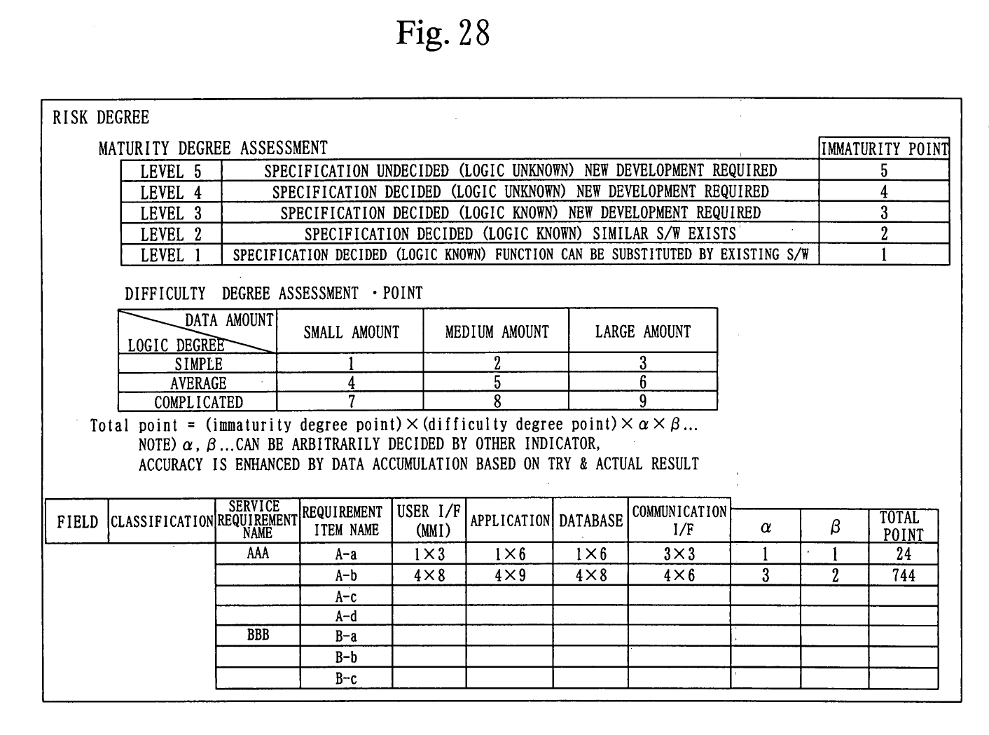

FIG. 28 shows a method of measuring a risk degree in the software development according to Embodiment 5. The productivity of the software development is largely depends on (1) maturity degree of an object model (it is an example of maturity degree information of an object model), and (2) difficulty degree of an object model (it is an example of difficulty degree information of an object model).

(1) The maturity degree of an object model can be estimated by the form supported by a related experience amount (width and depth), having been experienced until now, and the maturity degree assessment is classified into level 1 through level 5 in this model.

The level 1 indicates that the specification has been decided, and moreover, an existing software can substitute for it in performing the realization function. (It is an example of expected risk information and the first level information).

The level 2 indicates that the specification has been decided, and an existing software has a similar function to the realization function. (It is an example of expected risk information and the second level information).

The level 3 indicates that the specification has been decided, there is no existing software which has a similar function to the realization function, and new software development is required. (It is an example of expected risk information and the third level information).

The level 4 indicates though the outline of the specification has been decided (the outline specification is described in documentation), detailed logic is not decided, and it will newly be developed. (It is an example of expected risk information and the fourth level information).

The level 5 indicates that even the outline of the specification has not been decided. Thus, the situation is that the specification outline has not been described in documentation. (It is an example of expected risk information and the fifth level information).

In this model example, these levels are defined to be immaturity marks allotted 1 through 5 showing a risk degree.

(2) Regarding the difficulty degree of an object model, the case depending upon a logic degree complexity or a degree which needs verification acts, such as an experiment, for logic decision and further depending upon data amount will be described as an example.

According to this difficulty-degree-assessment-mark list, the example shows that the vertical axis is defined to be a logic degree (an example of ranking of logic degree of software), the horizontal axis is defined to be a fixed amount measure (an example of ranking of data amount of software) in the matrix of the data amount, and the difficulty degree marks 1 through 9 are defined and allotted.

The user who uses the present system specifies the risk estimation by specifying a level of the maturity degree assessment (in this example, 1 through 5 (an example of maturity degree ranking information)) and a matrix region of the difficulty degree assessment (in this example 1 through 9 (an example of difficulty degree ranking information)).

Regarding the software to develop, the software is composed of a “system” which is used to term the whole, a “software” composing the system and being termed by a role domain for business or an operation, and a “module” composing the software and being termed by an independent function domain. Here, a software and module is described as a representative example.

These software and modules are independent forms, and the composition is distinguishably related by a user interface (MMI), application, a database, and a communication interface that exchanges information with other software through an internal communication or a network communication. That is, as to all the software and modules, the maturity degree assessment and the difficulty degree assessment are specified for each of the user interface, application, database, and communication interface.

In order to promote a software appropriation and reference, sectioning is performed for the field (for example, according to an industry segment or an industry type) and the classification (for example, according to business or a function) at which the software is positioned. Then, hierarchical and detailed definition and registration are performed with regarding a name of corresponding software as a “service requirement name” and an independent module composing the software as a requirement item name”.

In the bottom table in FIG. 28, the example shows that the names of software are “AAA” and “BBB”, module names composing “AAA” are “A-a”, “A-b”, “A-c”, and “A-d”, and module names composing “BBB” are “B-a”, “B-b”, and “B-c.” The modules “A-a” and “A-b” composing “AAA” can be specified by the values of “immaturity degree point”×“difficulty degree point” in the table.

Further, in the bottom table in FIG. 28, α and β (examples of prescribed adjustment values) are added, and they are indicators other than the maturity degree assessment and the difficulty degree assessment. By using the above indicators, it is possible to arbitrarily decide and add. Thus, the structure being able to pursue further reality and validity is prepared.

Total point of risk degree=(immaturity degree point)×(difficulty degree point)×α×β is calculated. The result is presented that “A-a” is 24 points (an example of a calculated value) and “A-b” is 744 points. Thus, the degree of software development risk is quantitatively judged. The risk degree of the software “AAA” is automatically calculated and presented by the system as a total value of composing modules “A-a” “A-b”, “A-c”, and “A-d.”

As stated above, the present system provides the structure where the degree of software development risk is quantitatively presented, and the presented software development risk is reflected in the development load man-day, and the defect removal number etc. used as a quality indicator. Consequently, more practical reaction can be performed.

As mentioned above, the system according to Embodiment 5 includes the structure where the risk degree based on customer requirements (specification) in the software product development of a software business is quantified more practically by performing a maturity degree assessment, a difficulty degree assessment, and a suitable addition of other indicator.

As mentioned above, each of the above Embodiments has a business analysis plot for strictly performing an assessment and an analysis for the ranking in the business current market. The axes for the ranking are made of the degree of market demand growth and the degree of competitive dominance.

As stated above, each of the above Embodiments performs a business analysis indicator by the cash flow improvement amount (CF improvement amount) and the feed forward economical added value (ffEVA).

When it is difficult to obtain a suitable value of a CF improvement amount and an ffEVA as business management data, because, for instance, a management period is very short, the following substitution can be performed. As a representation indicator, the transition of an inventory amount or an inventory turnover number, and a trade receivable amount or a trade receivable turnover number can substitute for the CF improvement amount. A comparison of an order volume and an estimated amount (conditions of receiving orders are considered), and an order transition based on a gross profit can substitute for the value of ffEVA.

Thus, after grasping the ranking, each of the above Embodiments raises four sorts of holons which can carry out a profit improvement and a reform of business in a reasonable (economic rationality) form, as four sorts of solid strategies, as follows:

The first holon: throughput improvement

The second holon: assets turnover improvement

The third holon: process reform

The fourth holon: product reform

As mentioned above, each of the above Embodiments has the following processes: to plan activity items based on breakdown measures depending upon four sorts of holons (solid strategy), to perform giving priority to activities in view of a quantitative effect prediction and an expected risk, to decide the plan being the optimum at the current point (simulation is suitably carried out), and to register it in the profit improvement amount as management data.

The decision process includes the following list bases:

Activity item list (template file)

Activity progress management list (template file)

Activity results registration list (template file)

As mentioned above, in the model of each of the above Embodiments, three items are shown as a concrete activity of the medium classification item and the minor classification item in the holon 1 through holon 4 of the management improvement and reform. The model includes the minimum items which are required for achieving the improvement and the reform and are common to each business.

As mentioned above, each of the above Embodiments has the following as a PDM model of product composition so that a current value relevant to the activity item in the present system, a profit improvement amount, etc. can be read-out from the existing basic system and can be automatically calculated in haste:

It has a hierarchical structure of a product name, a unit name, a module name, and an installation part name. In addition to such information for producing, information required for procurement etc., such as a class name of installation part, a classification name, a model name, a manufacture maker name (maker code), a procurement trading company name (trading company code), delivery deadline, a price, and a quality evaluation is structured as a series of databases.

In the material master structure, an order actual result time-quantity (details), a total number of deliveries in a year, a total number of orders in a year (not yet delivered), and others are performed accumulative management using material codes based on the installation part name, the model name, and the maker name. The present system utilizes these data in order to automatically calculate and present the predicting how much of the results of cost reduction activity etc. can be attainable as actual results values in the current year (this term), with being influenced by liquidation of achievement time.

As mentioned above, each of the above Embodiments has the dynamic production plan adjustment control as an adjustment function used as a key in activity execution. The difficult subject linking directly to profit growth is conquered. The dynamic production plan adjustment control is adjusted based on the amount of demand, volume of inventories (product, component), a procurement lead time, a production lead time, and a physical distribution lead time.

As mentioned above, each of the above Embodiments has the product mix function to act in performing a production plan adjustment control when demand exceeds supply capability.

The product mix function is automatically calculated from a gross profit, a marginal profit for every demanded product, a production lead time per product or a lead time of a process being a bottleneck. Giving a priority to a product having a large throughput value, the product mix function automatically includes it in the production schedule.

As mentioned above, each of the above Embodiments has investment risk adjustment control as an adjustment function used as a key in activity execution, and the difficult subject linking directly to profit growth is conquered.

The investment includes the following:

(1) Development investment

(2) Investment-in-plants

(3) M&A investment

As mentioned above, each of the above Embodiments has the structure procedure of performing a business analysis plot again according to a change and a reform of the market conditions even at the time of activity execution. Further, as the structure procedure, a management measure and an activity which can be suitably responded by a series of cycles are performed, and a business profit improvement is continuously realized.

As mentioned above, the system in the above Embodiments includes the structure where the risk degree based on customer requirements (specification) in the software product development of a software business is quantified more practically by performing a maturity degree assessment, a difficulty degree assessment, and a suitable addition of other indicator.

As mentioned above, the system in the above Embodiments is a management model system for aiming at an effective business reinforcement→maintenance→withdrawal→new business shift, with aiming at a business profit improvement, and includes the following (1), (2), and (3):

(1) to have a business analysis evaluation plot which strictly performs an assessment and an analysis for the ranking in the business current market.

(2) after grasping the ranking of (1), to raise four sorts of holons which can carry out a profit improvement and a reform of business, as four sorts of solid strategies, in a reasonable (economic rationality) form.

(3) to have the following processes: to plan activity items based on breakdown measures depending upon four sorts of holons (solid strategy), to perform giving priority to activities in view of a quantitative effect prediction and an expected risk, to decide the plan being the optimum at the current point (simulation is suitably carried out), and to register it in the profit improvement amount as management data.

According to the business profit improvement support system 100 of the Embodiments 1 through 5, it is a feature that the business profit improvement support system 100 which prompts a user to perform a market analysis evaluation of business and supports profit improvement of the business comprises:

an input part 3 for inputting prescribed information;

a processing part 2 for calculating a value of a prescribed parameter based on the prescribed information inputted by the input part 3, and determining a ranking of the prescribed parameter based on the value calculated, and

a terminal display part 1 for prompting the user to input the prescribed information by the input part, displaying the ranking of the prescribed parameter determined by the processing part 2 in a graph, and prompting the user to perform the market analysis evaluation of the business.

Further, in the business profit improvement support system 100 of the above Embodiment, it is a feature that the prescribed parameter includes, with reference to the business, a competitive dominance degree and a market growth degree.

Further, in the business profit improvement support system 100 of the Embodiments 1 through 5, it is a feature that the prescribed information includes, with reference to the business, ranking information on a sales volume growth degree and ranking information on a profit growth degree, and

the processing part calculates a value of the market growth degree, by using the ranking information on the sales volume growth degree and the ranking information on the profit growth degree and depending upon a prescribed standard, and determines ranking of the market growth degree based on a calculated value.

Further, in the business profit improvement support system 100 of the Embodiments 1 through 5, it is a feature that the prescribed information includes, with reference to the business, ranking information on a plurality of sales volume growth degrees and ranking information on a plurality of profit growth degrees,

the input part 3 inputs ranking information on one sales volume growth degree in the ranking information on the plurality of sales volume growth degrees and ranking information on one profit growth degree in the ranking information on the plurality of profit growth degrees,

the processing part 2 allots a prescribed value to each of the ranking information on the plurality of sales volume growth degrees, the ranking information on the plurality of profit growth degrees, ranking information on each sales volume growth degree in the ranking information on the plurality of sales volume growth degrees, and ranking information on each profit growth degree in the ranking information on the plurality of profit growth degrees respectively,

obtains an added value by adding a multiplied value calculated by multiplying a value allotted to the ranking information on the plurality of sales volume growth degrees by a value allotted to the ranking information on the one sales volume growth degree inputted by the input part 3, and a multiplied value calculated by multiplying a value allotted to the ranking information on the plurality of profit growth degrees by a value allotted to the ranking information on the one profit growth degree inputted by the input part, and

ranks the market growth degree at a position to which the added value belongs.

Further, in the business profit improvement support system 100 of the Embodiments 1 through 5, it is a feature that the prescribed information includes, with reference to the business, ranking information on a customer evaluation, ranking information on cash flow, and ranking information on a profit improvement rate, and

the processing part 2 calculates a value of the competitive dominance degree by using the ranking information on the customer evaluation, the ranking information on the cash flow, and the ranking information on the profit improvement rate and depending upon a prescribed standard, and determines a ranking of the competitive dominance degree based on a calculated value.

Further, in the business profit improvement support system 100 of the Embodiments 1 through 5, it is a feature that the prescribed information includes, with reference to the business, ranking information on a plurality of customer quality evaluations, ranking information on a plurality of customer costs evaluations, ranking information on a plurality of customer delivery deadline evaluations, ranking information on a plurality of cash flow, and ranking information on a plurality of profit improvement rates,

the input part 3 inputs ranking information on one customer quality evaluation in the ranking information on the plurality of customer quality evaluations, ranking information on one customer costs evaluation in the ranking information on the plurality of customer costs evaluations, ranking information on one customer delivery deadline evaluation in the ranking information on the plurality of customer delivery deadline evaluations, ranking information on one cash flow in the ranking information on the plurality of cash flow and ranking information on one profit improvement rate in the ranking information on the plurality of profit improvement rates, and

the processing part 2 allots a prescribed value to each of the ranking information on the plurality of customer quality evaluations, ranking information on each customer quality evaluation in the ranking information on the plurality of customer quality evaluations, the ranking information on the plurality of customer costs evaluations, ranking information on each customer costs evaluation in the ranking information on the plurality of customer costs evaluations, the ranking information on the plurality of customer delivery deadline evaluations, ranking information on each customer delivery deadline evaluation in the ranking information on the plurality of customer delivery deadline evaluations, the ranking information on the plurality of cash flow, ranking information on each cash flow in the ranking information on the plurality of cash flow, the ranking information on the plurality of profit improvement rates, and ranking information on each profit improvement rate in the ranking information on the plurality of profit improvement rates respectively,

obtains an added value by adding a multiplied value calculated by multiplying a value allotted to the ranking information on the plurality of customer quality evaluations by a value allotted to the ranking information on the one customer quality evaluation inputted by the input part 3,

a multiplied value calculated by multiplying a value allotted to the ranking information on the plurality of customer costs evaluations by a value allotted to the ranking information on the one customer costs evaluation inputted by the input part 3,

a multiplied value calculated by multiplying a value allotted to the ranking information on the plurality of customer delivery deadline evaluations by a value allotted to the ranking information on the one customer delivery deadline evaluation inputted by the input part 3,

a multiplied value calculated by multiplying a value allotted to the ranking information on the plurality of cash flow by a value allotted to the ranking information on the one cash flow inputted by the input part 3, and

a multiplied value calculated by multiplying a value allotted to the ranking information on the plurality of profit improvement rates by a value allotted to the ranking information on the one profit improvement rate inputted by the input part 3, and

ranks the competitive dominance degree at a position to which the added value belongs.

Further, according to the business profit improvement support system 100 of the Embodiments 1 through 5, it is a feature that the business profit improvement support system 100 further comprises:

a memory part 4 for storing a first holonic information which improves throughput of business, a second holonic information which improves assets turnover of the business, a third holonic information which reforms a process of the business, and a fourth holonic information which reforms a product of the business, wherein

the input part 3 inputs a current value corresponding to at least one of the first through the fourth holonic information stored in the memory part 4 from an external apparatus 8, and inputs a target value corresponding to the current value, from a user, and

the processing part 2 calculates an improvement value corresponding to the current value and the target value, based on the current value and the target value inputted by the input part 3.

Further, in the business profit improvement support system 100 of the Embodiments 1 through 5, it is a feature that the first holonic information includes, with reference to the business, at least one of part material cost reduction information, production process improvement information, and sales volume growth information based on a sales promotion,

the second holonic information includes, with reference to the business, at least one of production process lead time improvement information, inventory improvement information based on a production plan adjustment, and funds collection information,

the third holonic information includes, with reference to the business, at least one of reform process domain range information, process lead time reduction information, and business costs reform information based on a process cost reduction, and

the fourth holonic information includes, with reference to the business, at least one of product development strategy information, continuous development information, and new development information.

Further, in the business profit improvement support system 100 of the Embodiments 1 through 5, it is a feature that the terminal display part 1 prompts a user to perform a business profit improvement activity based on the first through the fourth holonic Information corresponding to the target value, and to input progress information based on the business profit improvement activity,

the input part 3 inputs the progress information, and

the processing part 2 calculates a target value corresponding to the progress information, based on the progress information inputted by the input part 3.

Further, in the business profit improvement support system 100 of the Embodiments 1 through 5, it is a feature that the processing part 2 calculates, based on the current value inputted by the input part 3 and a calculated target value corresponding to the progress information, an improvement value corresponding to the current value and the calculated target value corresponding to the progress information.

Further, in the business profit improvement support system 100 of the Embodiments 1 through 5, it is a feature that the terminal display part 1 displays a calculated target value corresponding to the progress information and calculated by the processing part 2, and prompts a user to input recognition information for a displayed target value corresponding to the progress information,

the input part 3 inputs the recognition information from the user, and

the processing part 2 converts the current value inputted by the input part 3 into the calculated target value corresponding to the progress information, based on the recognition information inputted by the input part 3.

Further, in the business profit improvement support system 100 of the Embodiments 1 through 5, it is a feature that the terminal display part 1 displays a converted current value converted by the processing part 2 and a calculated improvement value corresponding to the current value and the calculated target value corresponding to the progress information.

Further, according to the business profit improvement support system 100 of the Embodiments 1 through 5, it is a feature that the business profit improvement support system 100 supports profit improvement of the business, based on a production plan of a product corresponding to the business,

the business profit improvement support system 100 further comprises:

a dynamic production plan adjustment control part 5 for controlling the production plan, based on at least one of demand information, component material information, production load information, and physical distribution information.

Further, in the business profit improvement support system 100 of the Embodiments 1 through 5, it is a feature that the dynamic production plan adjustment control part 5 calculates a production throughput value of the product, based on at least one of the component material information, the production load information, and the physical distribution information, and when a plurality of the products exist, controls the production plan to give priority to the product with a calculated production throughput value being large.

Further, in the business profit improvement support system 100 of the Embodiments 1 through 5, it is a feature that the component material information includes part procurement lead time information,

the production load information includes lead time information on a plurality of production processes, and restriction time information on between a production process and a production process in the plurality of production processes,

the physical distribution information includes delivery time information, and

the dynamic production plan adjustment control part 5 calculates the production throughput value of the product, based on the part procurement lead time information, the lead time information on the plurality of production processes, the restriction time information on between a production process and a production process in the plurality of production processes, and the delivery time information.

Further, according to the business profit improvement support system 100 of the Embodiments 1 through 5, it is a feature that the business profit improvement support system 100 supports profit improvement of the business based on investment measures corresponding to the business, and the business profit improvement support system 100 further comprises

an investment adjustment control part 6 for controlling the investment measures, based on investment amount information and accumulated profit information.

Further, according to the business profit improvement support system 100 of the Embodiments 1 through 5, it is a feature that the business profit improvement support system 100 allots a prescribed value to be corresponding to a plurality of periods in progression and each of the plurality of periods,

the input part 3 inputs an investment amount and a profit amount corresponding to each of the plurality of periods,

the investment adjustment control part 6 calculates an accumulated profit amount which accumulates, per period, a multiplied value calculated by multiplying the profit amount corresponding to each of the plurality of periods by the prescribed value corresponding to the plurality of periods, and

the terminal display part 1 displays the plurality of periods, an investment amount corresponding to each of the plurality of periods, and the accumulated profit amount calculated by the investment adjustment control part 6.

Further, in the business profit improvement support system 100 of the Embodiments 1 through 5, it is a feature that the terminal display part 1 displays the plurality of periods, the investment amount corresponding to each of the plurality of periods, and the accumulated profit amount calculated by the investment adjustment control part, in a second dimension coordinate in which one is a time axis and another is an investment amount axis and accumulated profit amount axis.

As stated above, in the business profit improvement support system 100 of the Embodiment 5, it is a feature that the first holonic information includes, with reference to the business, at least one of defect removal rate improvement information and software development man-day improvement information, and

the second holonic information includes, with reference to the business, at least one of software part circulation number-of-times information and funds collection information.

As stated above, according to the business profit improvement support system 100 of the Embodiments 1 through 5, it is a feature that the business profit improvement support system 100 further comprises:

a memory part 4 for storing a first holonic information which improves throughput of the business, a second holonic information which improves assets turnover of the business, a third holonic information which reforms a process of the business, and a fourth holonic information which reforms a product of the business, wherein

the input part 3 inputs expected risk information corresponding to at least one of the first through the fourth holonic information stored in the memory part 4,

the processing part 2 calculates a prescribed value based on the expected risk information inputted by the input part, and

the terminal display part 1 displays the prescribed value calculated by the processing part, with at least one of the first through the fourth holonic information corresponding to the prescribed value, stored in the memory part, and prompts a user to perform profit improvement of the business.

As stated above, in the business profit improvement support system 100 of the Embodiments 1 through 5, it is a feature that the expected risk information is at least one of maturity degree information on an object model and difficulty degree information on the object model.

As stated above, in the business profit improvement support system 100 of the Embodiment 5, it is a feature that the maturity degree information on the object model relates to development of software, and includes

first level information which shows a ranking indicating that, after a specification of the software having been determined, the software corresponding to the specification having been determined can be realizable by using an existing software,

second level information which shows a ranking indicating that, after a specification of the software having been determined, the software corresponding to the specification having been determined is similar to an existing software,

third level information which shows a ranking indicating that, after a specification of the software having been determined, the software corresponding to the specification having been determined needs new software development,

fourth level information which shows a ranking indicating that, after an outline of a specification of the software having been determined, the software corresponding to the outline of the specification having been determined needs new software development, and

fifth level information which shows a ranking indicating that an outline of a specification of the software has not been determined.

As stated above, in the business profit improvement support system 100 of the Embodiment 5, it is a feature that the difficulty degree information on the object model relates to development of software and includes a plurality of difficulty degree ranking information, based on a plurality of logic degree rankings of the software and a plurality of data amount rankings of the software.

As stated above, in the business profit improvement support system 100 of the Embodiments 1 through 5, it is a feature that the expected risk information includes maturity degree information on an object model, and difficulty degree information on the object model,

the maturity degree information on the object model includes a plurality of maturity degree ranking information,

the difficulty degree information on the object model includes a plurality of difficulty degree ranking information,

the input part 3 inputs one of the plurality of maturity degree ranking information and one of the plurality of difficulty degree ranking information, and

the processing part 2 allots a prescribed value to each of the plurality of maturity degree ranking information, allots a prescribed value to each of the plurality of difficulty degree ranking information, and calculates a value by at least multiplying a value corresponding to the one of the plurality of maturity degree ranking information inputted by the input part 3 by a value corresponding to the one of the plurality of difficulty degree ranking information inputted by the input part 3.

As stated above, in the business profit improvement support system 100 of the Embodiments 1 through 5, it is a feature that the processing part 2 includes a prescribed adjustment value for adjusting adequacy of a calculated value, and calculates a value by multiplying the value corresponding to the one of the plurality of maturity degree ranking information inputted by the input part 3, the value corresponding to the one of the plurality of difficulty degree ranking information inputted by the input part 3, and the prescribed adjustment value together.

According to Embodiments 1 through 5, as mentioned above, a business failure can be prevented, and a structure is provided where it is possible to analyze and judge, from the viewpoint of market competitive power, whether it is satisfactory to promote the current business contents, plan and target, to request to amend courses if needed, and to lead an exact activity to people and an organization.

As stated above, the following can be performed by Embodiments 1 through 5:

(1) to have a business analysis plot which strictly performs an assessment and an analysis for ranking the business in the current market.

(2) after grasping the ranking of (1), to raise four sorts of holons which can carry out a profit improvement and a reform of the business, as four sorts of solid strategies, in a reasonable (economic rationality) form.

(3) to have the following processes: to plan activity items based on breakdown measures depending upon four sorts of holons (solid strategy), to perform giving priority to activities in view of a quantitative effect prediction and an expected risk, to decide the plan being the optimum at the current point (simulation is suitably carried out), and to register it in the profit improvement amount as management data.

(4) in executing the activity of (3), to have a dynamic production plan adjustment control and an investment risk adjustment control as an adjustment function used as a key, and to conquer a difficult subject linking directly to profit growth.

According to a change and a reform of the market conditions even at the time of activity execution, it is possible to continuously realize a business profit improvement by going back to (1) and performing a management measure and an activity which can be suitably responded by a series of cycles.

Embodiment 6.

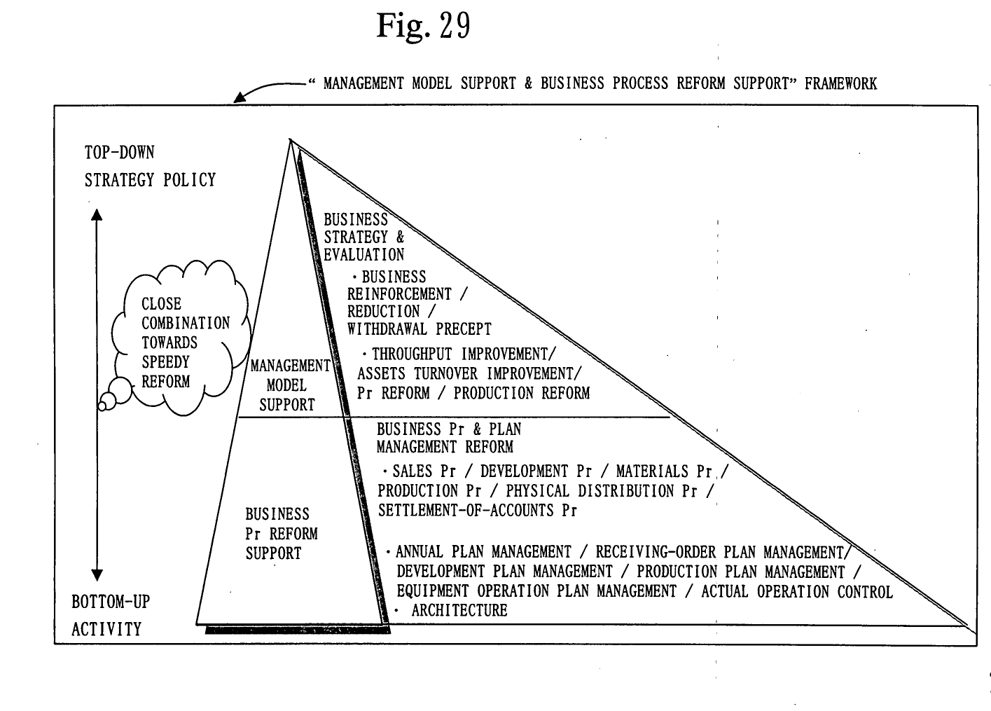

FIG. 29 shows a hierarchy of a business reform. In FIG. 29, a business strategy and an evaluation are regarded to be important as a hierarchy of management model support. A business process (Pr) and a plan management reform are regarded to be important as a hierarchy of business process (Pr) reform support. In the business process of FIG. 29, a sales process, a development process, a materials process, a production process, a physical distribution process, and a settlement-of-accounts process are provided. The business process (Pr) and the plan management reform are executed by relating the above processes with an annual plan management, an estimation plan management, an order-receiving-plan management, a development-plan management, a production-plan management, an equipment operation plan management, and an actual operation control.

Embodiments 1 through 4 are systems mainly located in the hierarchy of the management model support in FIG. 29. In Embodiment 6, the system mainly located in the hierarchy of the business process (Pr) reform support in FIG. 29 will be explained.

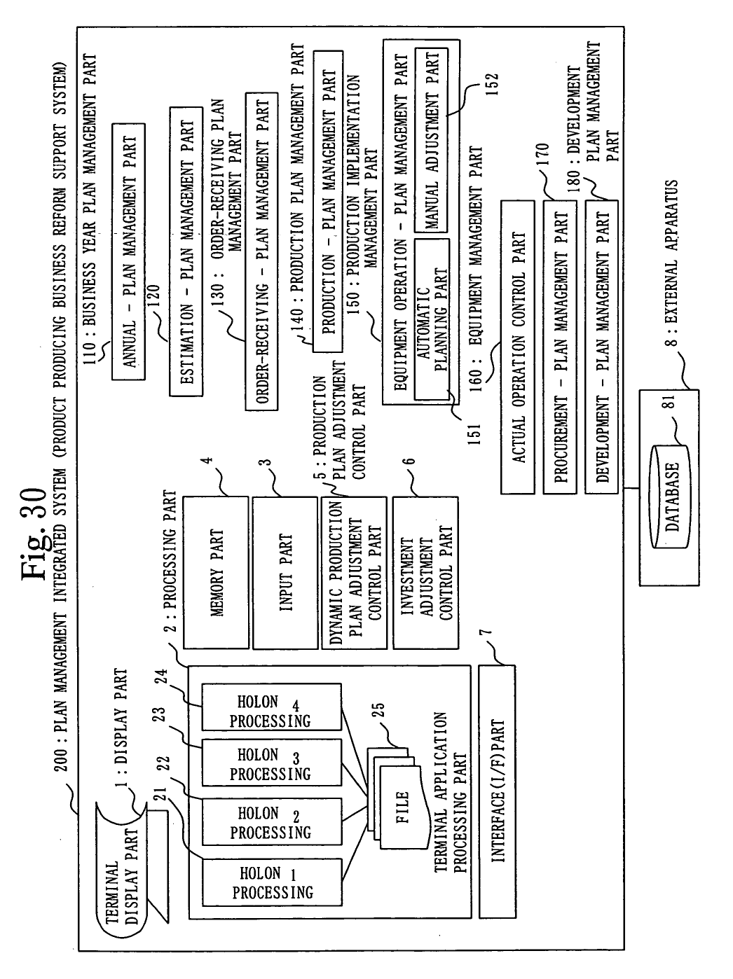

FIG. 30 shows a composition according to Embodiment 6. In FIG. 30, a plan management integrated system 200 (it is an example of a product producing business reform support system, and a business profit improvement support system) includes the terminal display part 1, the terminal application processing part 2, the input part 3, the memory part 4, the dynamic production plan adjustment control part 5, the investment adjustment control part 6, the I/F part 7, an annual-plan management part 110 (it is an example of a plan management part, and a business year plan management part), an estimation-plan management part 120 (it is an example of the plan management part, and an estimation plan management part), an order-receiving-plan management part 130 (it is an example of the plan management part, and an order-receiving plan management part), a production-plan management part 140 (it is an example of the plan management part, and a production plan management part), an equipment operation-plan management part 150 (it is an example of the plan management part, and a production implementation management part), an actual operation control part 160 (it is an example of the plan management part and an equipment management part), a procurement-plan management part 170 (it is an example of the plan management part, and a procurement plan management part), and a development-plan management part 180 (it is an example of the plan management part and a development plan management part).

The equipment operation-plan management part 150 includes an automatic planning part 151 and a manual adjustment part 152.

The terminal application processing part 2 includes the holon 1 processing 21, the holon 2 processing 22, the holon 3 processing 23, the holon 4 processing 24, and the file 25 like Embodiment 1.

The plan management integrated system 200 is connected to the external apparatus 8. The external apparatus 8 includes the database 81. ERP is an example of the external apparatus 8.

The terminal display part 1, the terminal application processing part 2, the input part 3, the memory part 4, the dynamic production plan adjustment control part 5, the investment adjustment control part 6, and the I/F part 7 are the same as those of FIG. 1.

The order-receiving-plan management part 130 manages order-receiving plan information which is changing. The order-receiving plan information is stored in the memory part 4.

The production-plan management part 140 generates production plan information based on the order-receiving plan information managed by the order-receiving-plan management part 130, and manages the production plan information corresponding to the change of the order-receiving plan information. The production plan information is stored in the memory part 4.

The equipment operation-plan management part 150 generates production implementation information based on the production plan information managed by the production-plan management part 140, and manages the production implementation information corresponding to the change of the production plan information. The production implementation information is stored in the memory part 4.

The terminal display part 1 displays at least one of the order-receiving plan information managed by the order-receiving-plan management part 130, the production plan information managed by the production-plan management part 140, and the production implementation information managed by the equipment operation-plan management part 150. Then, the terminal display part 1 prompts a user to perform a product producing business reform.

The actual operation control management part 160 generates equipment control information which controls production equipment based on the production implementation information managed by the equipment operation-plan management part 150, and manages the equipment control information corresponding to the change of the production implementation information. The equipment control information is stored in the memory part 4.

The annual-plan management part 110 manages business year plan information, and outputs the managed business year plan information to the order-receiving-plan management part 130 as one order-receiving plan information in the order-receiving plan information which is changing. The business year plan information is stored by the memory part 4.

The development-plan management part 180 inputs the business year plan information from the annual-plan management part 110, manages development plan information on a product based on the inputted business year plan information, and outputs the managed development plan information to the order-receiving-plan management part 130. The development plan information is stored in the memory part 4.

The plan management integrated system 200 is characterized by separately inputting a plurality of prescribed information from the external apparatus 8.

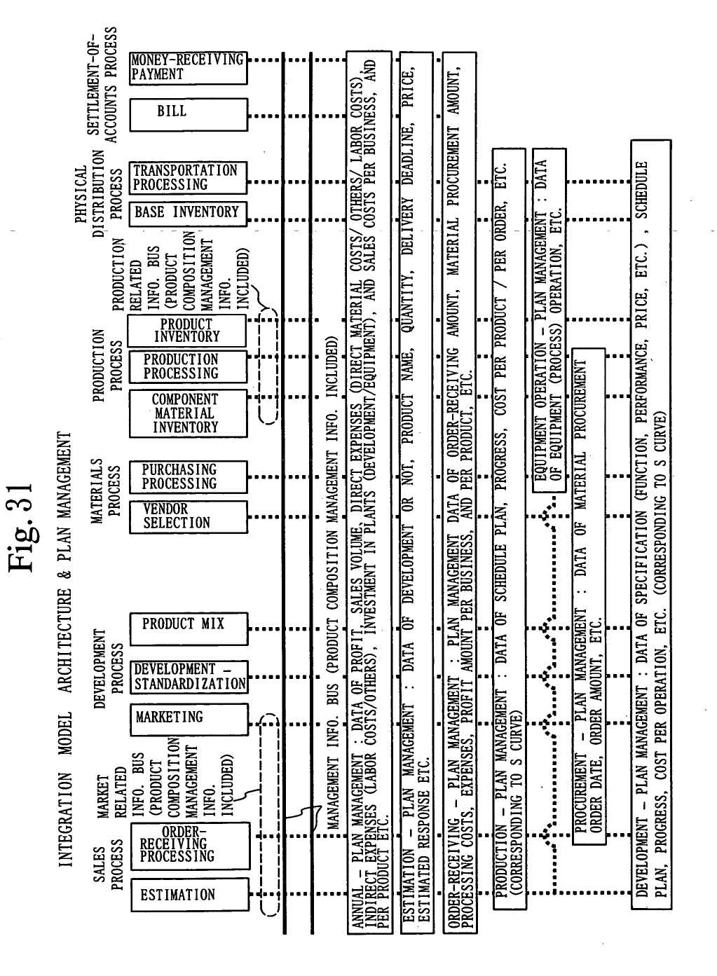

FIG. 31 shows a business process of the whole company, i.e., the sales process, the development process, the materials process, the production process, the physical distribution process, and the settlement-of-accounts process.

A main business exists in each business process. For example, estimation business and order-receiving processing exist in the sales process, marketing, development-standardization business, and a product mix measure business to a new product shift from an existing product exist in the development process, a vender selection and purchase processing in the materials process, component material and product inventory management and production processing exist in the production process, a base inventory management and transportation processing exist in the physical distribution process, and bill processing and money-receiving payment processing exist in the settlement-of-accounts process.

According to Embodiment 6, all of business can be effectively performed by plan management of only seven sorts for each business process:

I annual-plan management

II estimation-plan management

III order-receiving-plan management

IV production-plan management

V equipment operation-plan management

VI procurement-plan management

VII development-plan management

The “effectively” described herein indicates to progress towards “growth of a gross profit and a cash flow CF improvement” which are directly linked with a business profit growth, and adjusts various risks which obstruct it, in feed forward.

The annual-plan management part 110 performs an annual plan management.

The estimation-plan management part 120 performs an estimation plan management.

The order-receiving-plan management part 130 performs an order-receiving plan management.

The production-plan management part 140 performs a production plan management.

The equipment operation-plan management part 150 performs an equipment operation plan management.

The procurement-plan management part 170 performs a procurement plan management.

The development-plan management part 180 performs a development plan management.

Moreover, in the present Embodiment, information required between each business process and various plan management is composed of market related information, production related information and various management information, making product composition management information as a core. Thus, it is possible to structure a system where information is suitably increased or decreased by self-multiplication based on a minimum information, in order to be economical and highly flexible.

In FIG. 31, a product composition management information bus, a market related information bus, a production related information bus, and a management information bus perform bridging between each business process and various plan management.

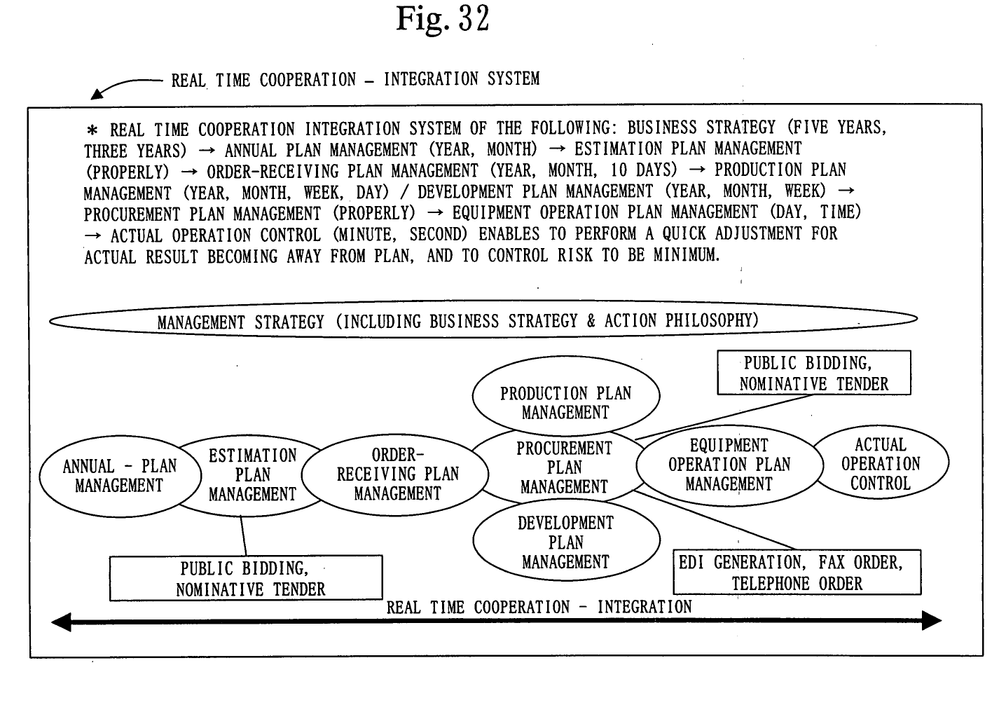

FIG. 32 shows “real-time cooperation-integrated system” of plan management of the plan management integrated system. Cooperation-integration of seven sorts of plan management will now be explained referring to FIG. 32.

Based on a management strategy of the highest rank, that is a business middle or long term (three years, five years, etc.) strategy, “annual-plan management” of the current year is set up. The selling sales and shipment quantity of the current term (income) are set up. Activity financial funds of selling, production etc. (expenditure) are planned and set up.

Next, it exists “order-receiving-plan management” which receives a concrete order-receiving contract issue and creates input information for a low-ranking production plan. “Estimation-plan management” used as a premise activity of an order-receiving contract has a role of intermediate between the above two sorts of plan management.

Based on this “estimation-plan management”, concrete activities of “public bidding and nominative tender” are performed at the business spots.

Based on the order-receiving contract information of the “order-receiving-plan management”, “production-plan management” exists. The “production-plan management” plans and sets up an activity schedule which is indispensable to production activities, such as a load control of a production process, and component material order date based on procurement lead time, with making inventory information and contract delivery deadline as a basis.

Moreover, “development-plan management” for producing a new product, whose level in the flow is the same as that of the “production-plan management” exists.

“Procurement-plan management” exists for performing order processing including prices and arrival dates of procurement components needed by those “production-plan management” and “development-plan management”.

Regarding the order processing based on the “procurement-plan management”, “order processing through a facsimile” or “order processing through a telephone” based on “EDI through a network” is concretely performed at the business spot.

Moreover, based on the information on “production-plan management”, “equipment operation-plan management” exists for deciding time and date of starting and completing an equipment operation (a production tool in a broad sense including CAE-CAD in designing) of a process required for production.

Based on the “equipment operation-plan management”, there is an actual operation control of an equipment apparatus which performs concrete production. The above stated are all the elements required for production.

According to Embodiment 6, it is an object that these “plan management” of seven sorts are formed into cooperative integration (the integration indicates that data appropriation and an activity incentively act on other activities), decision-making and execution are performed based on the action idea of “a gross profit growth and a cash flow CF improvement”, and the result is reflected in this “plan management” in real time to link directly to the business profit.

According to Embodiment 6, the annual-plan management part 110 in the plan management integrated system 200 sets up various management indicator values as one example of business year plan information required for concrete business execution, in the “annual-plan management”. Various business targets (profit, sales volume, management resources, etc.) coming from each business segment (from each product, acceptable) in a management strategy of a management plan model at the top flow can be a base for setting up the above-mentioned various management indicator values (profit, sales volume, direct costs, indirect costs, investment costs (development, equipment), selling costs, head office common expenses, etc.). This serves as a target of a business activity. This serves as a target of a business activity.

From this “annual-plan management”, an order volume (schedule) for each schedule order (including for each customer and each product segment) and a cost (schedule) made by adding a procurement amount (schedule), processing costs (schedule) and various expense (schedule) to the order amount are presented. The difference between them is automatically computed as a profit amount (schedule), and is created as data for <order-receiving-issue model> of every order issue. Further, all the issues corresponding to periods are created as data for “order-receiving-plan management” in the order-received issue list.

In the receiving-order-plan management part 130, as an example of receiving-order plan information from the above “annual-plan management”, the order volume (schedule), the material procurement amount (schedule), the processing costs (schedule) and the various costs (schedule) per schedule order (including, per customer and per product segment) are added to be presented as a cost (schedule). The difference between them is automatically computed as a profit amount (schedule), and is created as data for <order-receiving-issue model> of every order issue. Further, all the issues corresponding to periods are created as data for “order-receiving-plan management” in the order-received issue list.

The schedule order herein includes promising business negotiations, such as an issue whose order-receiving contract has been finished, an issue waiting for an order final decision for the estimation which has been submitted to a customer, an issue whose estimation is to be submitted to a customer in the future, etc., and includes a temporary business negotiation which will set about sales promotion in a market. At the time of formally receiving an order for a schedule issue or a final decision time of a new order business negotiation, the issue is erased or newly registered in the “order-receiving-plan management”. Moreover, based on actual result management data, it is possible in this structure to pursue a deviation between an actual result and a plan in the order-receiving plan.

Detailed explanation of the actual result management data will be stated in the “order-receiving-plan management” below-mentioned.

An actual result transition from the manufacture after receiving an order (an engineering design is included when necessity) to the shipment can be presented through actual result management data of low-ranking “production-plan management”. Concretely, it is possible to present a difference between a planned value and an actual result value at a work progress axis by collecting (automatically, or other) a work man hour at each process and an actual result value against the planned value of a generated cost at each process. Therefore, it is possible to control a deviation adjustment, in feed forward, as an activity after generation at a lower process.

Furthermore, when newly developed article is required at an order-receiving contract time, or when developing a post production is necessary as a business strategy, after recognizing the development by a development investment value evaluation, a planned value of work man hour, cost, etc. per work type (each process of developing a design, procuring a component, manufacturing, and shipment delivery) based on development specifications (a function, a performance, price, etc.) is registered in the “development-plan management” managed by the development-plan management part 180.

Moreover, it is possible to present a difference between a planned value and an actual result value at a work progress axis by collecting (automatically, or other) a work actual result value at each process through “development-plan management.” Therefore, it is possible to control a deviation adjustment, in feed forward, at a lower process as an activity after generation.

In development especially, there are many cases of accompanying an increase of unexpected costs (for example, when a delivery deadline is given a priority, a man day is increased for recovering an actual result delay), depending upon a maturity degree of the plan. Accordingly, when it is expected that a development investment amount exceeds the plan, this exceeding issue can be shown to a business top (there is also a case of a management top) to obtain an judgement at an early stage in order to ask for a suitable strategy and a measure from a management viewpoint (the business strategy itself considering an influence on the management actual condition, and an influence on a future market demand transition) including a course amendment of a future development project.

The “production-plan management” managed by the production-plan management part 140 receives the plan of “order-receiving-plan management” in the same way as the “development-plan management”, sets up a plan of a required working schedule in detail and executes an actual result management.

As an example of production plan information, a design schedule, a manufacture schedule, a procurement schedule, a physical distribution schedule, and a planned schedule of an actual work per order and per product segment are decided. That is, specifying the plan schedule based on a load man hour in the “order-receiving-plan management” is based on an inquiry to the “production-plan management” and a definite reply from the “production-plan management.” The “based on” herein indicates that an order person in charge specifies for enhancing a cash flow or considering a risk (for example, a penalty because of a delivery deadline delay), with paying attention to a customer shipment (indicating a completion of development in the case of development based on a business plan) depending on the reply from the “production-plan management”.

Design schedule in the “production-plan management” managed by the production-plan management part 140 is determined using the standard time if it is the design standard model work which had an actual result in the past. If it is the case of having a similar actual result in the past or the case of being completely new (for example, a development design), a person in charge of production-plan management determines optimally, with giving a top priority to a design risk and taking other working schedules into consideration, based on the reply from a design side.

In the present system, basically a working schedule is automatically decided based on the various databases 81 (it is henceforth described as DB). However, regarding the last decision, a person in charge of production-plan management can determine by manual, with taking actual conditions into consideration. Of course, when the conditions which the person in charge of the production-plan management takes into consideration can be determined logically, it becomes possible for the present system to decide all.

Moreover, as a design obstacle brings about the largest influence on an order execution, quality, costs, and a delivery deadline, the person in charge of the production-plan management gives the top priority to the design risk in order to guide the plan so that the present system can recover such design risk as much as possible in other operations.

In addition, the details of determining method of the working schedule in the “production-plan management” will be mentioned later.

The working schedule adjustment by the “production-plan management” is automatically calculated by a priority processing control based on data of the various kinds DB (indicating order-receiving basic data of a product composition management model <prototype>, procurement basic data, manufacture basic data, and inventory basic data) of the present system, and data (an example of production implementation information) of the “equipment operation-plan management” in the equipment operation-plan management part 150 which manages an actual operation of equipment needed for production.

The equipment operation-plan management part 150 carries out scheduling of starting time and scheduled completing time of an actual operation, using data of an operation load (actual result capacity×time) resource loading and resource leveling at each equipment (process) required for producing prescribed quantity per order and per product segment as an example of production implementation information.

Guessing a direction of an actual operation start time, preparation including an arrangement operation of equipment (machine) required for operation is finished (including the case of arrangement being unnecessary). Then, receiving an injection of a component material (input), an operation start instruction (it is an example of equipment control information) is transmitted to equipment to start an actual operation (operation) in order to execute a required purpose. This is the actual operation control management part 160, and it includes “from an actual machine” which produces a target added value, conventionally being a center of production, in the form of an automation operation, an automatic operation (a man of equipment observation required), and a manual operation (people and machines cooperate).

According to the cooperation integrated system of the above “plan management”, the time axis can be actually operated as follows, as shown in FIG. 32, for instance.

Business strategy (five years, three years (it is an example of the first period)→annual plan management (year, month (it is an example of the second period))→estimation plan management (properly)→order-receiving plan management (year, month, 10 days (it is an example of the third period))→production plan management (year, month, week, day)/development plan management (year, month, week)→procurement plan management (properly)→equipment operation plan management (day, time (it is an example of the fifth period))→actual operation control (minute, second (it is an example of the sixth period)) enables to cooperate and integrate in real time using the time width, to perform a quick adjustment for deviation between an actual result and a plan, and to control risk to be minimum.

Based on the business strategy information in the first period, the annual plan management part 110 generates business year plan information, and manages the business year plan information in the second period within the first period.

Based on the business year plan information managed by the annual-plan management part 110, the receiving-order-plan management part 130 generates receiving-order plan information, and manages the receiving-order plan information in the third period within the second period.

Based on the receiving-order plan information managed by the receiving-order-plan management part 130, the production-plan management part 140 generates production plan information, and manages the production plan information in the fourth period within the third period.

Based on the production plan information managed by the production-plan management part 140, the equipment operation-plan management part 150 generates production implementation information, and manages the production implementation information in the fifth period within the fourth period.

Based on the production implementation information managed by the equipment operation-plan management part 150, the actual operation control management part 160 generates equipment control information which controls production equipment, and manages the equipment control information in the sixth period within the fifth period.

The terminal display part 1 displays at least one of the receiving-order plan information managed by the receiving-order-plan management part 130, the production plan information managed by the production-plan management part 140, the production implementation information managed by the equipment operation-plan management part 150, and the equipment control information managed by the actual operation control management part 160, and prompts a user to perform a product producing business reform.

Moreover, it is one of the features of the present system that it can be dealt with in common whether the business is hardware or software.

“Product composition management model” which can be dealt with in common is introduced as an object of the above mentioned “plan management” of various types.

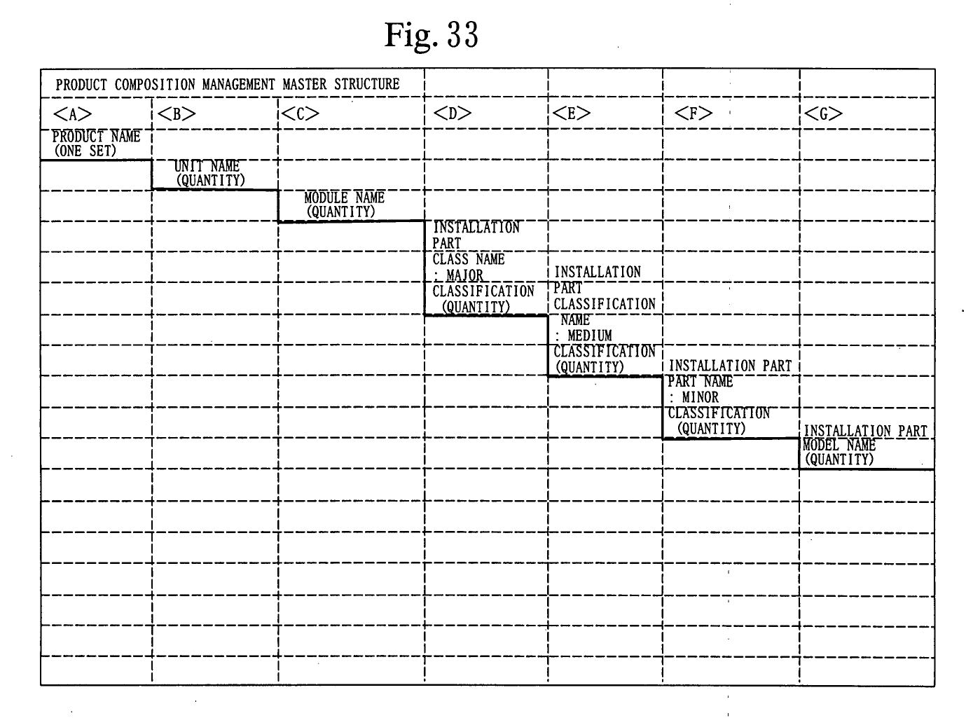

FIG. 33 shows a “product composition management master” which constitutes each of the composition according to Embodiment 6. In FIG. 33, “product composition management model master” which is an example of the product information being a core of the “product composition management model” is shown. The product composition management model is stored in the memory part 4.

The product composition management model has a hierarchical structure which is composed of object names, from the upper rank for example, “product name”→“unit name”→“module name”→“installation part class name (major classification)”→“installation part classification name (medium classification)”→“installation part name (minor classification)”→“installation part model name (last classification)”, and composed of lower rank objects and quantity which are needed for completing the objects of the above names.

The hierarchy can be arbitrarily defined in the present system.

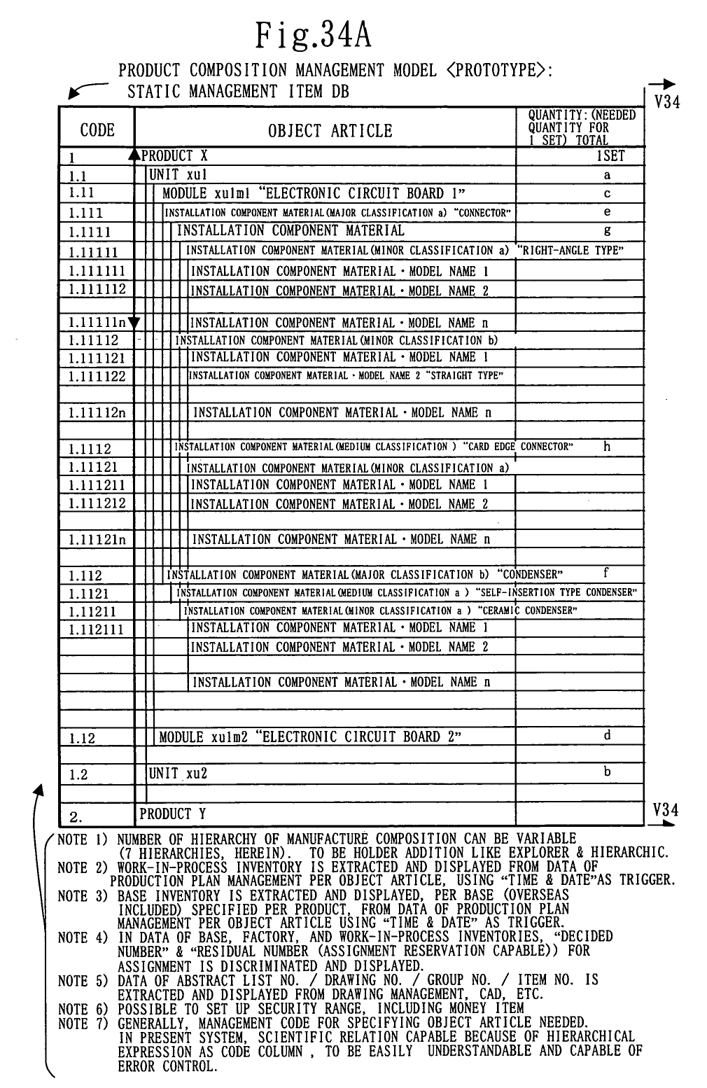

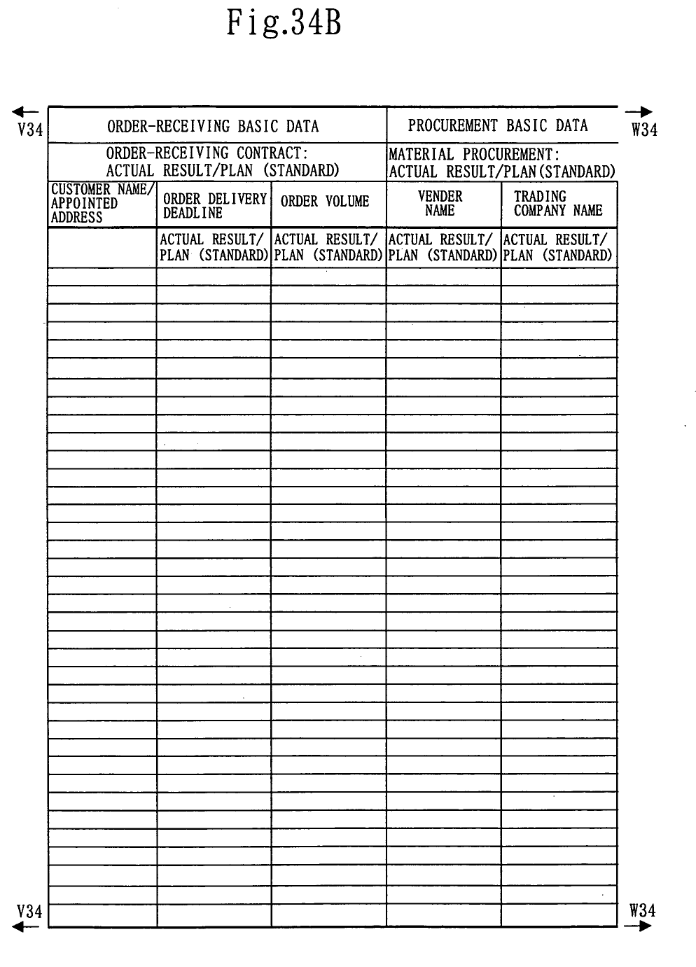

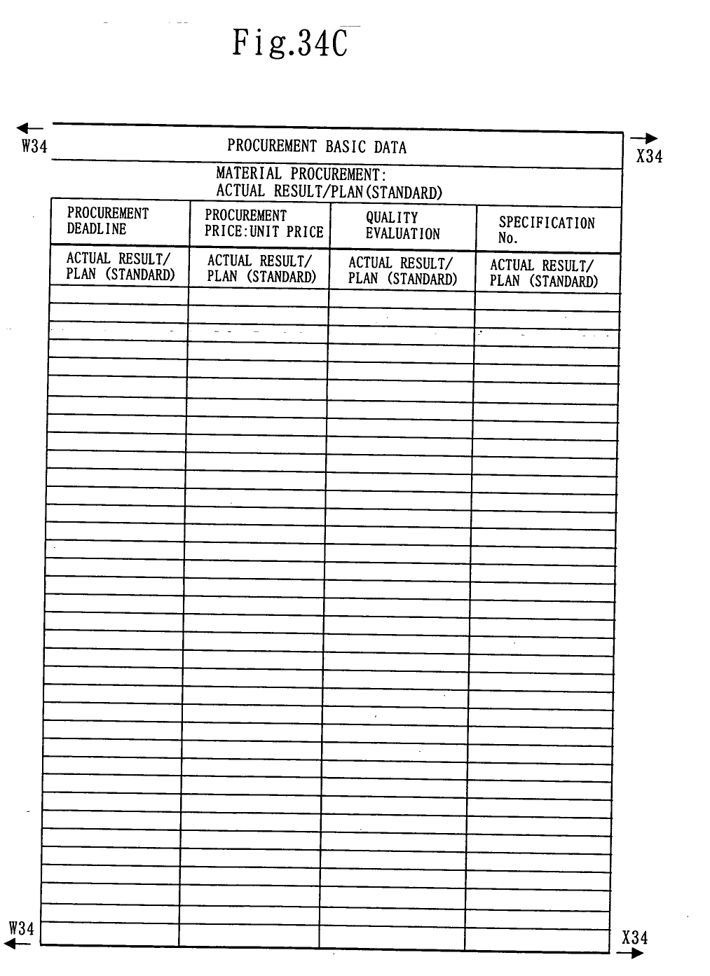

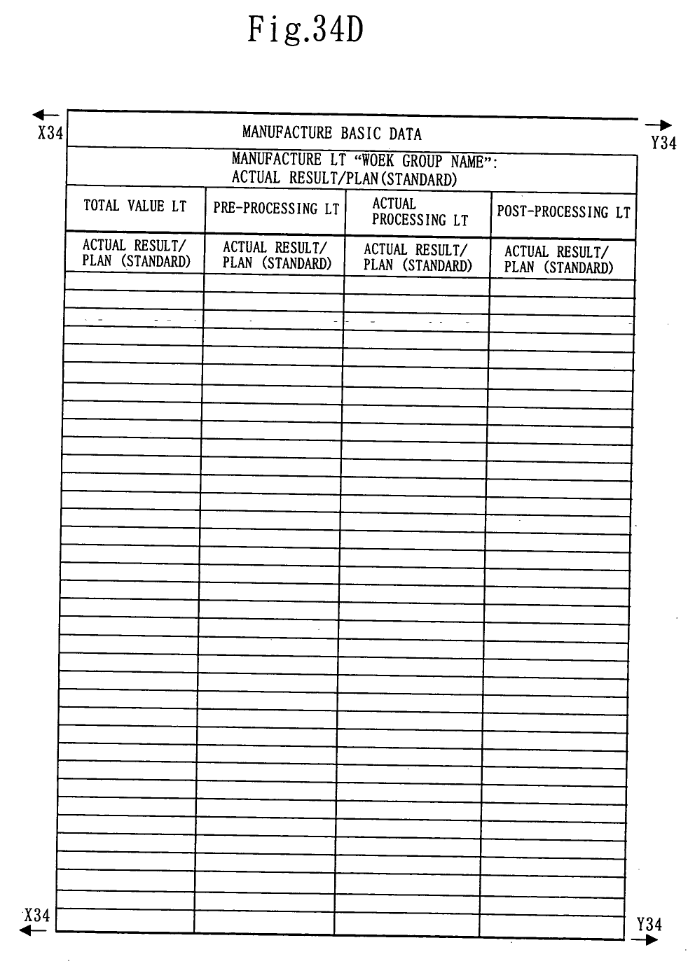

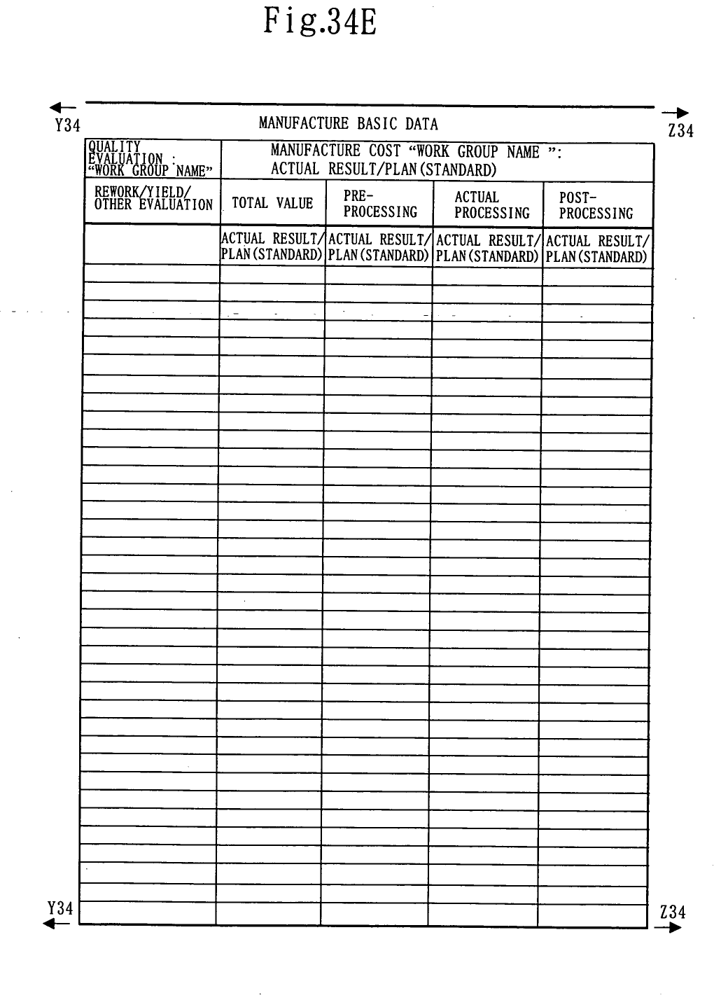

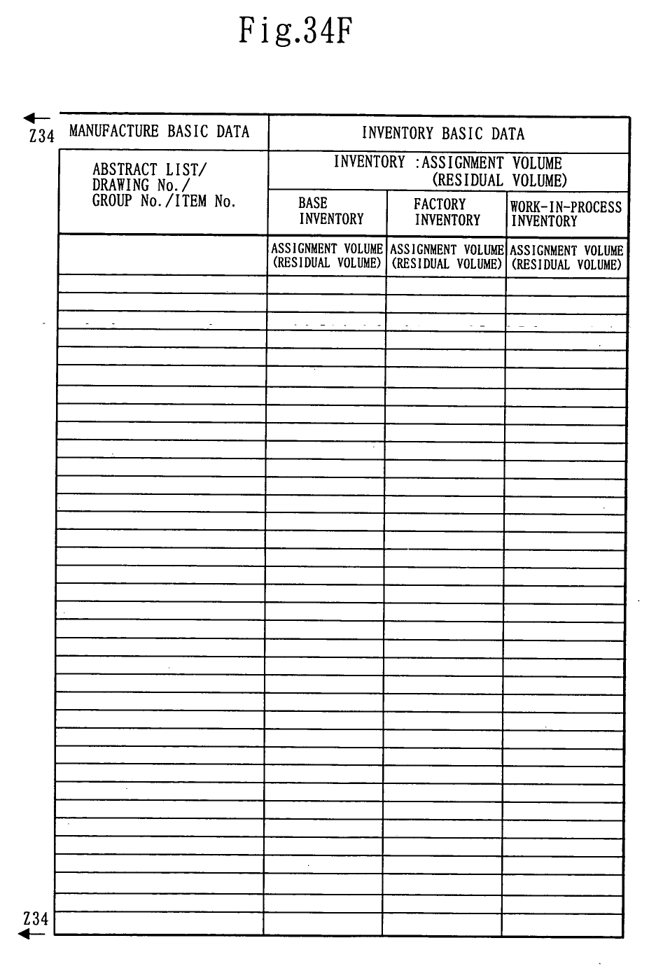

FIG. 34A, FIG. 34B, FIG. 34C, FIG. 34D, FIG. 34E, and FIG. 34F (FIGS. 34A through 34F express one figure) show a product composition management model <prototype> which is common to plan management in Embodiment 6.

A concrete “product composition management model <prototype>” using the “product composition management model master” will now be explained with reference to FIG. 34A, FIG. 34B, FIG. 34C, FIG. 34D, FIG. 34E, and FIG. 34F (FIGS. 34A through 34F express one figure).

As an example of product information, one set of product name “product x” is composed of a lower rank object article, that is unit “xu1” whose quantity is “a” and a lower rank object article, that is unit “xu2” whose quantity is “b.”

One set of unit name “xu1” is composed of a lower rank object article, that is module xu1m1 “electronic circuit board 1” whose quantity is “c” and a lower rank object article, that is module xu1m2 “the electronic circuit board 2” whose quantity is

Similarly, one set of the object article module xu1m1 “electronic circuit board 1” is composed of a lower rank object article, that is installation component material (major classification) “connector” whose quantity is “e” and a lower rank object article, that is installation component material (major classification) “condenser” whose quantity is “f”. Then, one set of the object article installation component material (major classification) “connector” is composed of a lower rank object article, that is installation component material (medium classification) “D-sub connector” whose quantity is “g” and a lower rank object article, that is installation component material (medium classification) “card edge connector” whose quantity is “g.”

Thus, since the composition element of the product “x” is hierarchically classified and registered, it is possible to specify a detailed composition element by a suitable classification name and a model name being the last name. Therefore, it is easily understood by a person other than a registrant.

Generally, the classification name herein is specified in the industry segment of the object article or by the vendor of the object article, and is published as a catalog.

The classification name is gradually integrated and unified in the direction of vender→industry segment (domestic)→industry segment (world). However, even if it is not unified, it is possible to adjust the difference easily by “XML” conversion.

The range of the above-mentioned is the “product composition management model master” part.

The “product composition management model <a prototype>” includes “order-receiving basic data”, “procurement basic data”, “manufacture basic data”, and “inventory basic data” (it is an example of inventory information) as a core of management, in addition to the “product composition management model master” being a core of composition.

The order-receiving basic data includes a customer name and a customer appointed address used as a product (service, software included) delivery place, and an order delivery deadline and an order volume corresponding to an object article.

In accordance with the order-receiving process of time of business negotiation→time of estimation→time of an order-receiving contract, based on specifying object articles covering from a rough object article (ex., two sets of the product x) to details of detailed product composition, it is a fundamental rule to be represented by the product composition management model master. Of course, it is also allowable in the present system to enter only the decided object article, in the order-receiving process (blank column exists).

Procurement basic data includes: a vender name being a supply source, a trading company name being an order party, a procurement deadline being an acquisition period, a price (total price based on a unit price and the number of supplied), an order party assessment evaluation or an official evaluation being a quality evaluation of an article, and a specification number for order. Thus, it is composed of minimum items required for procurement.

Moreover, as the above items, it is possible to set up a standard registration, a planned registration differing from the standard, and an actual result registration. That is, the structure which always can execute an improvement and a reform is prepared in the present system.

Manufacture basic data includes such as: a lead time required for manufacturing, manufacture costs, a quality evaluation in manufacture, a drawing number of a design drawing in which specifications of installation object articles needed for manufacturing and a manufacture method are described, and an abstract list in which various related drawings are summed up.

Lead time and a manufacture cost which is closely united with the lead time include: an actual processing (work for generating a value) being a structure element, pre-processing and post-processing generated along with the actual processing, and a total value of them.

In the case of an equipment machine, these pre-processing and post-processing are generally called arrangements.

Quality evaluation of manufacture includes data and degrees (ratio of an item against the whole amount) of reworking or a yield.

The contents of the drawing includes a group number and an item number for specifying an installation object article.

Moreover, in the present system, so as to guide an operation quality and productivity including outsourcing to be optimum, it is possible to change a section (work group name) of business work. Then, for these items, it is possible to set up a standard registration, a planned registration differing from the standard, and an actual result registration. That is, the structure which always can execute an improvement and a reform is prepared in the present system. In the inventory basic data, an existing volume of inventory for every object article is discriminated by factory inventory/work-in-process inventory/base inventory (outside of a factory), and is presented automatically. The factory inventory and the base inventory (outside of a factory) present a volume of inventory of a specified object article, at the present moment. The work-in-process inventory presents an article which is now being manufactured in the factory as a specific order.

Therefore, it is possible to optimally determine from a viewpoint of a trouble risk reduction for a customer and maximization of CF, at an inventory priority assignment and an urgent reaction assignment.

In these items, it is possible to set up an assignment volume and to present an inventory residual volume. At the time of an assignment, an assignment operation is performed in the “assignment mode” of the present system, under a security management (a regular setting person check, data check, etc.), and regulation data (an assignment order name, an assignment volume, registration time and date, an assignment person name, etc.) is recorded. As the presentation of an inventory residual volume, the latest data from the basic database 81 connected to the present system is automatically presented, and thus, it is impossible to set up.

These procurement basic data, manufacture basic data, and inventory basic data are not only what is minimum and indispensable to an operation management (static management item DB which serves as universal data as long as there is no registration revision) of procurement, manufacture, and inventory check in the present system, but also what gives influence mutually with a duplication relation, being a minimum related indispensable item.

Of course, it is possible to suitably add an item in addition to the related indispensable item, in the present system.

Various plan management composition management models composing the present system using the “product composition management model <a prototype>” will now be concretely explained.

In order to execute the business, the present system is composed of plan management of seven types of “annual-plan management (sale)”, “estimation-plan management (business negotiation)”, “order-receiving-plan management (contract)”, “production-plan management (manufacture)”, “equipment operation-plan management (operation)”, “procurement-plan management (purchase)” and “development-plan management (new product).”

At the time of starting business of each fiscal year, the “annual-plan management (sale)” plans sales: where to (customer), what (object article), how many (quantity), how much (price), and when (term). A framework for business execution is made to be an order-receiving strategy.

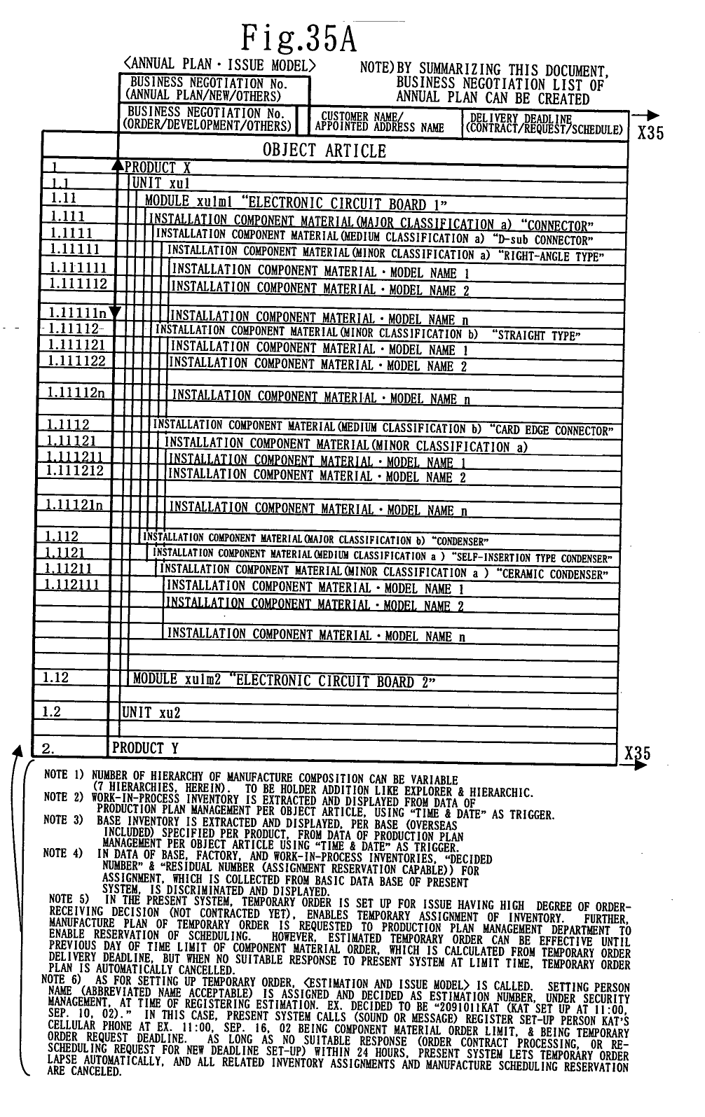

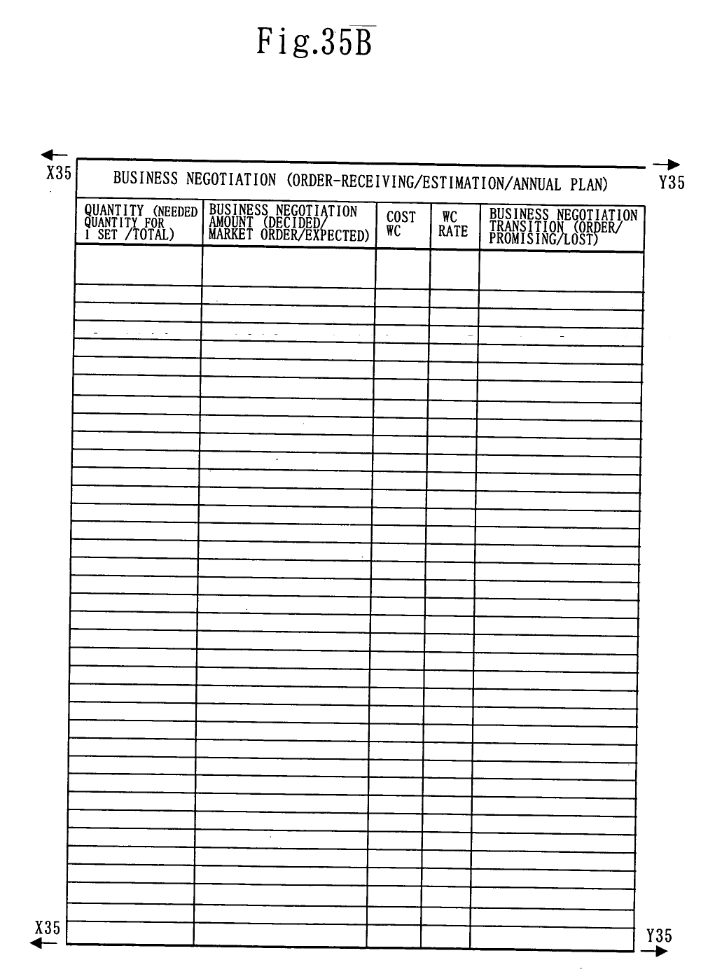

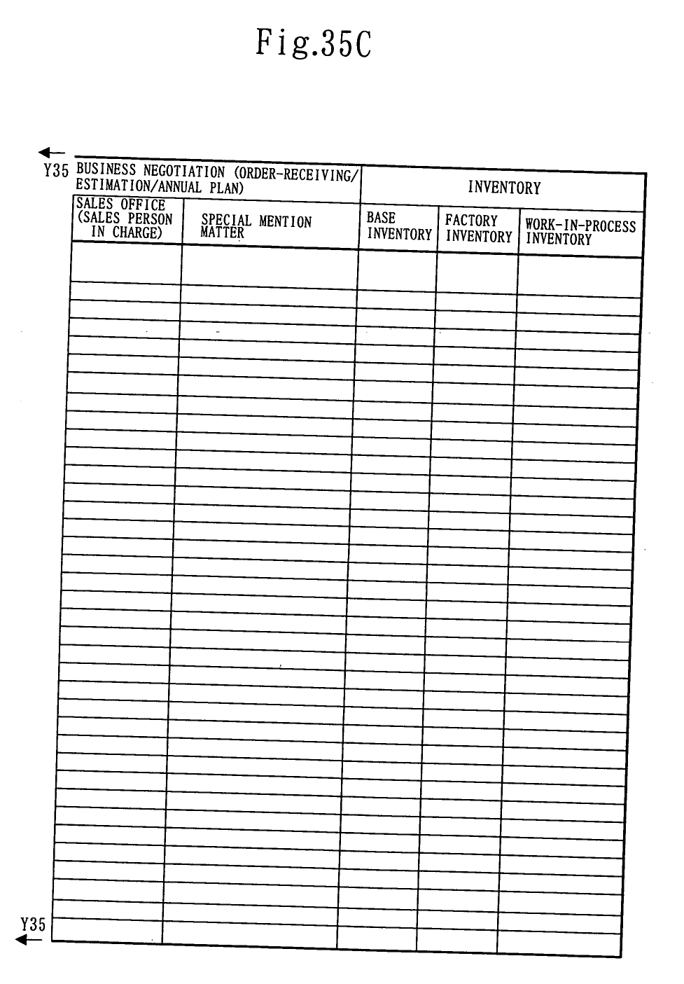

The premise (input) is based on a market and customer demand investigation activities.

<Annual plan-issue model> (it is an example of business year plan information), being the contents of the plan management, will be explained with reference to FIG. 35A, FIG. 35B, and FIG. 35C (FIGS. 35A through 35C express one figure).

FIG. 35A, FIG. 35B, and FIG. 35C (FIGS. 35A through 35C express one figure) shows a business negotiation issue model in the annual-plan management (sale) according to Embodiment 6.

It is basically composed of addition items required for the “product composition management model master” and the “annual-plan management (sale)” of an object article.

As an example of the business year plan information, in order to discriminate an issue per business negotiation, first “business negotiation number”, “customer name” used as a sale party, and “customer appointed address” are clarified. Regarding the “customer appointed address”, it is preferable to add this address for the purpose of discriminating a duplicated order received from the same customer name and aiming at mitigation of an expected risk, by getting to know an application environment. Then, “delivery deadline”, order-received object article×“quantity”, “business negotiation amount” used as an order-receiving schedule amount, and decided order-receiving/promising order-receiving/lost order status of the business negotiation are input as “business negotiation transition”. Moreover, a sales office (sales person in charge) which serves as a contact person in charge of the business negotiation is input, with a communication address of a person in charge (a mailing address, a cellular phone number etc.) as much as possible, for the purpose of confirming the person in charge about real-time information on a business negotiation situation. Further, a change element such as a plan to increase per object article is input as a “special mention matter”.

The present system has a feature that, in order to check the “business negotiation transition” or the “special mention matter”, it is possible to automatically create and transmit an inquiry message to the address of a sales office (sales person in charge) to reflect the reply (answer mail) in real time.

Moreover, the annual plan management part 110 collects and calculates data from the product composition management model master in order to present a cost (WC) of an object article. Dividing the cost (WC) by the inputted business negotiation amount of the object article, the annual plan management part 110 calculates a cost rate to present.

As an addition item, a quantity, an order volume, a cost rate, a business negotiation transition, a sales office (sales person in charge), and a special mention matter of each object article, which are required per order, are combined with the product composition management model master of the object article base.

As to initial values in this model, required quantity of each object article decided by connecting to one set (needed quantity for one set) of the “product X” being the object article is automatically presented as a needed quantity for one set. When a quantity of the object article is specified and registered for each order, a quantity of a lower rank object article connected to the data of the above-mentioned quantity is automatically calculated and presented as a total value. As to a business negotiation transition, the present transition based on the present business negotiation No. (order) of order-receiving/promising/lost order is discriminated and presented. To be an order received or to be a lost order is settled at the time of being registered in the memory part 4 by the annual plan management part 110. Except for this, it is automatically presented as being promising. Since a cause of a lost order is shown in the special mention matter at the time of the lost order becoming definite, it becomes effective as a suggestion to a future activity.

When an order-receiving contract has been executed, it is registered as a received order in the business negotiation transition column, and when its order volume is registered in the product x line of the “business negotiation box” of the present system, it is possible to perform an input registration by automatically-or by manual.

There are three types of status: in addition to the “order-receiving”, there are “lost order” and “promising” which is neither order-receiving nor lost order. By setting up a degree of prediction of whether the “promising” goes to “order-receiving” or goes to “lost order” in the special mention matter, a real-time transition can be checked.

For instance, the prediction degrees are defined as follows:

Prediction value 5: settled (waiting for a contract direction)

Prediction value 4: almost settled, a preparation stage before settling

Prediction value 3: a final stage towards settling, still there being possibility of risk of lost order

(risk conquest activity required)

Prediction value 2: there being almost no possibility of order, or a stage of much possibility of cancel of business negotiation by the customer side's convenience

(lead activity towards next business negotiation with customer)

Prediction value 1: much possibility of other company receiving the order, only tactical conclusion being effective to reverse the possibility, or a stage of probably cancelling the business negotiation

Prediction value 0: decided to be lost order or to cancel the business negotiation

As mentioned above, in the present system, the special mention matter column can be utilized as a membership function term of the degree of order-receiving expectation. Therefore, the course of business negotiation efforts before an order-receiving can be known. Accordingly, it can be utilized for a future effective activity.

Regarding the delivery deadline of the <annual plan-issue model>, in the case of an order-receiving having been decided, “contract” is automatically shown as an initial value, in the present system. In the case of the delivery deadline still being fluid, “request” reflecting customer's will is input. In the case of an accepted delivery deadline of the order receiving side being allowable, “expectation” is input.

When the degree of order-receiving decision in the above-mentioned business negotiation transition column is high, a temporary order is set up in the form of an estimated issue (not contracted yet) to enable a temporary assignment of the inventory. Further, a manufacture plan of the temporary order is requested to the production plan management department to enable a reservation of scheduling. However, the estimated temporary order can be effective until the time limit of component material order, which is calculated from the temporary order delivery deadline, but if there is no suitable response to the present system at the limit time, the plan of the temporary order is automatically cancelled. As to setting up the temporary order, <estimation-issue model> is called, and a setting person name (an abbreviated name is also acceptable) is assigned and decided as an estimation number, under the security management, at the time of registering the estimation. For example, it is decided to be “2091011KAT (KAT set up at 11:00 on September 10^{th} in 2002).” As long as there is no demand of re-scheduling, the present system lets this temporary order lapse automatically, and all of the related inventory assignments and manufacture scheduling reservation are canceled. Thus, the present system realizes an advanced intellectual support. Details will be explained in <estimation-issue model> below stated.

Regarding a cost column, data is automatically collected from the cost breakdown of the product x in the present system in advance, and automatically presented. Therefore, deviation between the business negotiation amount and the cost of the product x can be known here, and it can be judged in real time whether cost reduction activity is required or not.

A cost rate is automatically calculated by dividing the cost by the business negotiation amount (order volume) to be presented. Then, the deviation rate is decided. Based on this value, it is possible to guide the indicator in real time to find which structure factor of the product cost can be effective for performing a cost reduction concentration, such as a purchase cost reduction of component material procurement or a cost reduction at manufacturing, processing and assembling. This is a feature of the present system.

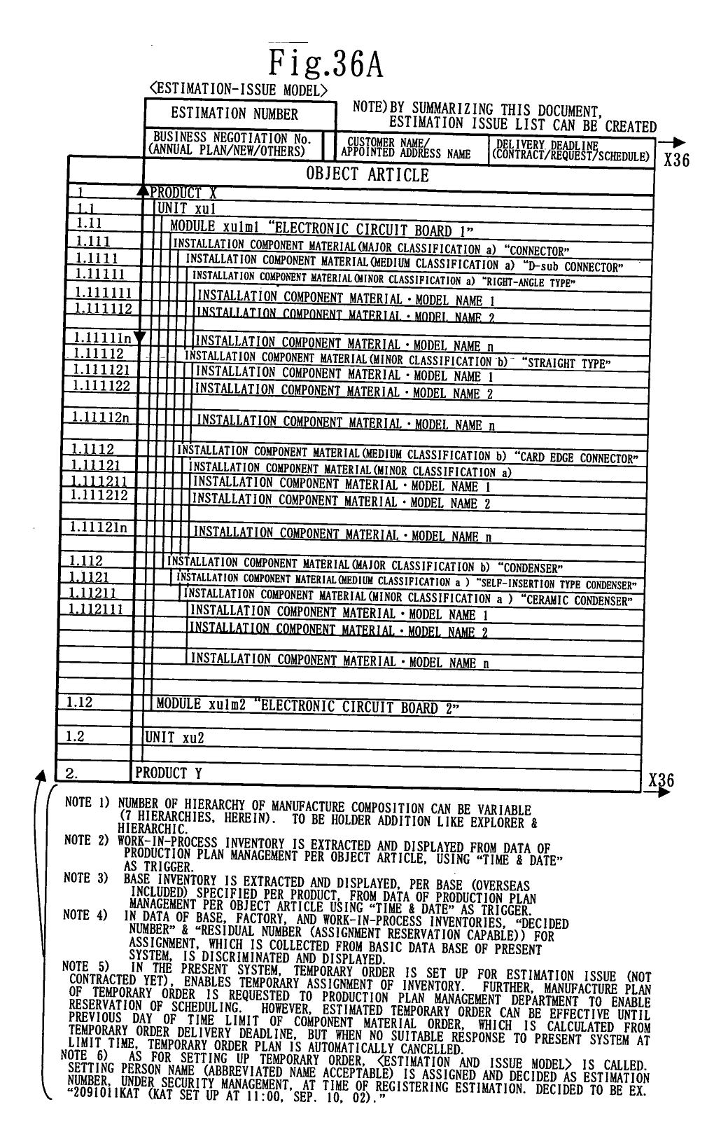

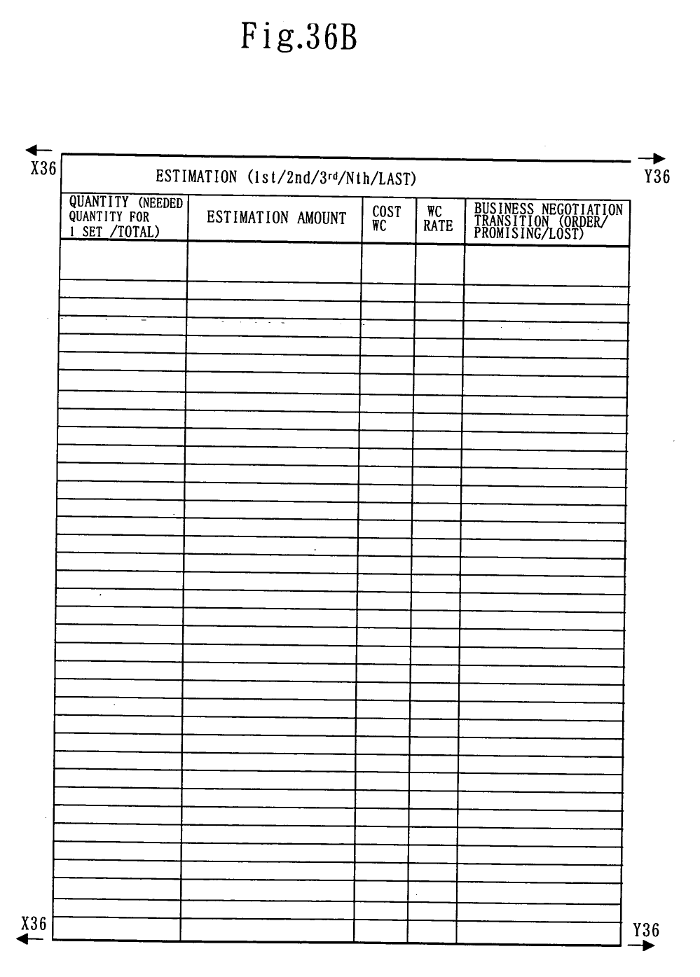

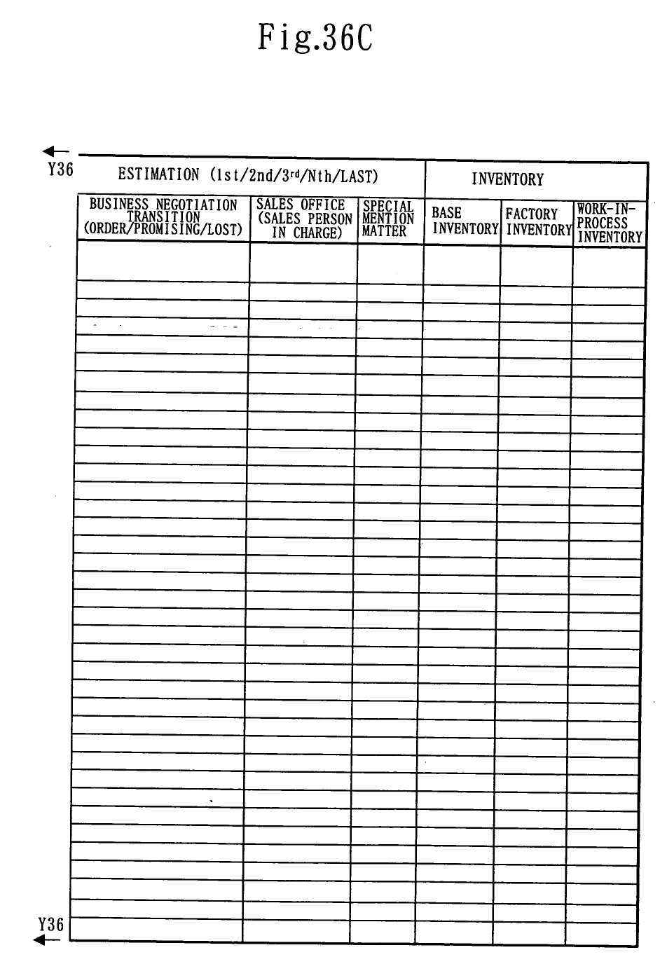

Next, “estimation-plan management (business negotiation)” performed by the estimation-plan management part 120 will be explained. This indicates to submit development costs including whether to develop or not, a price of a product object article, and an accepted delivery deadline, as estimated responses, to a customer based on the estimated specification (name of an object article for product, quantity, delivery deadline) from the customer. The <estimation-issue model> (it is an example of estimation plan information) will be explained with reference to FIG. 36A, FIG. 36B, and FIG. 36C (FIG. 36A through FIG. 36C express one figure).

FIG. 36A, FIG. 36B, and FIG. 36C (FIG. 36A through FIG. 36C express one figure) show an information model of an estimation issue of estimation-plan management according to Embodiment 6.

Generally, estimation is generated by a case of a business negotiation of the <annual plan-issue model> of the “annual-plan management”, or by a case of a new business negotiation which has not been registered in the <annual plan-issue model>. First, “estimation number” for discriminating an issue per estimation is input. Then, a business negotiation number (annual plan) is input in the case of the business negotiation of the <annual plan-issue model>. A business negotiation number (new) is input in the case of the new business negotiation which has not been registered in the <annual plan-issue model>. Further, in other case, a business negotiation number (others) is discriminated and input.

Then, “customer name” used as a sale party, and “customer appointed address” are clarified. Regarding the “customer appointed address”, it is preferable to add this address for the purpose of discriminating a duplicated order received from the same customer name and aiming at mitigation of an expected risk, by getting to know an application environment. Then, “delivery deadline”, order-received object article×“quantity”, “estimation amount” used as an order-receiving schedule amount, and order-receiving/promising/lost order status of the business negotiation are input as “business negotiation transition”. Moreover, a sales office (sales person in charge) which serves as a contact person in charge of the business negotiation is input, with a mailing address of a person in charge as much as possible, for the purpose of confirming the person in charge about real-time information on a business negotiation situation. Further, a change element such as a plan to increase per object article is input as a “special mention matter”.

Regarding estimation, generally, it is not limited to performing an estimation once. There is a case of performing an estimation several times because of specifications (including conditions) being changed. In order to read history transitions of the change, the estimation-plan management part 120 defines an estimation (first), an estimation (second), an estimation (third) and an estimation (Nth) which is a continuing case. Based on the changing status, it is structured to propose a customer side a measure for settling the change, to contribute to the service improvement in estimation, and to advantageously guide the order-receiving.

Moreover, the present system collects, calculates and presents a cost (WC) of an object article by collecting data from the product composition management model master, and a cost rate by dividing the cost (WC) by the inputted business negotiation amount of the object article.

As an addition item, a quantity, an order volume, a cost rate, a business negotiation transition, a sales office (sales person in charge), and a special mention matter of each object article, which are required per order, are combined with the product composition management model master of the object article base.

As to initial values in this model, required quantity of each object article decided by connecting to one set (needed quantity for one set) of the “product X” being the object article is automatically presented as a needed quantity for one set. When a quantity of the object article is specified and registered for each order, a quantity of a lower rank object article connected to the data of the above-mentioned quantity is automatically calculated as a total value. As to a business negotiation transition, the present transition based on the present estimation No. (order) of order-receiving/promising/lost order is discriminated and presented. To be an order received or to be a lost order is settled at the time of being registered in the memory part 4 by the estimation-plan management part 120. Except for this, it is automatically presented as being promising. Since a cause of a lost order is shown in the special mention matter at the time of the lost order becoming definite, it becomes effective as a suggestion to a future activity.

When an order-receiving contract has been executed, it is registered as a received order in the business negotiation transition column, and when its order volume is registered in the product x line of the “business negotiation box” of the present system, it is possible to perform an input registration by automatically or by manual.

There are three types of status: in addition to “order-receiving”, there are “lost order” and “promising” which is neither order-receiving nor lost order. By setting up a degree of prediction of whether the “promising” goes to “order-receiving” or goes to “lost order” in the special mention matter, a real-time transition can be checked.

For instance, the prediction degrees are defined as follows:

Prediction value 5: settled (waiting for a contract direction)

Prediction value 4: almost settled, a preparation stage before settling

Prediction value 3: a final stage towards settling, still there being possibility of risk of lost order

(risk conquest activity required)

Prediction value 2: there being almost no possibility of order, or a stage of much possibility of cancel of business negotiation by the customer side convenience

(lead activity towards next business negotiation with customer)

Prediction value 1: much possibility of other company receiving the order, only tactical conclusion being effective to reverse the possibility, or a stage of probably cancelling the business negotiation

Prediction value 0: decided to be lost order or to cancel the business negotiation

As mentioned above, in the present system, the special mention matter column can be utilized as a membership function term of the degree of order-receiving expectation. Therefore, the course of business negotiation efforts before an order-receiving can be known. Accordingly, it can be utilized for a future effective activity.

Regarding the delivery deadline of the <estimation-issue model>, in the case of an order-receiving having been decided, “contract” is automatically shown as an initial value, in the present system. In the case of the delivery deadline still being fluid, “request” reflecting customer's will is input. In the case of an accepted delivery deadline of the order receiving side being allowable, “expectation” is input. When the degree of order-receiving decision in the above-mentioned business negotiation transition column is high, a temporary order is set up in the form of an estimated issue (not contracted yet) to enable a temporary assignment of the inventory. Further, a manufacture plan of the temporary order is requested to the production plan management department to enable a reservation of scheduling. However, the estimated temporary order can be effective until the previous day of the time limit of component material order, which is calculated from the temporary order delivery deadline, but if there is no suitable response to the present system at the limit time, the plan of the temporary order is automatically cancelled. As to setting up the temporary order, <estimation-issue model> is called, and a setting person name (an abbreviated name is also acceptable) is assigned and decided as an estimation number, under the security management, at the time of registering the estimation. For example, it is decided to be “2091011KAT (KAT set up at 11:00 on September 10^{th} in 2002).” As long as there is no demand of re-scheduling, the present system lets this temporary order lapse automatically, and all of the related inventory assignments and manufacture scheduling reservation are canceled.

The present system has a feature that, in order to check the “business negotiation transition” or the “special mention matter”, it is possible to automatically create and transmit an inquiry message to the communication address (a mailing address, a cellular phone number etc.) of a sales office (sales person in charge) to reflect the reply (answer mail) in real time. Thus, an intellectual support of high level can be realized in the present system.

Regarding a cost column, data is automatically collected from the cost breakdown of the product x in the present system in advance, and automatically presented. Therefore, deviation between the business negotiation amount and the cost of the product x can be known here, and it can be judged in real time whether cost reduction activity is required or not.

A cost rate is automatically calculated by dividing the cost by the business negotiation amount (order volume) to be presented. Then, the deviation rate is decided. Based on this value, it is possible to guide the indicator in real time to find which structure factor of the product cost can be effective for performing a cost reduction concentration, such as a purchase cost reduction of component material procurement or a cost reduction at manufacture, processing and assembling. This is a feature of the present system.

Next, “order-receiving-plan management (contract)” performed by the receiving-order-plan management part 130 will be explained. According to this, the present system presents a situation of an actual result against the order-receiving plan in the “annual plan management (sale)” first, and then a change of sales promotion activities from now on is requested in feed forward.

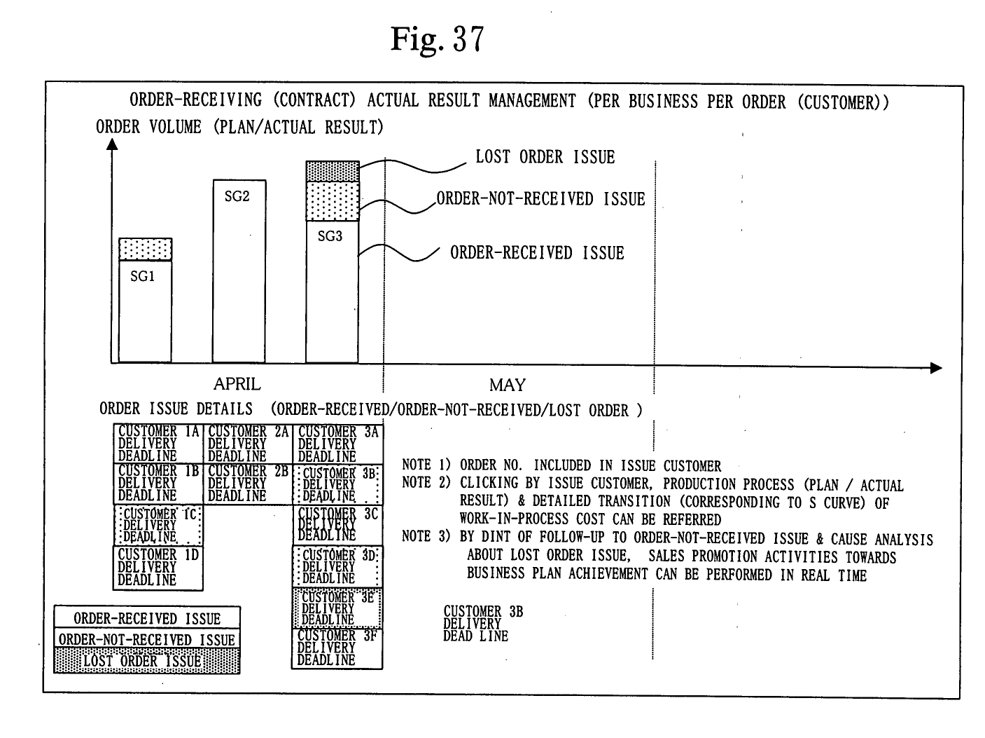

FIG. 37 shows an example of order-receiving actual result management of the order-receiving-plan management of Embodiment 6. The graph of FIG. 37 is monthly data (an example of expected order plan information) per business segment (per product, included).

In FIG. 37, the actual result of order volume in April at each of segments SG1, SG2, and SG3 is shown in graph as an example, and an order-received issue, an order-not-received issue, and a lost order issue are classified by color and shown. Customers are shown to be corresponding to each business segment. In SG1, a customer 1A, a customer 1B, a customer 1C, and a customer 1D are planned. It is shown that the customer 1C is in order-not-received status and that the issue follow activity is required. In SG2, a customer 2A and a customer 2B are both order-received on schedule. In SG3, from a customer 3A to a customer 3F are planned. The customers 3A, 3C and 3F are definitely order-received, the customers 3B, and 3D are order-not-received, and the customer 3E is definitely lost order. Then, it is noticed if a new order-receiving issue, instead of the lost order issue, is not required, it is impossible to achieve the annual plan. By seeing this graph, the amount of sufficiency of the annual plan for every business segment is quite obvious. This data is reflected and presented in the actual result of the <annual plan-issue model>, and at the time of lost order becoming definite, it is automatically deleted from the load of the plan which will be produced soon, in the “production-plan management (manufacture).”

The order-receiving plan information includes expected order plan information which expects an order amount based on business year plan,

the order-receiving-plan management part 130 stores an order amount, an order-not-decided amount, and a lost order amount corresponding to the expected order plan information, per prescribed unit, and

the terminal display part 1 displays the order amount, the order-not-decided amount, and the lost order amount stored by the order-receiving-plan management part 130, in a graph per prescribed period, and prompts a user to perform sales reinforcement.

In the present system, a follow-up to an order-not-received issue and a cause analysis about a lost order issue are prompted. Therefore, sales promotion activities towards a business plan achievement can be performed in real time.

Secondly, FIG. 37 is for producing a product based on a contract specification at the time of an order-receiving contract, planning a production process in order to be in time for a delivery deadline of a received order, and performing a progress actual result management (work progress and costs).

In the present system, an optimal production program decision (a top priority is given to a customer delivery deadline and a maximization of CF cash flow is demanded) in a production process is realized based on a contract specification (object article name, quantity, delivery deadline, price).

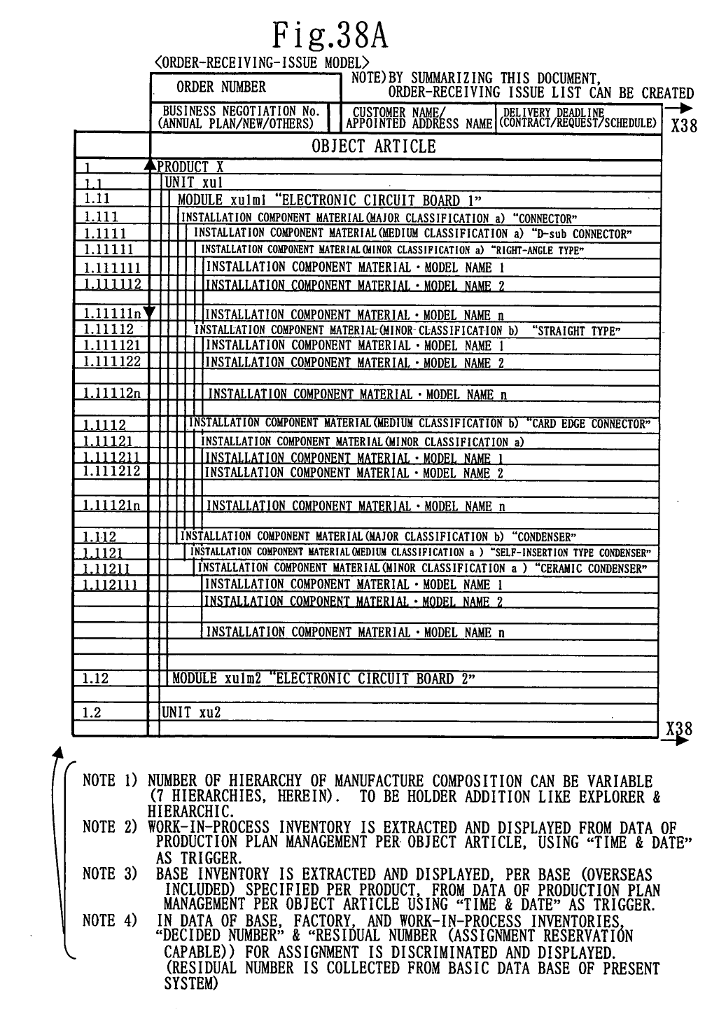

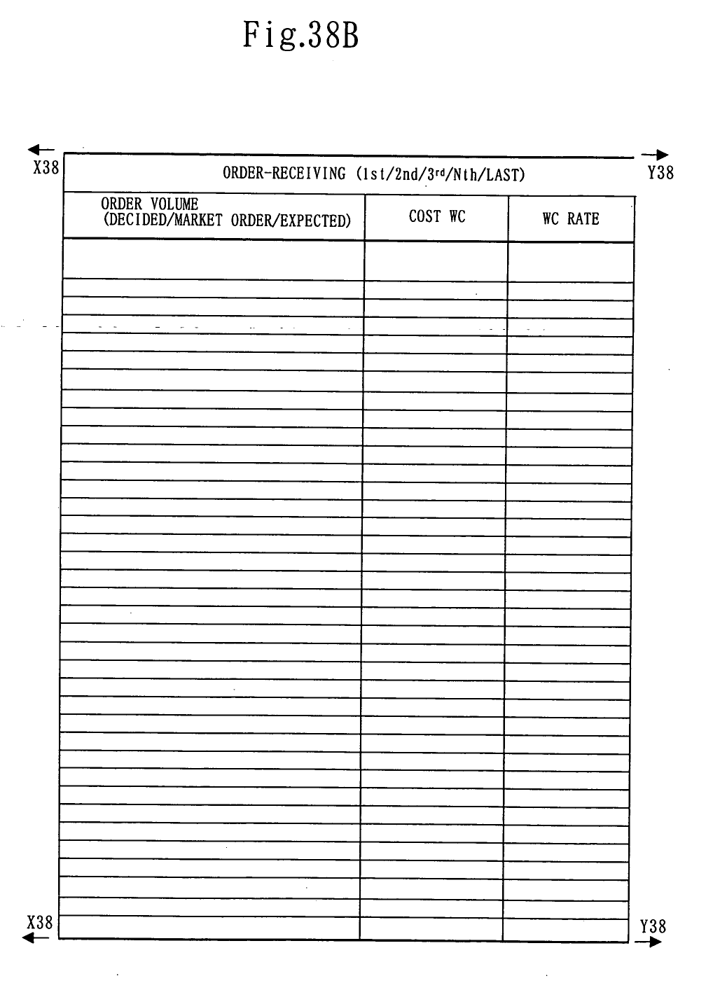

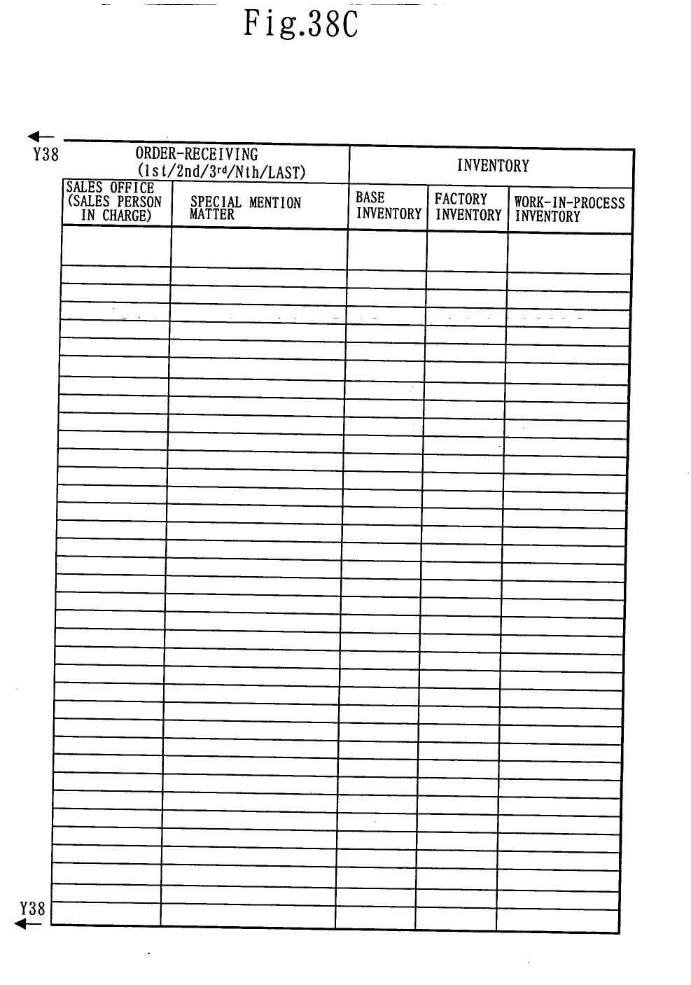

FIG. 38A, FIG. 38B, and FIG. 38C (FIG. 38A through FIG. 38C express one figure) show an information model of an order-received issue of the order-receiving-plan management according to Embodiment 6.

The <order-receiving-issue model> will now be explained with reference to FIG. 38A, FIG. 38B, and FIG. 38C (FIG. 38A through FIG. 38C express one figure).

Generation of order-receiving is based on a business negotiation of <estimation-issue model> of the “estimation-plan management” as a premise.

In the order-receiving issue model, first an “order number” for discriminating an issue per order received and an estimation number (annual plan/new/others) from the business negotiation of the <estimation-issue model> are input.

After clarifying a “customer name” used as a sale party and a “customer appointed address” (it is preferable to add the customer appointed address for the purpose of discriminating a duplicated order received from the same customer name and aiming at mitigation of an expected risk, by getting to know an application environment), a “delivery deadline”, order-received object article×“quantity”, and an “order volume” used as an order-receiving contract amount are input.

Regarding the order volume, it needs to assume a case of not becoming definite. In the present system, so as to be applied and discriminated in the case of a market order or in the case of a prediction by a sales office (sales person in charge), it is possible to input by selecting one of three cases: a decided order volume (it is an example of decided order plan information), an order volume of market order stage (it is an example of market order plan information), and an order volume of expectation stage (it is an example of expected order plan information) as shown in FIG. 38A, FIG. 38B, and FIG. 38C (FIG. 38A through FIG. 38C express one figure). Therefore, various measures dealings can be executed. Moreover, similar to the estimation, considering a change of the investment measure by the customer side in accordance with change of the market, history transition can be read in the present system, such as an order received (1st), an order received (2nd), an order received (3rd), and an order received (Nth). Based on the changing status, it is possible to propose a customer side a suitable measure for settling the change, to contribute to the service improvement in customer support, and to guide the contract specification at an early stage.

Moreover, a sales office (sales person in charge) which serves as a contact person in charge of the business negotiation is input, with a communication address of a person in charge (a mailing address, a cellular phone number etc.) as much as possible, for the purpose of confirming the person in charge about real-time information on a business negotiation situation. Further, a change element such as a plan to increase per object article is input as a “special mention matter”. The present system has a feature that, in order to check the “business negotiation transition” or the “special mention matter”, it is possible to automatically create and transmit an inquiry message to the address of a sales office (sales person in charge) to reflect the reply (answer mail) in real time. Moreover, the present system collects and calculates data from the product composition management model master in order to present a cost (WC) (it is an example of cost information) of an object article. The present system automatically calculates a cost rate (it is an example of cost information) to present, by dividing the cost (WC) by the inputted business negotiation amount of the object article. As an addition item, a quantity, an order volume, a cost rate, a sales office (sales person in charge), and a special mention matter of each object article, which are required per order, are combined with the product composition management model master of the object article base.

As to initial values in this model, required quantity of each object article decided by connecting to one set (needed quantity for one set) of the “product X” being the object article is automatically presented as a needed quantity for one set. When a quantity of the object article is specified and registered for each order, a quantity of a lower rank object article connected to the data of the above-mentioned quantity is automatically calculated and presented as a total value.

Regarding the delivery deadline of the <order-receiving-issue model>, considering the case of a contract decision and convenience of a customer and a sales office (sales person in charge), it is possible in the present system to select a contract, a request, and a schedule. In the case of an order-receiving having been decided, “contract” is automatically presented as an initial value, in the present system. In the case of the delivery deadline still being fluid, “request” reflecting customer's will is input. In the case of an accepted delivery deadline of the order receiving side being allowable, “expectation” is input. It enables a temporary assignment of the inventory which is input in the inventory information of FIG. 38A, FIG. 38B and FIG. 38C (FIG. 38A through FIG. 38C express one figure), and a manufacture plan of the order is requested to the production plan management department in order to reserve scheduling. When its order volume is registered in the product x line of the “business negotiation box” of the present system, it is possible to perform an input registration by automatically or by manual.

As stated above, the order-receiving plan information includes expected order plan information which expects an order amount based on business year plan, market order plan information in which an order amount is undecided, and decided order plan information in which an order amount is decided, the expected order plan information changes to the market order plan information, and the market order plan information changes to the decided order plan information,

the order-receiving-plan management part 130 manages product information, cost information and inventory information corresponding to managed order-receiving plan information, and dynamically changes the product information, the cost information, and the inventory information corresponding to the order-receiving plan information, based on a change of the order-receiving plan information, in a case of the order-receiving plan information being the expected order plan information, in a case of the order-receiving plan being the market order plan information, and in a case of the order-receiving plan being the decided order plan information.

As the third function of the “order-receiving-plan management (contract)”, it is possible to grasp a profit-and-loss actual result of a transferred order for the production completion and shipment. This data can be collected as actual result management data (sales volume against actual result costs) through a lower rank “production-plan management (manufacture)” (It will be mentioned in detail later).

The “production-plan management (manufacture)” performed by the production-plan management part 140 will now be explained. This indicates to set up a production plan which will be produced soon to be close to the delivery deadline of the order, in order to create an optimal production program of the “order-receiving-plan management (contract)” of a higher rank, in the present system. A load control of each production process (here, it is called a “process”) is decided by automatically receiving a simulation result at the dynamic production plan adjustment control part 5 which is a feature of the present system, and, in properly, by making some complements and corrections to data of the automatic simulation in consideration of a realistic risk.

Of course, it is possible to properly set up the data of the simulation. The present system has a feature of supplementing more realistic conditions to the data.

The “production-plan management (manufacture)” of the present system has a function of grasping an actual result (work progress degree, and generated costs) based on the decided plan. The result is presented to the “order-receiving-plan management” of a higher rank, and the real-time situation in the order can be accurately supervised.

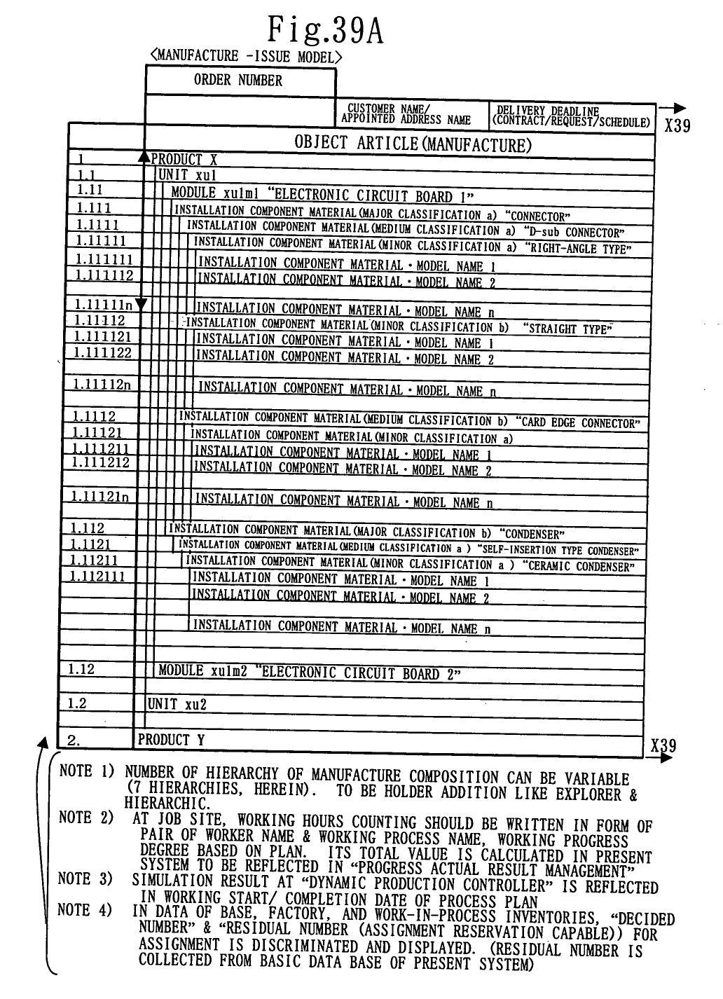

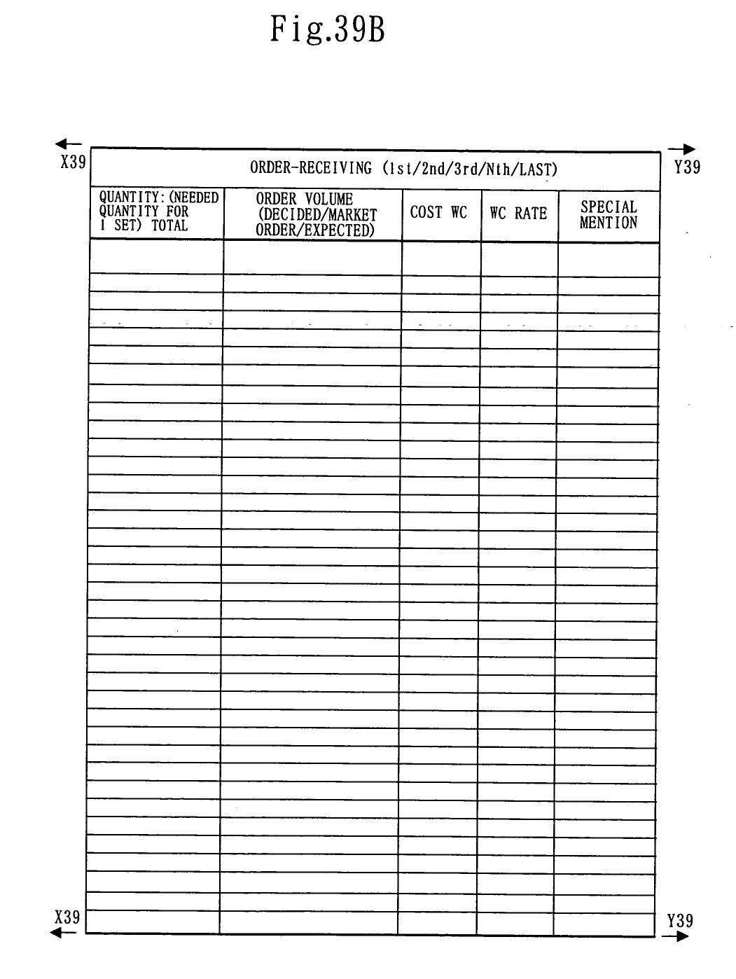

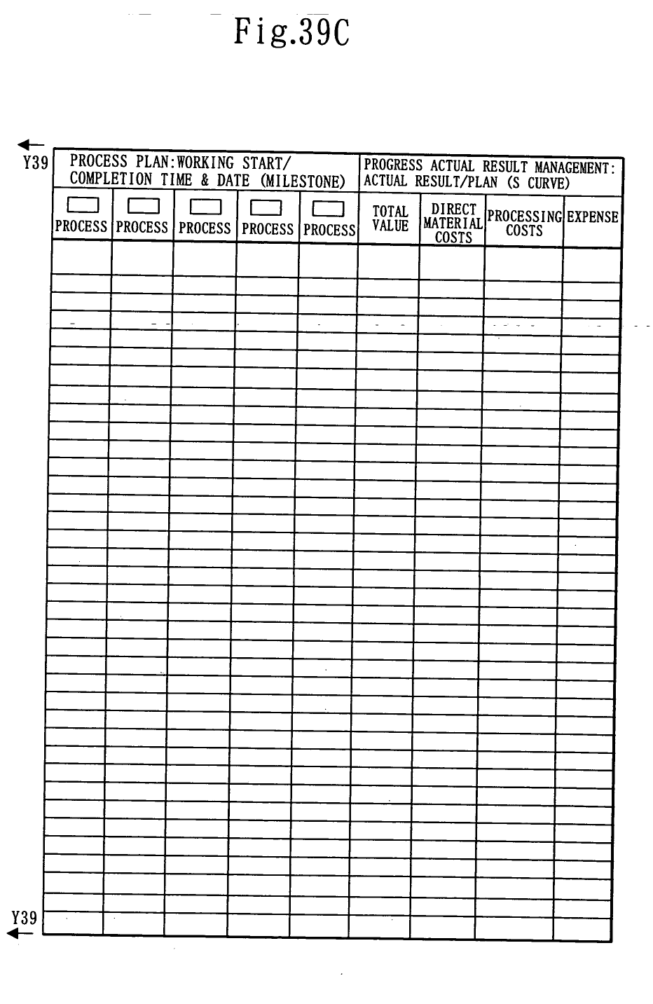

Therefore, based on the real-time situation, it is possible in the present system to guide the indicator towards a business profit growth & a CF cash flow growth in feed forward, for a future activity.

<Manufacture-issue model> (it is an example of production plan information) will be explained with reference to FIG. 39A, FIG. 39B, and FIG. 39C (FIG. 39A through FIG. 39C express one figure).

FIG. 39A, FIG. 39B, and FIG. 39C (FIG. 39A through FIG. 39C express one figure) show an information model of a manufacture issue of the production-plan management according to Embodiment 6.

After clarifying an “order number” per order, a “customer name” used as a sale party and a “customer appointed address” (it is preferable to add the customer appointed address for the purpose of discriminating a duplicated order received from the same customer name and aiming at mitigation of an expected risk, by getting to know an application environment), a “delivery deadline”, order-received object article×“quantity”, and an “order volume” used as an order-receiving contract amount are input. Regarding the order volume, it needs to assume a case of not becoming definite. In the present system, so as to be applied and discriminated in the case of a market order or in the case of a prediction by a sales office (sales person in charge), it is possible to input by selecting one of three cases like the order-receiving plan information: an order volume of expectation stage (it is an example of expected production plan information), an order volume of market order stage (it is an example of market-order production plan information), and a decided order volume (it is an example of decided production plan information). Therefore, various measures dealings can be executed. Moreover, similar to the estimation, considering a change of the investment measure by the customer side in accordance with change of the market, history transition can be read in the present system, such as an order received (1st), an order received (2nd), an order received (3rd), and an order received (Nth). Based on the changing status, it is possible to propose a customer side a suitable measure for settling the change, to contribute to the service improvement in customer support, and to guide the contract specification at an early stage.

Further, a change element such as a plan to increase per object article is input as a “special mention matter”.

Moreover, the present system collects and calculates data from the product composition management model master in order to present a cost (WC) (it is an example of cost information) of an object article. The present system automatically calculates a cost rate (WC rate) (it is an example of cost information) to present, by dividing the cost (WC) by the order volume of the object article.

As an addition item, a quantity, an order volume, a cost rate, and a special mention matter of each object article, which are required per order, are combined with the product composition management model master of the object article base.

As to initial values in this model, required quantity of each object article decided by connecting to one set (needed quantity for one set) of the “product X” being the object article is automatically presented as a needed quantity for one set. When a quantity of the object article is specified and registered for each order, a quantity of a lower rank object article connected to the data of the above-mentioned quantity is automatically calculated and presented as a total value.

As to the delivery deadline, the status of the delivery deadline in the <order-receiving-issue model> is presented as it is. As to the order volume, the numerical value of the order volume in the <order-receiving-issue model> is presented as it is.

As to the costs of the progress actual result management column (it is an example of cost information), a value which the plan value collected from the “product composition management model <prototype>” is first presented. Thus, in the present system, cost in each production process corresponding to an object article is presented by discriminating to be direct material costs, processing costs (including manpower accounting which needs to be injected to equipment operation costs) and other expenses (including design costs and indirect management expenses). Therefore, observation of becoming over a plan value etc. can be identified in what process becoming over the plan value occurs and to what cost the plan value becoming over is related. Accordingly, various traceability functions can be demonstrated.

These data is reflected in real time in the “production-plan management (manufacture)” per order, and further in the actual result management (profit-and-loss situation) per business.

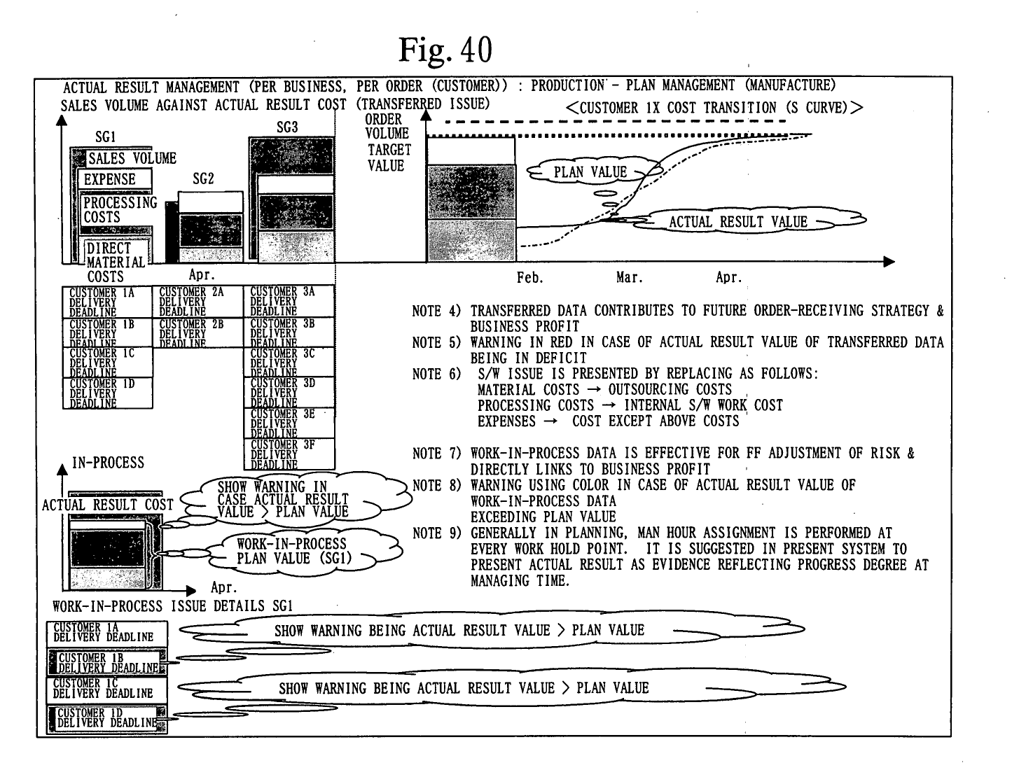

An example of an actual result management (profit-and-loss situation) grasping in the present system is shown in FIG. 40. FIG. 40 shows an example of actual result costs management. The graph at the upper part of FIG. 40 shows sales volume against actual result cost (it is an example of cost information) regarding an order-received issue. This data serves as a result report to sales volume in an issue having produced. Based on this data, it is possible to grasp being in surplus or in deficit (profit or loss) in the transferred issue to be monthly correspondence (it is an example of a prescribed period).

“Transfer” indicates that it has reached a phase of production processing and shipment required for delivery to a customer having finished and of being able to swiftly receive an order-receiving amount of money from the customer. It is important for CF cash flow to shorten the period from “transferring”→payment receiving period from the customer.

In FIG. 40, at the business segment SG1 of the issue having finished transferring in April, results in Customers 1A, 1B, 1C, and 1D are presented by showing costs in the sales volume to be discriminated into direct material costs, processing costs, and expenses. In SG2, the costs which has exceeded the sales volume is presented to display a warning of being in deficit. In SG3, the actual result having a large surplus rate can be grasped.

In addition, of course, an actual result grasp of work-in-process before transferring is performed in the present system. An example is shown in the graph in the right side of the graph. That is, the amount of work and its costs are set up (direct material costs, processing costs, expenses, and a total value) for every process plan as a received order. Based on manufacture basic data of the product composition model <prototype>, the present system automatically calculates and presents a setting value in principle. Regarding the value automatically calculated, man's intervention operation is also supported by the present system in the range of a specific rule (registration of a reason for revision, a revised person in charge, etc. as basic data management). Based on the setting value, a production monthly plan value is plotted in the graph, and a monthly actual result value (in the present system, a progress degree and costs must be synchronizingly presented. Details is described in the “development-plan management (new product)”) is also shown by comparison.

In this example, a curve based on a target value (plan value) (it is an example of a target value of a cost amount) smaller than order volume is presented, and deviation from the actual result curve (S curve) (it is an example of cost actual result information) can be observed.

Moreover, observation and management can be similarly performed for a software issue (service issue included) as well as hardware. Here, it becomes possible for materials costs (direct material costs) as outsourcing costs, for processing costs as software work costs, and expenses as other cost (management-indirect costs) to be practically applied.

As mentioned above, in the present system, based on an actual result value of transferred order in real time, it is possible to guide an effective and actual action by a future order-receiving strategy, and to act on a business profit as a feed forward adjustment function.

Moreover, in the present system, it is possible to observe an actual result against a monthly (it is an example of a prescribed period) plan corresponding to its work-in-process order and business segment. An example of this is shown in the lower graph in FIG. 40. Here, a monthly work-in-process order, that is an actual result value (it is an example of cost actual result information) in Customers 1A, 1B, 1C, and 1D is computed, and presented. When the actual result value of an order exceeds a plan value (it is an example of cost information and a scheduled cost amount), a warning is issued.

This example shows the case of warning being issued to the order whose actual result exceeds a plan value, and to the business segment.

Thus, the present system can observe and manage transition of an actual result/plan corresponding to a work-in-process order and a business segment and can issue a warning when it is likely to exceed the plan value. Therefore, it is possible to guide a feed forward adjustment of improvement and reform to a subsequent action and provide a structure directly linking to a business profit.

These actual result management data is, of course, reflected in the “production-plan management (manufacture)” and further in the “order-receiving-plan management (contract)” and the “annual-plan management (sale).”

As stated above, it is a feature that the production-plan management part 140 manages cost information corresponding to production plan information managed, and the terminal display part 1 displays the production plan information and the cost information managed by the production-plan management part 140, in a graph per prescribed period, and prompts a user to perform a product producing business reform.

Further, it is a feature that the production-plan management part 140 manages the cost information on a product corresponding to managed production plan information per prescribed period, inputs cost actual result information on the product produced before the prescribed period managed, and the terminal display part 1 displays the cost information managed by the production-plan management part 140 and the cost actual result information in a graph to be overlapped, per prescribed period, and prompts a user to perform a product producing business reform.

Further, it is a feature that the input part 3 inputs prescribed information as well as Embodiment 1. The application processing part 2, as well as Embodiment 1, calculates a value of a prescribed parameter, based on the prescribed information inputted by the input part 3, and decides a ranking of the prescribed parameter based on the calculated value. The terminal display part 1 prompts a user to input the prescribed information by the input part 3, displays the ranking of the prescribed parameter decided by the application processing part 2, in a graph, and prompts the user to perform a market analysis evaluation of business of the product as well as Embodiment 1, and the input part 3 inputs the target value of the cost amount of the product from a user, based on the market analysis evaluation of the business and outputs it to the production-plan management part 140.

Further, it is a feature that the production-plan management part 140 stores a target value of a cost amount of the product corresponding to the managed production plan information, and the terminal display part 1 further displays the target value stored by the production plan management part, in the graph, and prompts a user to perform a product producing business reform.

It is a feature that the production-plan management part 140 sets up a scheduled cost amount of the product corresponding to managed production plan information, and after receiving an order of the product, manages a cost amount required for the product, and the terminal display part 1 displays warning information in the case that the costs amount managed by the production-plan management part 140 exceeds the scheduled cost amount set up by the production-plan management part 140, and calls a user's attention.

The production-plan information includes expected production plan information which expects a production quantity based on a business year plan and decided production plan information in which order-receiving is decided, and the expected production plan information changes to the decided production plan information, and the production-plan management part 140 manages product information, cost information, and manufacture lead time information corresponding to managed production plan information, and dynamically changes the product information, the cost information, and the manufacture lead time information corresponding to the production plan information, based on a change of the production plan information, in a case of the production plan information being the expected production plan information and in a case of the production plan information being the decided production plan information.

Moreover, it is possible to decide and present the time and date of starting and completing this order work at every process of the process plan column, in the present system.

As an input value there, a work lead time (LT) (it is an example of manufacture lead time information) at each process per object article, which is a standard data of the product composition management model <prototype>, and a priority processing rule decided at the upper rank are input in the dynamic production plan adjustment control part 5.

In the present system, the standard of the priority processing rule is the latest completion schedule day priority (it is an example of priority processing information) of the order rooted in a CF cash flow maximization of the order. However, it is also acceptable to apply the earliest completion schedule day priority (it is an example of priority processing information), the earliest startable day priority (it is an example of priority processing information), etc.

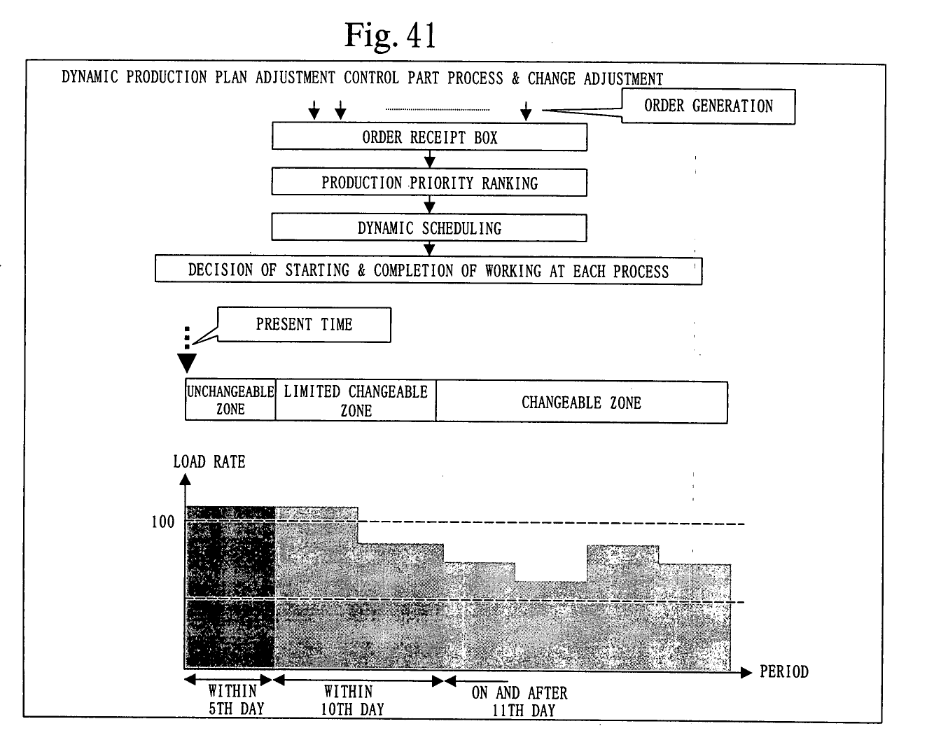

FIG. 41 shows a functional flow and an example of change adjustment of the dynamic production plan adjustment control part which performs an additional control in the production-plan management.

Hereafter, the dynamic production plan adjustment control part 5 of the present system will be explained with reference to FIG. 41.

The dynamic production plan adjustment control part 5 generates prescribed priority processing information for adjusting and controlling the production plan, based on a prescribed priority processing standard.

The production-plan management part 140 is characterized by inputting the prescribed priority processing information generated by the dynamic production plan adjustment control part 5, and generating production plan information based on the prescribed priority processing information that was input.

At the process of the dynamic production plan adjustment control part in FIG. 41, giving production priority ranking (it is an example of a prescribed priority processing standard) is performed for various orders (including orders-received and temporary orders) registered in the order receipt box. As to the ranking, a delivery deadline of an order is automatically decided based on a load rate (production capacity against demand scale), as follows:

(1) In the case of production capacity>demand scale (load rate of less than 100%), production priority is decided in order of added value (throughput) from large to small.

(2) In the case of production capacity<demand scale, production priority is decided in order of added value/manufacture LT from large to small.

As to the manufacture LT herein, it is preferable to apply a method of considering not only the pure production capacity of equipment but a make-ready time (pre-processing, post-processing) and failure probability, to convert it into a practical capability.

As mentioned the above, the priority ranking is decided, and the dynamic production plan adjustment control part 5 outputs a priority ranking (it is an example of prescribed priority processing information) to the production-plan management part 140. The production-plan management part 140 generates production plan information so that loading and load leveling (it generates provisionally during adjustment) simulation may be executed in every production process, according to ranking of the priority ranking.

Process scheduling is registered to be within the rule (tight) range of the present system, and a warning is issued for orders exceeding the rule and presented at the terminal of the present system. The order for which warning was presented is checked under the rule (loose) of the present system to be adjusted and decided.

The present system has priority ranking processing rules of two sorts: a tight type automatic processing system and a loose type dialog processing system. It is also acceptable for a person to be concerned to flexibly decide the production process.

As stated above, it is also acceptable that the input part 3 inputs prescribed information as well as Embodiment 1,

the application processing part 2, as well as Embodiment 1, calculates a value of a prescribed parameter, based on the prescribed information inputted by the input part 3, and decides a ranking of the prescribed parameter based on the calculated value,

the terminal display part 1, as well as Embodiment 1, prompts a user to input the prescribed information by the input part 3, displays the ranking of the prescribed parameter decided by the application processing part 2, in a graph, and prompts the user to perform a market analysis evaluation of business of a product,

the input part 3 inputs prescribed priority processing information from a user, based on the market analysis evaluation of the business, and

the production-plan management part 140 inputs the prescribed priority processing information inputted by the input part 3, and generates production plan information based on input prescribed priority processing information.

Therefore, based on the real-time situation, it becomes possible in the present system to guide the indicator towards a business profit growth & a CF cash flow growth in feed forward, for a future activity.

As shown in FIG. 41, the production change adjustment has three sorts of zones (period): an unchangeable zone, a limited changeable zone, and a changeable zone. For example, it is defined that the unchangeable zone is the present time through the fifth day, the limited changeable zone is the sixth day through the tenth day, and the changeable zone is on and after the eleventh day.

As to these zones of three sorts, the standard work regulation including work flows and work equalization, such as equipment operation, make-ready, and worker selection arrangement, serves as main restriction conditions.

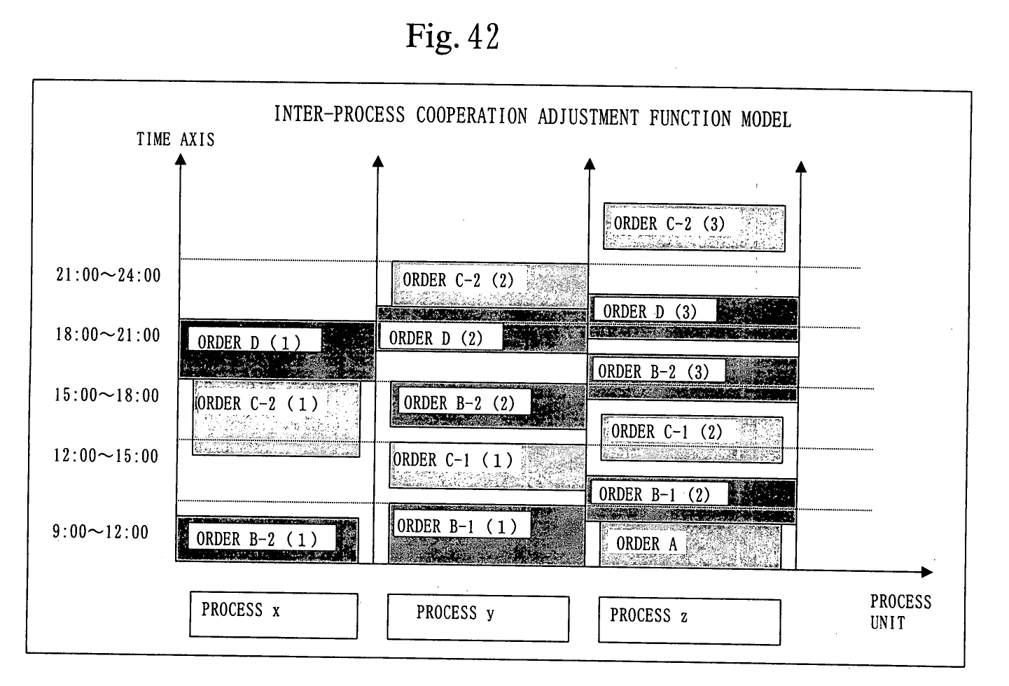

A model of an inter-process cooperation adjustment function of the dynamic production plan adjustment control part will be explained with reference to FIG. 42.

FIG. 42 shows a model of an inter-process cooperation adjustment function of the dynamic production plan adjustment control part. This model shows an example composed of a process x (high rank)→a process y (middle rank)→a process z (low rank). These processes are functionally independent completely, and they may work independently and may cooperate in working.

The horizontal axis indicates inter-process and the vertical axis indicates a time axis. Orders flowing are six sorts of orders: an order A (product A), an order B-1 (product B), an order B-2 (product B), an order C-1 (product C), an order C-2 (product C), and an order D (product D), and a flow of working of each order is shown.

The order B-1 and the order B-2 mean two sorts of orders of the same product B manufacture. The order C-1 and the order C-2 mean two sorts of orders of the same product C manufacture. The space between processes indicates that make-ready working is needed respectively and the work is discontinuous. No space between processes indicates that make-ready working is unnecessary and the work is continuous to be able to perform continuous operation. Between 9:00 and 12:00, at the process z, the work of the order A is completed, and a completed article (order B-1 (1)) flows in from the process y of the order B-1 and the regular work is continuously performed as the order B-1 (2). At the process y, the work of the order B-1 is performed (order B-1 (1)), and what has been completed flows into the process z as it is. At the process x, the product of the order B-2 (1) is produced. As shown in this example, it is possible in the present system to set up cooperation of processes from high rank to low rank including make-ready working being necessary or not. It is shown that the order B-1 performs cooperation without make-ready working at the process y→process z, and the order B-2 performs cooperation with make-ready working at the process x→the process y and cooperation without make-ready working at the process y→the process z. It is shown that the order D performs cooperation without make-ready working at all the processes from the process x (high rank)→the process y (middle rank)→the process z (low rank). It is shown in this example that a suitable order combination enables process cooperation by which the make-ready working becomes unnecessary, that is make-ready time can be omitted (useless can be omitted).

As mentioned above, the present system has the adjustment function in which, considering a future profit, flexibility can be demonstrated by responding to the needs of the customer, in addition to the rule (including the case of omitting the useless) towards CF cash flow maximization.

When a work starting time and date in each process of a manufacture object article connected to an order number is decided in the “production-plan management (manufacture)” of the present system, it is required to inject necessary procurement material (object article) synchronizingly with the starting time and date.

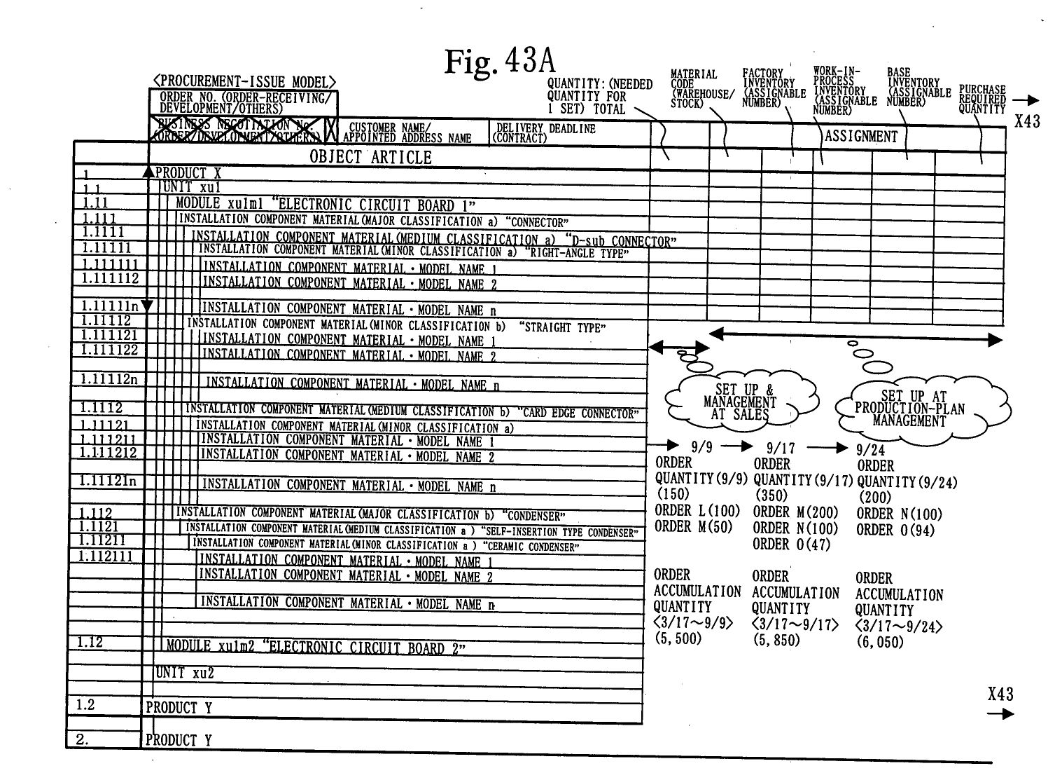

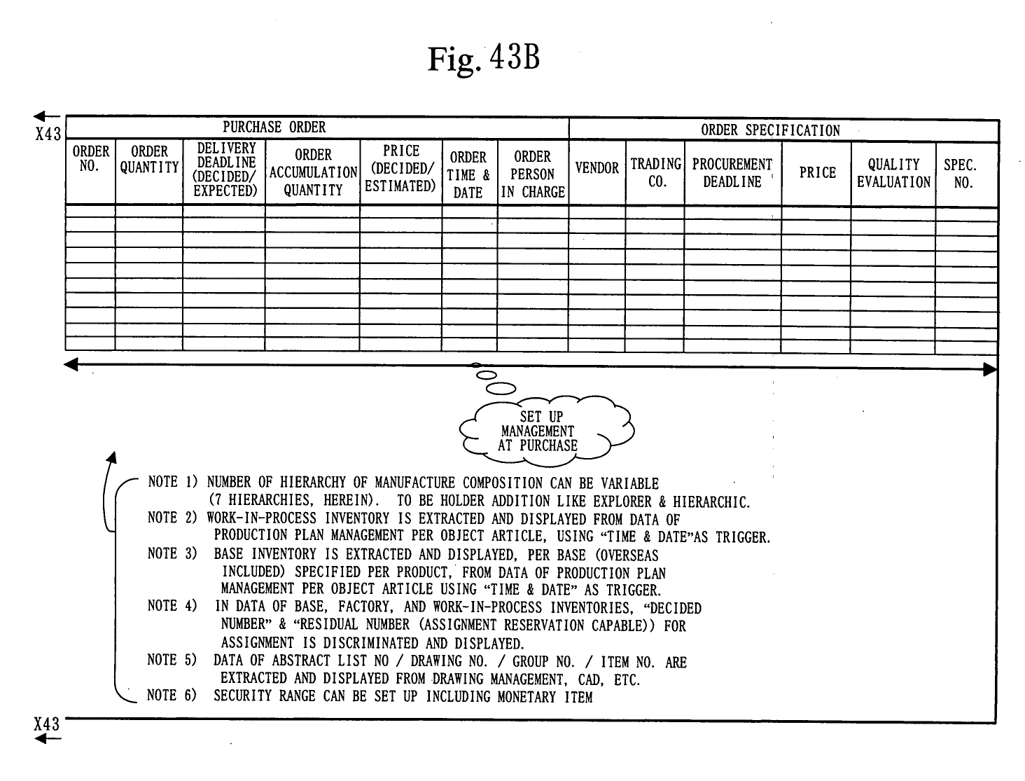

Next, <procurement-issue model> being an example of adjustment plan information will be explained with reference to FIG. 43A and FIG. 43B (FIG. 43A through FIG. 43B express one figure).

FIG. 43A and FIG. 43B (FIG. 43A through FIG. 43B express one figure) show a procurement issue information model at the procurement-plan management.

In the procurement-plan management part 170, in order to perform the requirement, that is to perform injection of necessary procurement component material (object article) before work starting of the process, a procurement deadline (procurement LT) which has been decided beforehand as procurement basic data of a product composition management model <prototype> is collected, and a procurement order date of component material (object article) is decided by automatically calculating “work starting time and date-procurement LT.”

Of course, as a preparing work of the component material order, when there is inventory, it is urged to precedently utilize the inventory and to provide factory inventory, base inventory (outside the factory) or work-in-process inventory which is being manufactured. Then, object articles which still run short are automatically calculated and presented as a purchase required number, in the present system. Moreover, it is possible to perform a manual setup for complementing a risk, based on an automatically calculated value.

In this way, the purchase required quantity and the order day of the component material (object article) are decided. Then, based on dealing conditions exchanged with the supplier, an order person in charge needs to decide whether to independently issue an order direction for the order, or to issue collective orders including other order, with having a delivery deadline confirmation and a price negotiation. (In the present system, a collective quantity of un-ordered articles whose order schedule time limits are over is automatically calculated by data consolidation per object article code or material code (which is classified into articles in warehouse, ordered articles, and special order) specified by material. Since an order accumulation number calculated by totaling numbers of orders issued till now is effective in the negotiation, the order accumulation number is automatically calculated and presented by way of specifying a period, in the present system.

Moreover, it is possible to advantageously attend the negotiation by preparing a quality evaluation, a procurement cost price, and procurement deadline information of the other venders or other trading companies used as procurement basic data in the order specification column. Regarding the number of orders, based on a purchase required number, it is possible to make the purchase required number (automatically presented by the present system) be the number of orders as it is, or to decide and register a value modified a little by considering risks (a failure rate of component material itself, a manufacture mistake rate, etc.).

In FIG. 43A and FIG. 43B (FIG. 43A through FIG. 43B express one figure.), an order of order regular quantity of 150 pieces was placed on 9/9 (September 9), and its order accumulation number became 5,500 pieces. On 9/17 (September 17), an order of 350 pieces against the order regular quantity of 347 pieces was placed and its order accumulation number became 5,850 pieces. On 9/24 (September 24), an order of 200 pieces against the order regular quantity of 194 pieces was placed and its order accumulation number became 6,050 pieces.

On decision or estimation, the price is discriminated and registered, and its result is fed back to the direct material costs of <manufacture-issue model>. Therefore, it is possible in the present system to predict in real time how much has been improved compared with the standard.

After the above data having been decided and registered, an order number and an order person in charge (name or code) are added to issue an order direction. Considering of the case where the price column and such is open to only a limited person, it is possible in the present system to set up a security range at the security processing process.

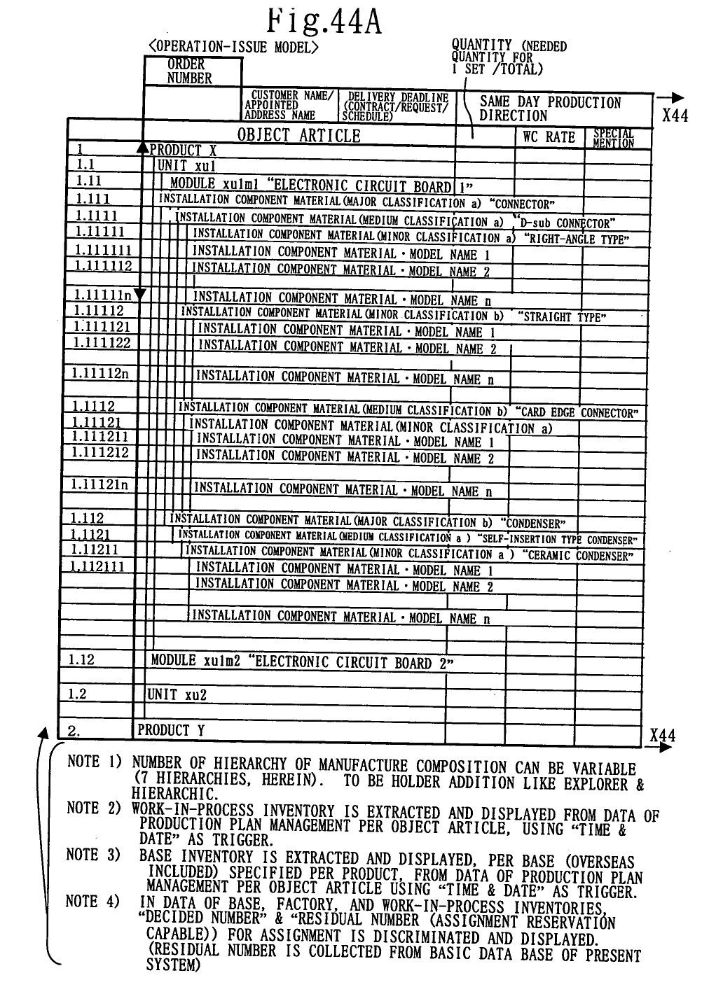

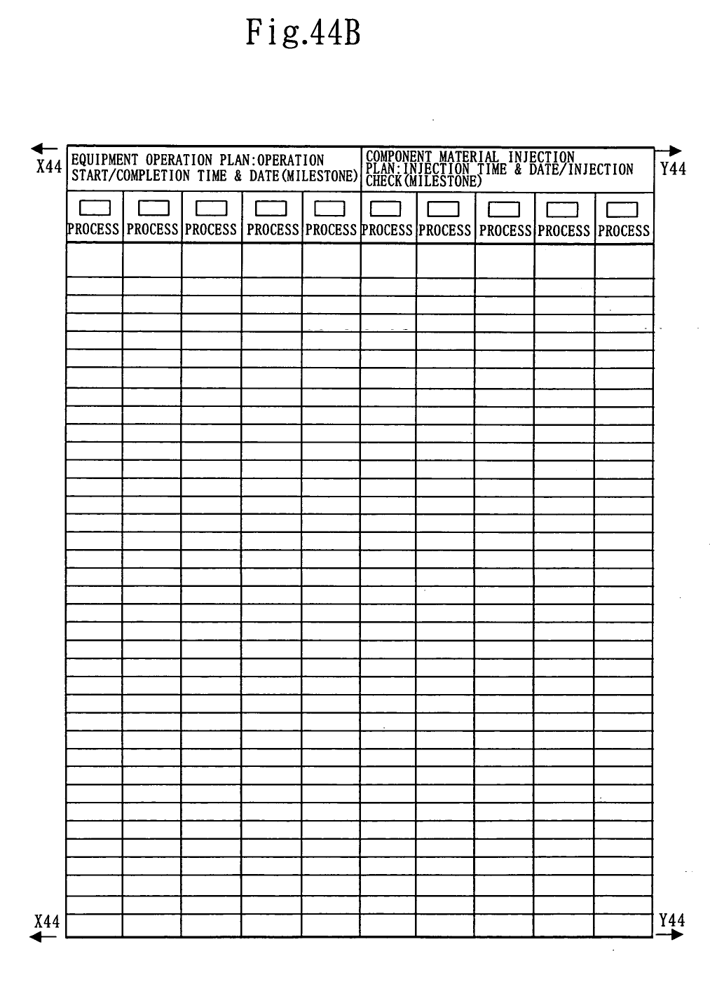

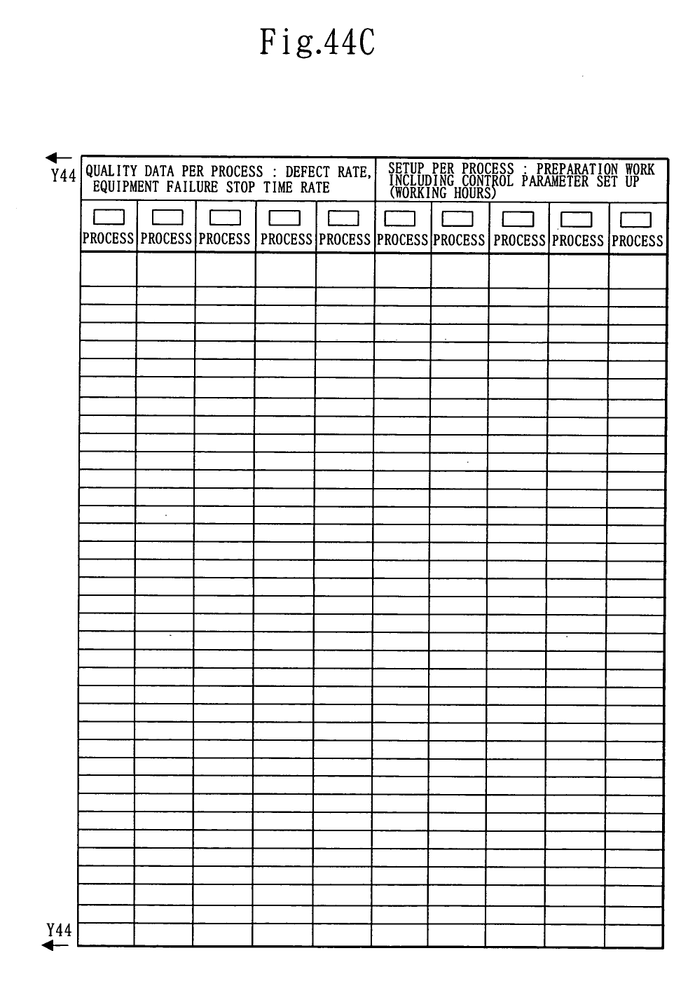

Next, “equipment operation-plan management (operation)” will be explained with reference to <operation-issue model> (it is an example of production implementation information) in FIG. 44A, FIG. 44B, and FIG. 44C (FIG. 44A through FIG. 44C express one figure).

FIG. 44A, FIG. 44B, and FIG. 44C (FIG. 44A through FIG. 44C express one figure) show an operation issue information model in the equipment operation-plan management.

After a decided order has been set up at the “production-plan management (manufacture)” or a plan to be produced soon is set up based on a delivery deadline in a temporary order, depending upon the set up, the equipment operation-plan management part 150 issues a same day production automatic direction (it is an example of production implementation information) or a same day production direction (it is an example of production implementation information) made by adding some risk compensation to the automatic direction is generated by manual set up. Then, it is output to the operation control management part 160. The operation control management part 160 generates equipment control information, and transmits it to the equipment apparatus which needs the equipment control information.

The automatic planning part 151 automatically generates the production implementation information based on prescribed priority processing information.

The manual adjustment part 152 performs a manual adjustment of the production implementation information generated by the automatic planning part 151, based on adjustment information input by the user.

The terminal display part 1 displays the production implementation information generated by the automatic planning part 151, and prompts a user to input the adjustment information.

Moreover, it is also acceptable to have the structure of the following: the equipment operation-plan management part 150 inputs production implementation actual result information (for example, the actual result value in the chart graph of the upper part of FIG. 40) which was used when the product was produced before. Then, similar to the terminal display part 1 performing at the production-plan management part 140 in FIG. 40, at least one of the production implementation information (for example, the plan value in the chart graph of the upper part of FIG. 40) which was generated by the automatic planning part 151 and the production implementation information (for example, the plan value in the chart graph of the upper part of FIG. 40) which was performed a manual adjustment by the manual adjustment part 152 can be displayed with the production implementation actual result information on the same screen to be in a chart display.

This region is a control region of the production process, and is in the range of a batch process (assembly processing) or a continuous process (material, energy).

Therefore, in the equipment process, it is indispensable to complete injecting component material (object article) required for the product for manufacturing before the equipment operation start. A control parameter (it is an example of equipment control information) required for the equipment operation is suitably set up by the operation control management part 160 or set up by the equipment itself (equivalent to a make-ready setup).

Thus, at the time of the make-ready setup is decided by the equipment operation-plan management part 150, the actual operation control management part 160 inputs information on the setup, generates an equipment operation parameter, sets it up for the equipment, and makes the equipment operated.

Moreover, since the quality of a manufacture object article and its productivity are dependent on the equipment apparatus, the rate of yield, the rate of defect, the rate of failure stop time of equipment, etc. are important as process quality data.

The <operation-issue model> are shown in FIG. 44A, FIG. 44B, and FIG. 44C (FIG. 44A through FIG. 44C express one figure). The <operation-issue model> includes the following make-ready setup: the product composition management model <prototype> composed of an order number as a base, a customer name/a customer appointed address, a delivery deadline, and a manufacture quantity of the object article, a special mention matter being a consideration matter from a higher rank, an operation start/completion time and date of each equipment (process), an injection time and date of each process in a component material injection plan, an yield and a defect rate as an operation result, quality data at each process for representing a rate of equipment failure time, and a control parameter setup for equipment apparatus at each process, which is required to be performed before the operation.

Next, “development-plan management (new product)” performed by the development-plan management part 180 will be explained.

This is functionally the same as the “production-plan management (manufacture)” at the time of order-receiving production except for one part. Thus, compared with the “production-plan management (manufacture)” in which the object article to be produced is decided based on the order-received production, the production object article in a development production is undecided in the “development-plan management (new product)”.

Ultimately, it can be called a risk investment order pursuing high breakthrough of uncertainty compared with the order-received order. Therefore, it is required here that a risk should be controlled as much as possible and a breakthrough should be made actual.

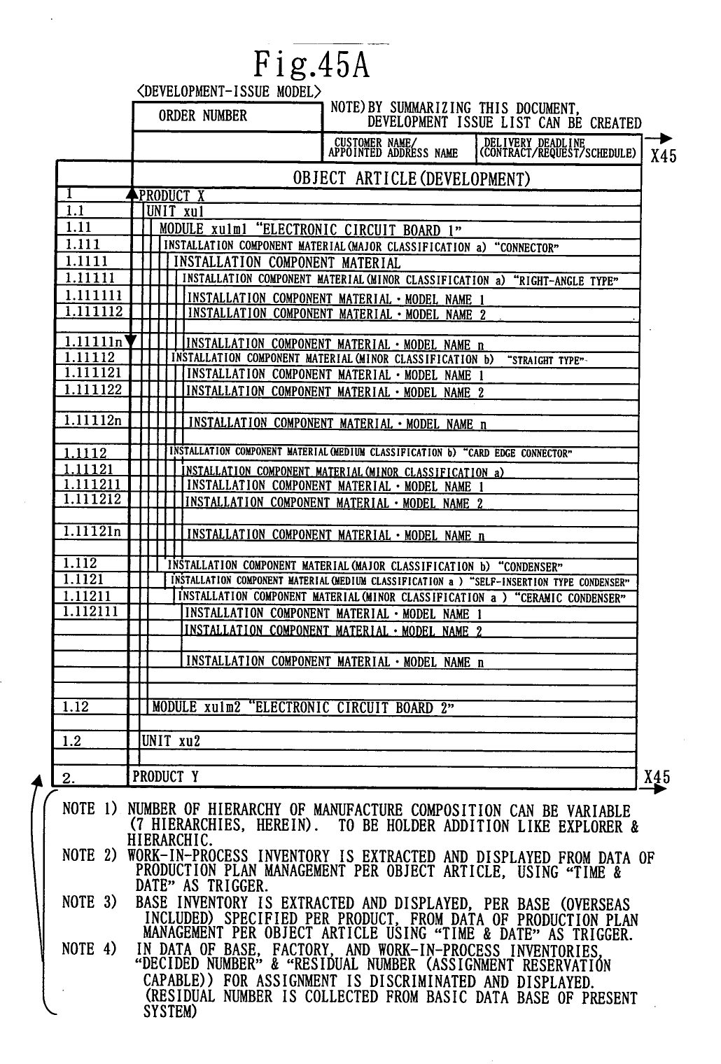

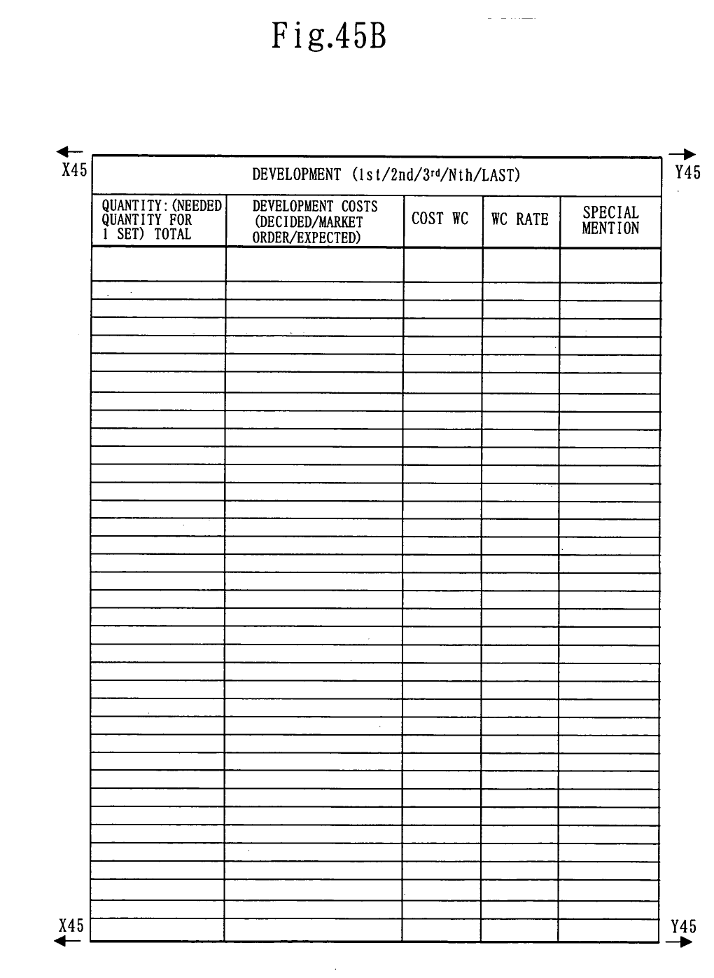

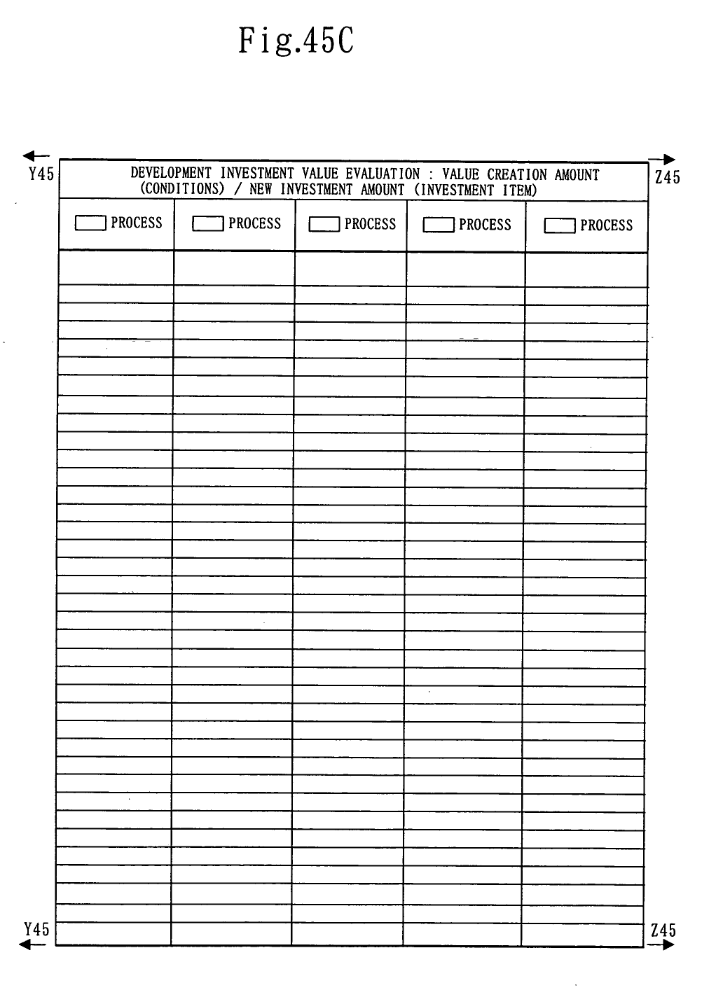

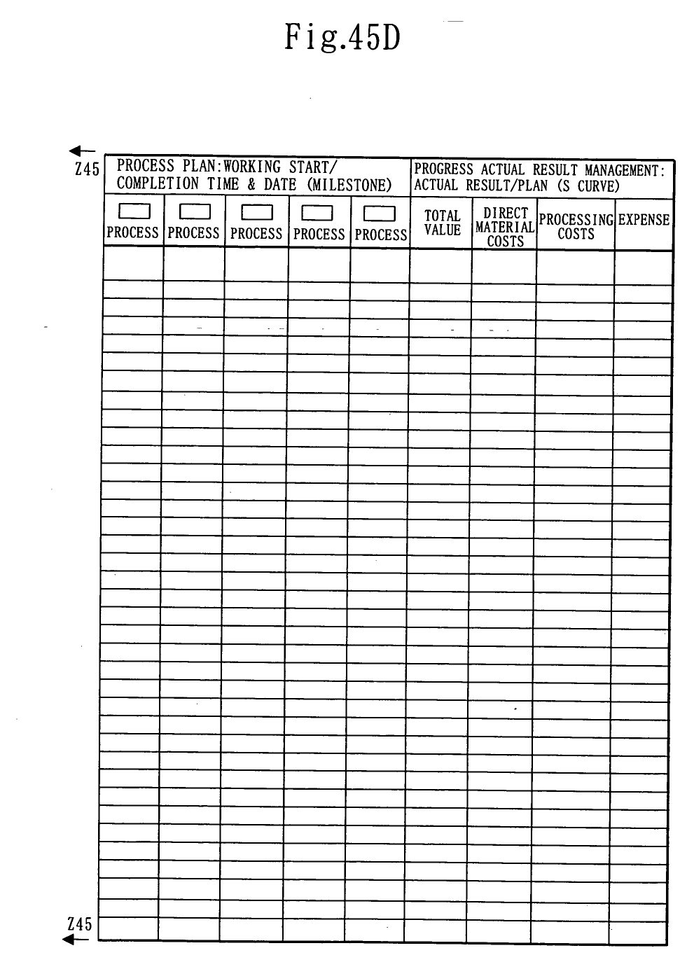

FIG. 45A, FIG. 45B, FIG. 45C, and FIG. 45D (FIG. 45A through FIG. 45D express one figure.) show a development issue information model of the development-plan management.

The order number in the <development-issue model> of FIG. 45A, FIG. 45B, FIG. 45C, and FIG. 45D (FIG. 45A through FIG. 45D express one figure.) must be registered as a development order like the order number of the order-receiving of the “production-plan management (manufacture).”

In FIG. 45A, FIG. 45B, FIG. 45C, and FIG. 45D (FIG. 45A through FIG. 45D express one figure.), when the delivery place has not been decided, the customer name/the customer appointed address can be a market demand class name or a special encrypted name being unwilling to be disclosed.

The delivery deadline is strictly determined in considering a market injection time, with a business management side. Since this delivery deadline delay becomes an important factor which brings about business inactivation and deterioration, it is important to make an adjustment between the sales side demand and the development side resource injection in deciding the delivery deadline. Accordingly, it first becomes important to have an examination and evaluation in advance to consider whether the development item (subject) is appropriate as a breakthrough object which creates a business profit or not. This is the column of development investment value evaluation of the present system, and this is different from the order-received order. As to the development investment value evaluation, expecting an amount of a value creation, and expecting an amount of a new investment are fundamentally performed to measure its ratio. For example, development of a new product “Product x” is planned. The new unit “xu1” and the module “electronic circuit board 1” compose the Product x, for which an installation component material “connector” which is newly developed is used in order to suggest differentiation from the other company. Then, an amount of the value creation based on the new product injection into the market is practically calculated and management resources required for the development are computed. This management resources are human resources, funds, or a new investment-in-plants.

Therefore, development resources (human resources and funds) or a new investment-in-plants is strictly estimated for every development object article (development item). It is necessary for a delivery deadline of a development result thing and a development costs which serves an exchange for the delivery deadline to mutually commit (a business management side, a sales person in charge, and a development person in charge).

As it is necessary to inject an appropriate specialist as the development human resources, it may-be procured from outside the company. Further, depending upon a development item, there may be a case of all of the development being performed outsourcing.

Considering dealing with these, it becomes possible to classify and discriminate to be corresponding to each object article (development item), in the development-plan management part 180. The work class relation of a product/a unit/a module (parent)/a module (child)/a module (grandchild) and its person-in-charge name can be assigned one to one. The development costs (amount/load) based on the work load and its development stage can be discriminated at a process, and consistency at the critical point can be observed by plan-actual result management. Further, it is possible to observe and manage in detail by way of discriminating the development work progress plan and actual result as direct material costs, processing costs (manufacture costs or experimental manufacturing costs), and expenses (design costs). Therefore, a problem generation (deviation between a plan and an actual result) can be detected in real time, and subsequent improvement activities can be suggested. Thus, as a feature, the present system can simultaneously perform adjustments of a new development design and a production line design in parallel, and enables an adjustment of deviation between the plan and the actual result in feed forward. In order to perform the development as planned, in the present system, specifying requirements for the development and managing a change of the development are managed as important points.

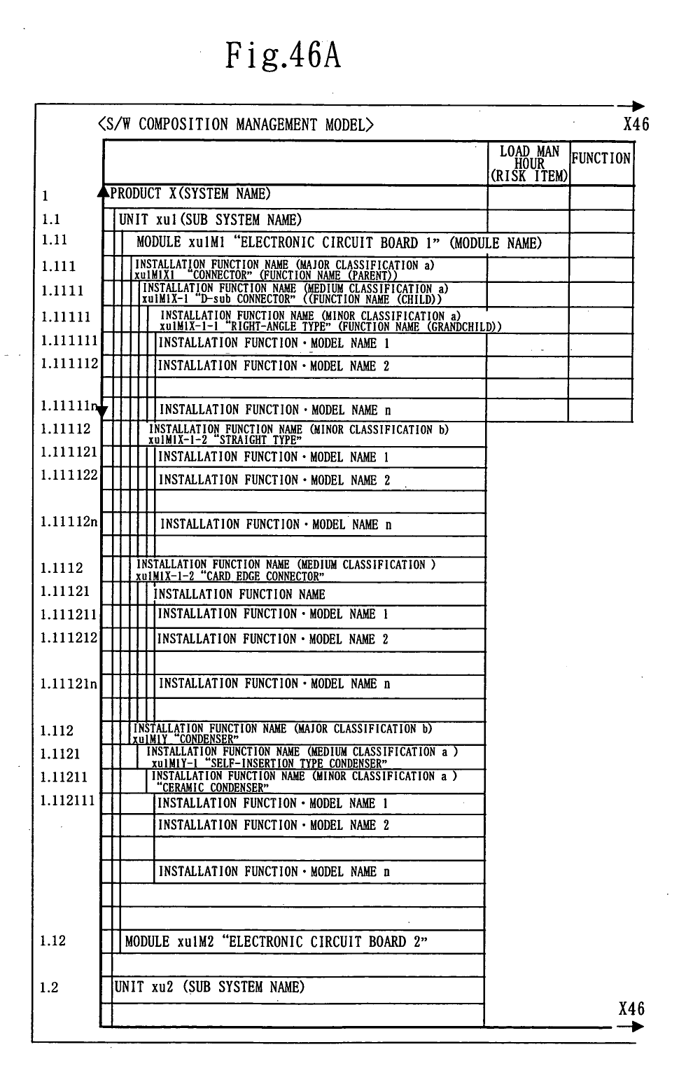

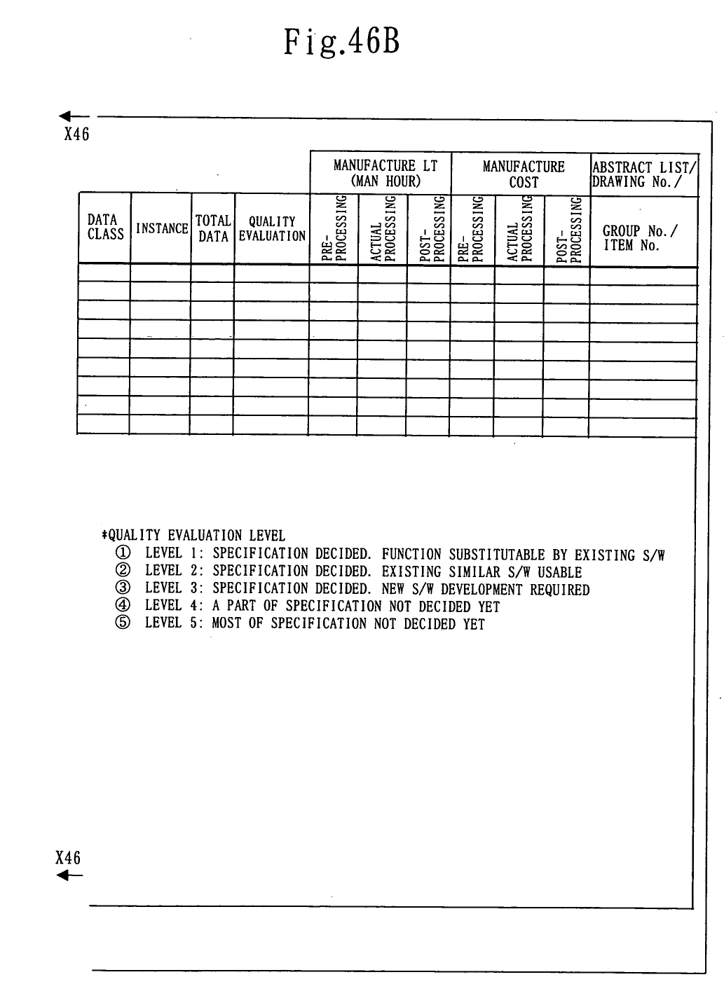

Moreover, in the present system, it is possible to settle a software development method, which requires complicated measures specially from a requirement definition to a change management, by completely the same method as hardware. This will be explained with reference to <software (S/W) composition management model> of FIG. 46A and FIG. 46B (FIG. 46A through FIG. 46B express one figure).

FIG. 46A and FIG. 46B (FIG. 46A through FIG. 46B express one figure) show a software composition management model.

The product x of FIG. 46A and FIG. 46B (FIG. 46A through FIG. 46B express one figure) corresponds to a “system name” in software, and a unit corresponds to a “subsystem name” composing a system. Thus, it indicates a work equivalent to an operating-role in the system.

Module items of lower rank indicate requirements for software, i.e., a plurality of independent works themselves for executing business, and they are “module names” themselves of minimum independent units of the general software composition. Moreover in the present system, the composition can be further advanced to be in detail by making the hierarchy where an installation component name of hardware corresponds to a “function name (parent)” of the installation function, and further naming is performed as a “function name (child)” and a “function name (grandchild)”.

Therefore, the hierarchy in hardware that the product of hardware→unit→module→installation function (major classification)→installation function name (medium classification)→installation function (minor classification) corresponds to the hierarchy in software that system→subsystem→module→installation function (parent)→installation function (child)→installation function (grandchild). Thus, although the names are somewhat different in hardware and software, it is possible in the present system to define completely the same composition for both the hardware and the software.

When the hierarchical structure of hardware and software is defined, it becomes possible to understand the whole contents and details by clarifying what functional actions the items have, what data classes (data lump name) they have, what data exists as a data name, and how much data total number they process.

When specification is defined as requirements in the form which the participants in development can understand, such as data classification which an item, such as a functional action, treats for every item in each hierarchical composition, a load man hour is set up for each of the requirements. By setting up and accumulating load man hours from the low rank of the hierarchy, the setup can be performed more practically and more correctly.

In the present system, this load man hour is vouched based on the existing similar issue, and further, it is possible to adjust more practically in feed forward by clearly specifying the risk in the setup.

Moreover, the quality evaluation depends upon a risk degree, and, in the present system, the level of the risk are the following five: a level in which specification is decided and its function can be substituted by existing software, a level in which specification is decided and existing similar software is usable, a level in which specification is decided but new software development is required, a level in which a part of specification has not been decided yet, and a level in which most of specification has not been decided yet. Based on these, the risk of the load man hour which has been set up is predicted.

Moreover, in the present system, when a work load man hour is estimated including the functional action defined for every item and the setup of detailing it for the data as an actual work of pre-processing, actual processing, and post-processing, the contents of the work can be further advanced in detail in order to accurately perform the setup. Then, costs based on the actual load can be presented as manufacture costs.

As mentioned above, a requirement definition, a prediction of a load man hour, and a risk degree in the development issue are included as a quality evaluation. Requirements are decided by completing these and this information is defined as baseline of a development issue, in the present system. Based on the above-mentioned concrete data, a plan setup can be attainable in the development (SW) process plan management of the present system.

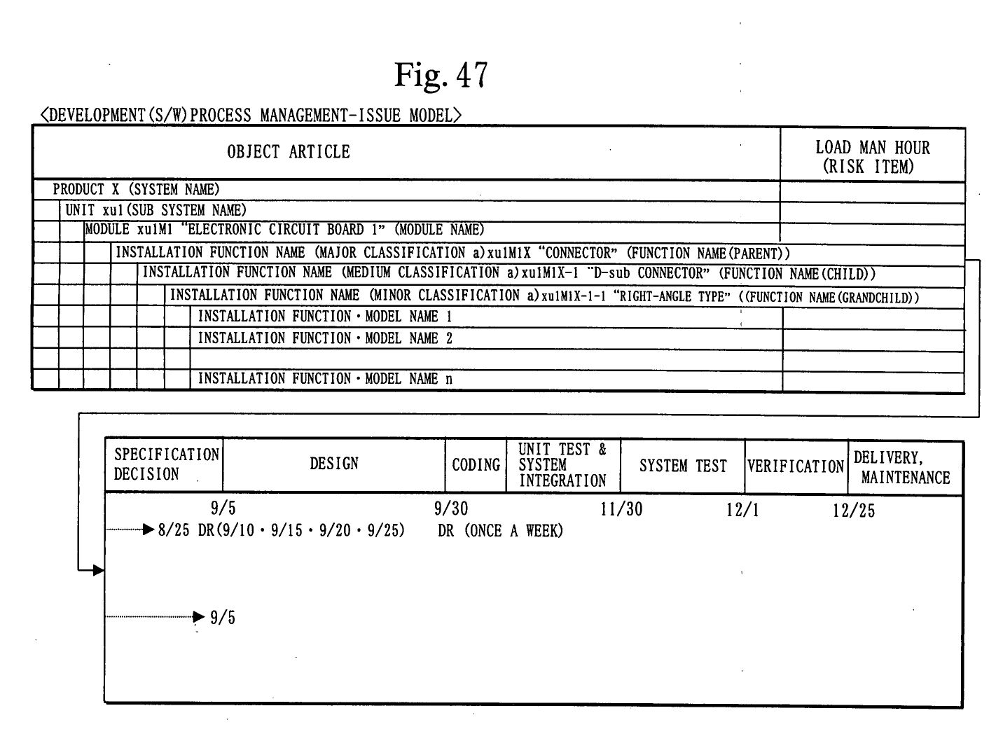

This is <development (S/W) process management-issue model> (it is an example of development plan information) of FIG. 47.

FIG. 47 show an example of a development (software) process management model. Consistency is needed at the phase of “specification decision”, “design”, “coding”, “unit test & system integration”, “system test”, “verification” and “delivery maintenance” to be corresponding to an object article. In this example, the schedule shows as follows; a specification is decided on 9/5 (September 5th), design specifications are completed on 9/30 (September 30th), coding completion and unit test & system integration are completed on 11/30 (November 30th), a system examination is started on 12/1 (December 1st), delivery is executed on 12/25 (December 25th), and verification is performed between 12/1 and 12/25.

In the present system, since schedule in the minimum unit of the development item can be set up as mentioned above, the schedule relation between the work starting and the work completion becomes quite obvious, and inconsistency of a critical path etc. can be easily discovered and presented.

Then, in the present system, a development (S/W) progress actual result management is performed under this process plan management. Deviation between a plan and an actual result can always be grasped, and an appropriate processing can be performed in real time to control an order profit-and-loss deterioration.

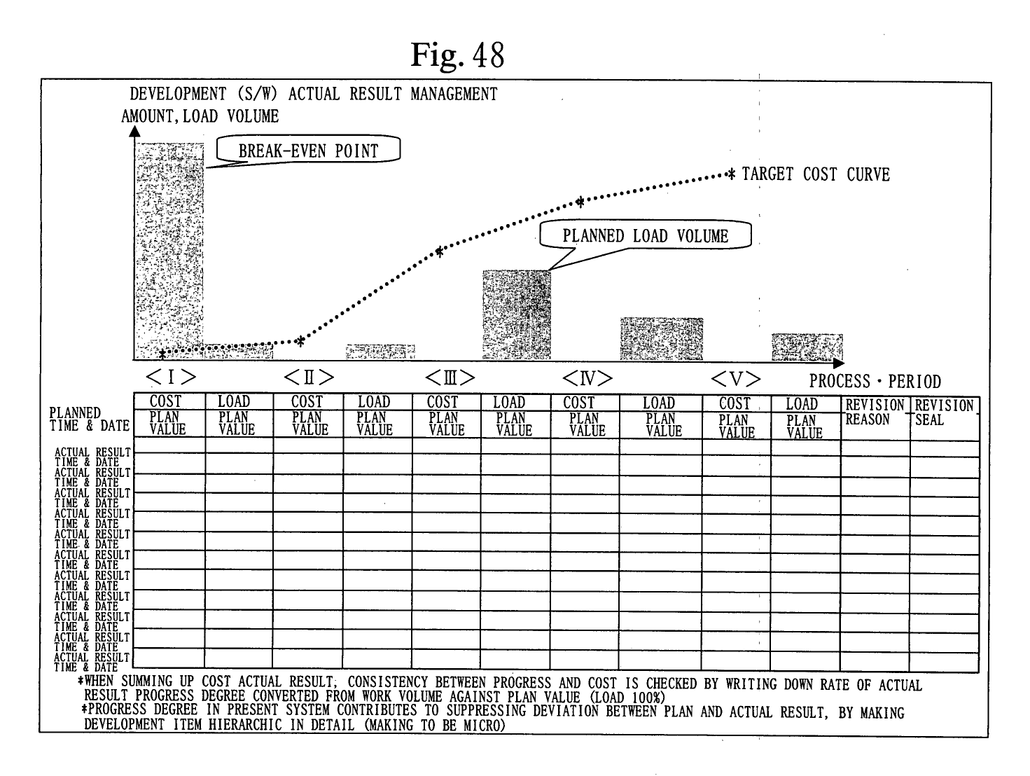

FIG. 48 shows a development (S/W) actual result management.

In FIG. 48, points from a process <I> to a process <V> as a base, amount of work load is planned (a work scale and costs) under an appropriate estimation for every development item, and an actual result against the plan value is observed and managed. Summing up the actual result is performed at a cycle or hold point specified beforehand. At the time of the summing up the actual result, a converted rate indicating a degree of actual result progress of the work amount against the plan value (100% of loads) is also presented to check the consistency between the progress and the cost. Therefore, in the case of observing the data at a certain actual result time, the whole can be looked through by specifying the product x (system name). Thus, it becomes possible to observe the details of the development item, such as a unit (subsystem name)→module “electronic circuit board 1” (module name)→installation function name “connector” (function name (parent)). Since the accumulation of a plan value and its actual result at every process (hold point) and the accumulation up to its process can be observed, the profit-and-loss prospect of the order can always be grasped. Since a recovery measure can be suitably took in real time at the time of a tendency of becoming deteriorated, it is possible to connect to a loss improvement and a profit growth.

Generally in the actual result management, an accuracy of estimation of work load amount at the time of planning is a cause of a deviation generation. In the present system, the rate of progress can contribute to deviation control between the plan and the actual result, by making the development item systematized and hierarchical (making to be micro).

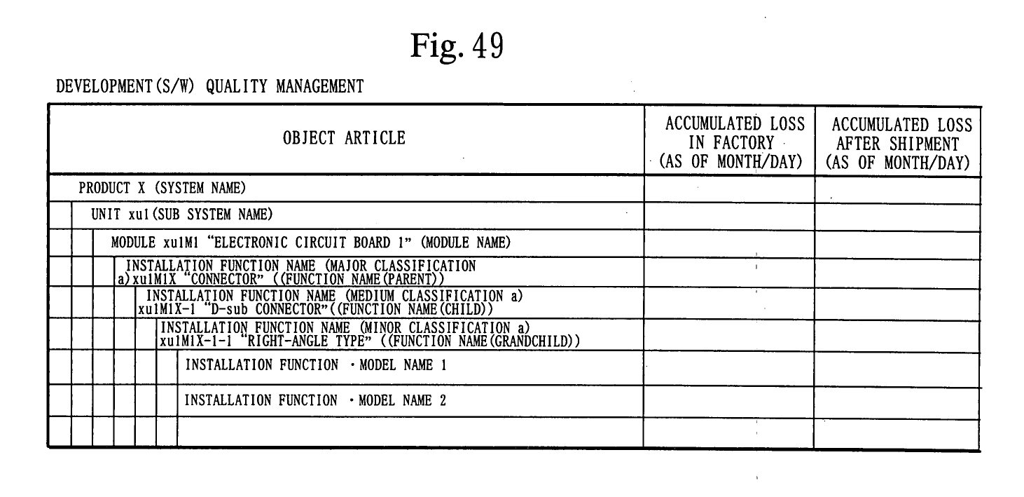

FIG. 49 shows quality management of development (S/W).

Furthermore, in the present system, development (S/W) quality management data is also included in the “development-plan management”. Considering that a development issue especially has a character as an investment order including a risk compared with an existing order-received order, it is possible to perform a management reinforcement as a quality cost of the result thing of the development issue. In FIG. 47, an accumulated loss in a factory and an accumulated loss after shipment are collected for every result thing of the object article. The former corresponds to a defect and failure discovered before shipment, and the latter corresponds to a defect and failure discovered in a verification and an actual operation after shipment. Moreover, when it is needed to check the contents of the quality defect, a detailed pursue can be performed by clicking an object column needed. Thus, in the matrix column of the result thing for development to be investigated and pursued and the accumulated loss, URL (Internet use) or a file name for presenting the details is embedded.

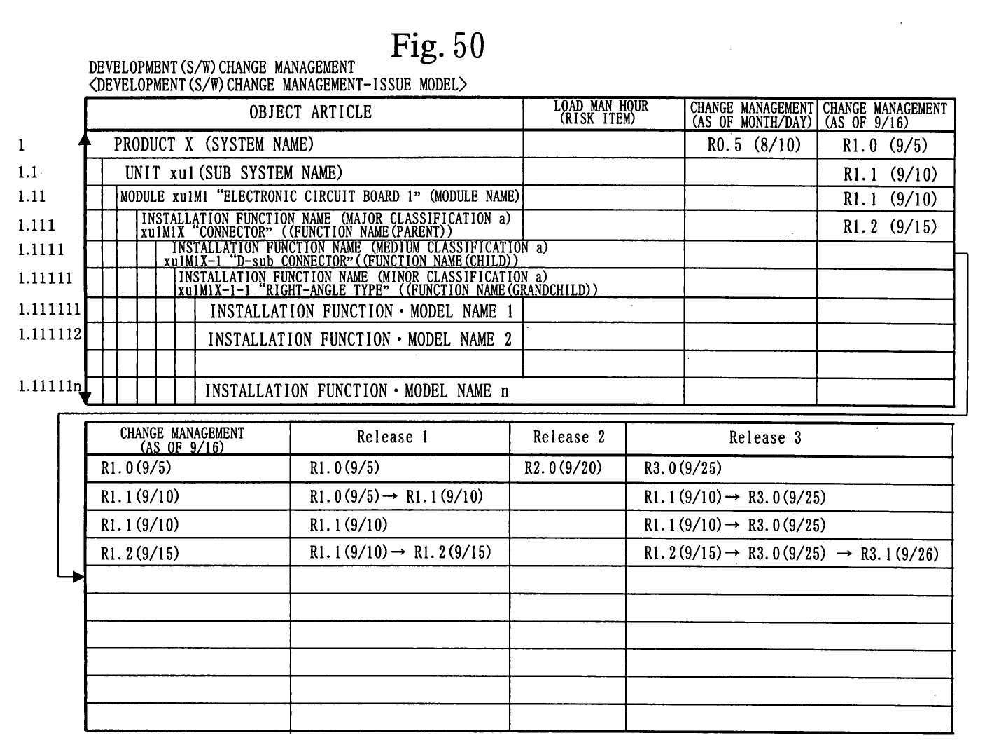

Next, a process plan management and a change management can be regarded as a remarkable important matter in a development order in the present system compared with an ordinary order-receiving order. The change management will be explained with reference to FIG. 50.

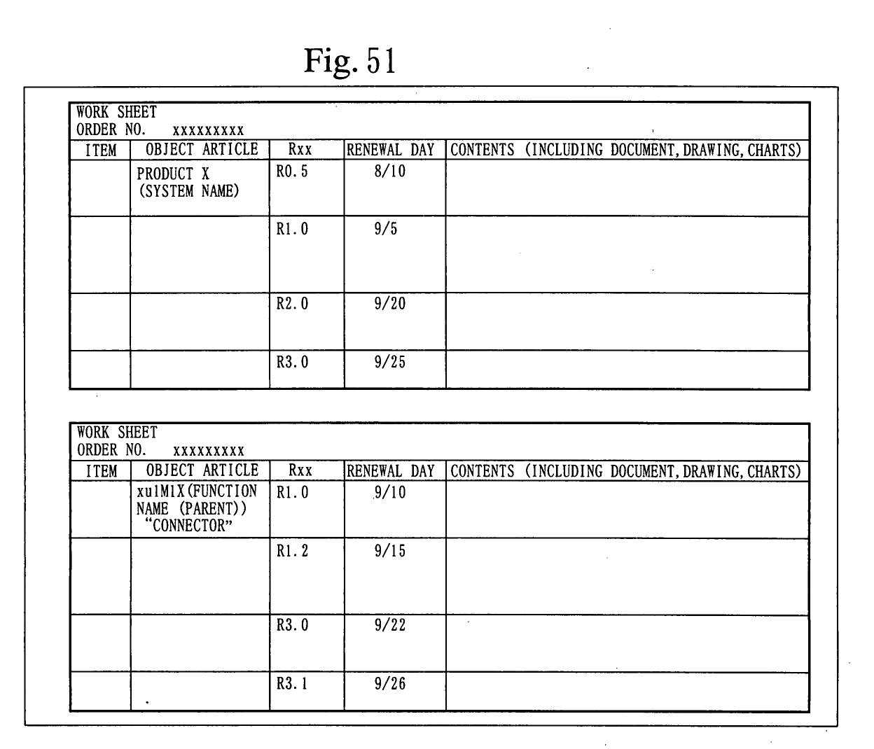

FIG. 50 shows an example of a change management model of development (software). FIG. 51 shows a worksheet. This frame is a product composition management model, and serves as a development software version.

Regarding a form, in which requirements of the change management are defined and a work range of the development item has been decided, as a baseline, it starts with being clearly specified to be release 1.0 (described as Rxx).

R0.5 specified on August 10 means the specification before the baseline, and can be called a specification of an estimation stage.

Release 1 (R1.0) is specified on September 5, and R1.0 (9/5) is registered for the product x (system name).

The release (integer x.0) in the present system means a requirement revision of the product x, and the release (decimal x.y) means a minor revision by the development side, which needs no revising requirements (revision).

In FIGS. 50 and 51, a minor revision is performed for a unit xu1 (subsystem name) from R1.0 (9/5)→R1.1 (9/10) on September 10.

Moreover, as to xu1M1 “electronic circuit board 1” (module name) composing a subsystem, the specification of R1.1 (9/10) is specified on 9/10 based on a subsystem revision of R1.1 (9/10).

Furthermore, as to xu1M1x “connector” composing a module, R1.1 (9/10) is defined and registered on September 10, and a minor revision is performed on September 15 to be defined and registered as R1.2 (9/15).

Next, the requirement for the product x (system name) is revised as release 2.0 on September 20 to be defined and registered as R2.0 (9/20). However, this revision of the requirement, which does not affect the unit xu1 (subsystem name) but affects a unit xu2 (subsystem name) and after it, is omitted here. Thus, the unit xu1 (subsystem name) group (xu1M1 “electronic circuit board 1” (module name), xu1M1x “connector” (function name (parent))) are presented to be invariable.

Next, the requirement is revised on 9/25 to be defined and registered as a release 3 (R3.0 (9/25)). It is shown that this directly affects the unit xu1 (subsystem name) group. The unit xu1 (subsystem name) is processed and revised to be from R1.1 (9/10) to R3.0 (9/25) on September 25. The xu1M1 “electronic circuit board 1” (module name) is processed and revised from R1.1 (9/10) to R3.0 (9/25) on September 25. The xu1M1x “connector” (function name (parent)) is processed and revised from R1.1 (9/10) to R3.0 (9/25) on September 25, and further a minor revision is performed to be from R3.0 (9/25) to R3.1 (9/26) on September 26.

Concrete revision processing according to the above change is shown in the worksheet of this figure. In the worksheet, an “order number”, a release number (Rxx) to be corresponding to an object article, its renewal day, and contents of the result thing are described as a document, a drawing, various charts, etc. This example shows the history of requirements revision of the Product x (system name) and the history of the xu1M1x “connector” (function name (parents)).

The revision processing is performed in the contents column of a result thing in this worksheet, and its completion date is registered and defined. Consequently, the release histories of the <development (S/W) change management-issue model> are automatically collected and presented in the present system. Thus, the “development-plan management” of the present system has the <development (S/W) process management-issue model> and the <development (S/W) change management-issue model> in addition to the <development-issue model>. It is possible to suppress a risk in a development order as an investment issue having the risk, by adding a special management function to the development order to discriminate from a general order-receiving.

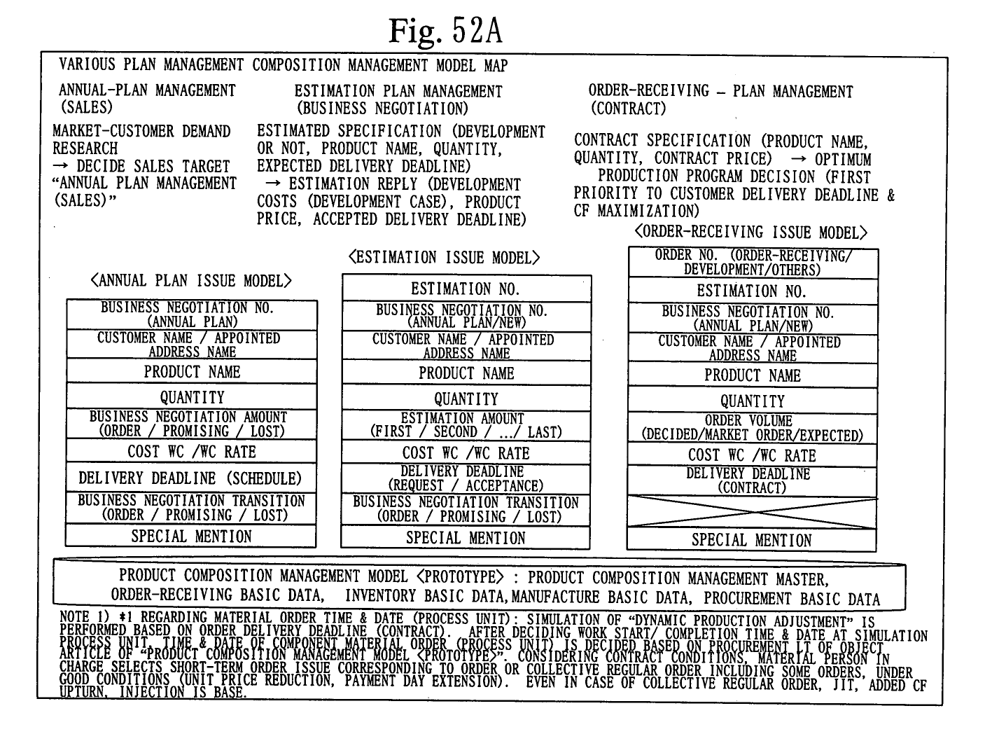

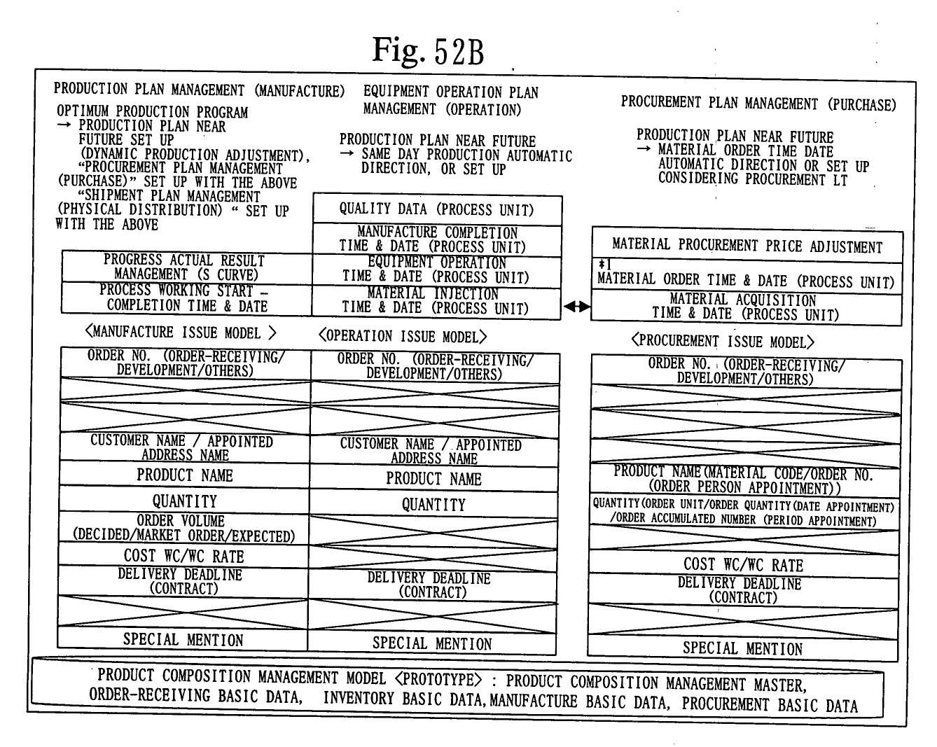

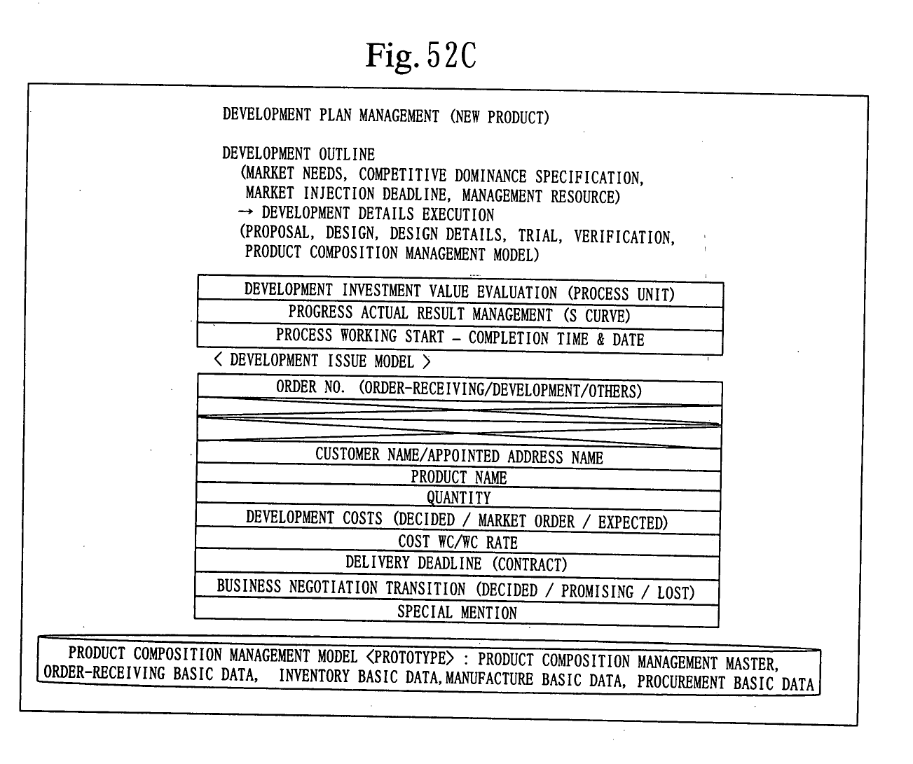

FIG. 52A, FIG. 52B, and FIG. 52C (FIG. 52A through FIG. 52C express one figure) show various plan management composition management model maps.

In FIG. 52A, FIG. 52B, and FIG. 52C (FIG. 52A through FIG. 52C express one figure), items performed by the various plan management parts and each plan data of the various plan management information are described respectively. The data with x (cross) mark indicates that it is unnecessary data in the plan management.

As mentioned above, in the present system, data of the various plan management properly includes the original data (underlying assets or original) of a product composition management model <a prototype>. Accordingly, it is possible to obtain a flexible structure where unification is attainable by extending data of the minimum item suitable for the purpose one by one.

As stated above, according to the product producing business reform support system of the above Embodiment, it is a feature that the product producing business reform support system comprises:

an order-receiving plan management part for managing order-receiving plan information which changes;

a production plan management part for generating production plan information based on the order-receiving plan information managed by the order-receiving plan management part, and managing the production plan information corresponding to a change of the order-receiving plan information;

a production implementation management part for generating production implementation information based on the production plan information managed by the production plan management part, and managing the production implementation information corresponding to a change of the production plan information; and

a display part for displaying at least one of the order-receiving plan information managed by the order-receiving plan management part, the production plan information managed by the production plan management part, and the production implementation information managed by the production implementation management part, and for prompting a user to perform a product producing business reform.

Further, it is a feature that the product producing business reform support system further comprises an equipment management part for generating equipment control information which controls production equipment based on the production implementation information managed by the production implementation management part, and for managing the equipment control information to be corresponding to a change of the production implementation information.

Further, it is a feature that the product producing business reform support system further comprises a business year plan management part for managing business year plan information, and outputting managed business year plan information to the order-receiving plan management part as one order-receiving plan information in the order-receiving plan information which changes.

Moreover, it is a feature that the product producing business reform support system further comprises a development plan management part for inputting the business year plan information from the business year plan management part, managing development plan information on a product based on inputted business year plan information, and outputting managed development plan information to the order-receiving plan management part.

Further, it is a feature that the product producing business reform support system inputs a plurality of prescribed information individually from an external apparatus.

Further, according to the product producing business reform support system of the above Embodiment, it is a feature that the product producing business reform support system comprises:

a business year plan management part for generating business year plan information based on business strategy information in a first period and managing the business year plan information in a second period within the first period;

an order-receiving plan management part for generating order-receiving plan information based on the business year plan information managed by the business year plan management part, and managing the order-receiving plan information in a third period within the second period;

a production plan management part for generating production plan information based on the order-receiving plan information managed by the order-receiving plan management part, and managing the production plan information in a fourth period within the third period;

a production implementation management part for generating production implementation information based on the production plan information managed by the production plan management part, and managing the production implementation information in a fifth period within the fourth period;

an equipment management part for generating equipment control information which controls production equipment, based on the production implementation information managed by the production implementation management part, and managing the equipment control information in a sixth period within the fifth period; and

a display part for displaying at least one of the order-receiving plan information managed by the order-receiving plan management part, the production plan information managed by the production plan management part, the production implementation information managed by the production implementation management part, and the equipment control information managed by the equipment management part, and prompting a user to perform a product producing business reform.

Further, it is a feature that the order-receiving plan information includes expected order plan information which expects an order amount based on business year plan, market order plan information in which an order amount is undecided, and decided order plan information in which an order amount is decided, the expected order plan information changes to the market order plan information, and the market order plan information changes to the decided order plan information, and

the order-receiving plan management part manages product information, cost information and inventory information corresponding to managed order-receiving plan information, and dynamically changes the product information, the cost information, and the inventory information corresponding to the order-receiving plan information, based on a change of the order-receiving plan information, in a case of the order-receiving plan information being the expected order plan information, in a case of the order-receiving plan being the market order plan information, and in a case of the order-receiving plan being the decided order plan information.

Further, it is a feature that the order-receiving plan information includes expected order plan information which expects an order amount based on business year plan,

the order-receiving plan management part stores an order amount, an order-not-decided amount, and a lost order amount corresponding to the expected order plan information, per prescribed unit, and

the display part displays the order amount, the order-not-decided amount, and the lost order amount stored by the order-receiving plan management part, in a graph per prescribed period, and prompts a user to perform sales reinforcement.

Further, it is a feature that the production plan management part manages cost information corresponding to production plan information managed, and

the display part displays the production plan information and the cost information managed by the production plan management part, in a graph per prescribed period, and prompts a user to perform a product producing business reform.

Further, it is a feature that the production plan management part manages the cost information on a product corresponding to managed production plan information per prescribed period, inputs cost actual result information on the product produced before the prescribed period managed, and

the display part displays the cost information managed by the production plan management part and the cost actual result information in a graph to be overlapped, per prescribed period, and prompts a user to perform a product producing business reform.

Further, it is a feature that the production plan management part stores a target value of a cost amount of the product corresponding to the managed production plan information, and

the display part further displays the target value stored by the production plan management part, in the graph, and prompts a user to perform a product producing business reform.

Moreover, it is a feature that the product producing business reform support system further comprises:

an input part for inputting prescribed information; and

a processing part for calculating a value of a prescribed parameter based on the prescribed information inputted by the input part, and deciding a ranking of the prescribed parameter based on the value calculated,

wherein the display part prompts a user to input the prescribed information by the input part, displays the ranking of the prescribed parameter decided by the processing part, in a graph, and prompts the user to perform a market analysis evaluation of business of the product, and

the input part inputs the target value of the cost amount of the product from a user, based on the market analysis evaluation of the business and outputs it to the production plan management part.

Further, it is a feature that the production plan management part sets up a scheduled cost amount of the product corresponding to managed production plan information, and after receiving an order of the product, manages a cost amount required for the product, and

the display part displays warning information in the case that the costs amount managed by the production plan management part exceeds the scheduled cost amount set up by the production plan management part, and calls a user's attention.

Further, it is a feature that the production plan information includes expected production plan information which expects a production quantity based on a business year plan and decided production plan information in which order-receiving is decided, and the expected production plan information changes to the decided production plan information, and

the production plan management part manages product information, cost information, inventory information, and manufacture lead time information corresponding to managed production plan information, and dynamically changes the product information, the cost information, the inventory information, and the manufacture lead time information corresponding to the production plan information, based on a change of the production plan information, in a case of the production plan information being the expected production plan information and in a case of the production plan information being the decided production plan information.

Moreover, it is a feature that the product producing business reform support system further comprises a production plan adjustment control part for generating prescribed priority processing information for adjusting and controlling a production plan based on a prescribed priority processing standard, and the production plan management part inputs the prescribed priority processing information generated by the production plan adjustment control part, and generates production plan information based on input prescribed priority processing information.

Moreover, it is a feature that the product producing business reform support system further comprises:

an input part for inputting prescribed information; and

a processing part for calculating a value of a prescribed parameter based on the prescribed information inputted by the input part, and deciding a ranking of the prescribed parameter based on the value calculated,

wherein the display part prompts a user to input the prescribed information by the input part, displays the ranking of the prescribed parameter decided by the processing part, in a graph, and prompts the user to perform a market analysis evaluation of business of a product,

the input part inputs prescribed priority processing information from a user, based on the market analysis evaluation of the business, and

the production plan management part inputs the prescribed priority processing information inputted by the input part, and generates production plan information based on input prescribed priority processing information.

Further, it is a feature that the production implementation management part includes:

an automatic planning part for automatically generating the production implementation information based on prescribed priority processing information; and

a manual adjustment part for performing a manual adjustment of the production implementation information generated by the automatic planning part, based on adjustment information inputted by a user, and

wherein the display part displays the production implementation information generated by the automatic planning part and prompts a user to input the adjustment information.

Further, it is a feature that the production implementation management part inputs production implementation actual result information which was used when producing a product before, and

the display part displays at least one of the production implementation information generated by the automatic planning part and the production implementation information which was performed manual adjustment by the manual adjustment part, with the production implementation actual result information, on a same screen to be in a chart display.

Moreover, it is a feature that the product producing business reform support system further comprises a procurement plan management part for generating procurement plan information based on the production plan information managed by the production plan management part, and managing the procurement plan information to be corresponding to a change of the production plan information.

Further, it is a feature that the procurement plan management part inputs a procurement lead time and a work starting time/date, calculates a difference of time/date between an inputted work starting time/date and an inputted procurement lead time, and decides a procurement order date based on the difference of time/date calculated.

Further, it is a feature that the procurement plan information includes a number of orders for a prescribed component material, an accumulated order number indicating an accumulated number of orders for the prescribed component material in a past, and a price of the prescribed component material,

the procurement plan management part changes the number of orders for the prescribed component material, the accumulated order number indicating the accumulated number of orders for the prescribed component material in the past, and the price of the prescribed component material, to be corresponding to a change of the production plan information, and

the display part displays the number of orders for the prescribed component material, the accumulated order number indicating the accumulated number of orders for the prescribed component material in the past, and the price of the prescribed component material which were changed by the procurement plan management part, and prompts a user to predict an improvement of the price of the prescribed component material, based-on the number of orders for the prescribed component material and the accumulated order number indicating the accumulated number of orders for the prescribed component material in the past.

Moreover, it is a feature that the product producing business reform support system further comprises an estimation plan management part for generating estimation plan information based on an annual plan information managed by the annual plan management part, and managing the estimation plan information to be corresponding to a change of the annual plan information.

Further, it is a feature that the estimation plan management part further generates estimation plan information based on new business negotiation information.

Further, it is a feature that the estimation plan information is revised a plurality of times, the estimation plan management part manages the estimation plan information revised the plurality of times, and the display part displays the estimation plan information managed by the estimation plan management part and revised the plurality of times, side by side in order of revision, and prompts a user to perform a service improvement relating to an estimation.

As mentioned above, in the present system in the above Embodiment, a means for concretely performing a process reform of the holon 3 at a higher rank management model is performed not only by executing the reform of a business process itself but also by making a plan and management laterally cooperated, as a system, with a business process, a development process, a material process, a production process, a physical distribution process, and a settlement-of accounts process. Therefore, it is possible to effectively connect to a detailed feed forward activity in real time.

Moreover, in the present system, it is possible to integrate various plan data to be unitary, by forming the plan management as a system based on a product composition management model as a target core.

Furthermore, in the present system, data of the various plan management properly includes the original data (underlying assets or original) of a product composition management model <prototype>. Accordingly, it is possible to obtain a flexible structure where unification is attainable by extending data of the minimum item suitable for the purpose one by one.

Moreover, the present system is characterized by being a plan management system applicable to a development and a production of hardware and software in common.

Moreover, in the present system, it is possible to adjust a management intensity of data registration of original data (underlying assets or original) of a product composition management model <prototype> and data of various plan management, by setting up a security level.

Moreover, in the present system, it is possible to directly connect to a concrete activity in real time and in feed forward by grasping a plan value/an actual result value. Then, the present system is characterized by being a plan management system which can be reflected in profit or loss of the business.

Moreover, the present system has a feature that it is a plan management system which can notify a person in charge of a deviation between a plan value and an actual result value, as an alarm, at any place and time in order to prompt the person to take an urgent action, and can grasp an actual result history of the action.

Moreover, the present system is characterized by being a plan management system which can pursue a concrete activity history in a specific item for executing the plan.

Moreover, it is characterized by being a plan management system which can grasp actual result costs and quality costs synchronizing with a progress in a plan execution.

Moreover, the present system is characterized by being a plan management system which can grasp a progress actual result management of hardware and software in detail by breakdown of direct material costs, processing costs, and expenses as management basic data.

Moreover, the present system is characterized by being a plan management system which issues an alarm in real time (management cycle) when data directly linking to management deviates from a plan value, in order to prompt a future measure and improvement.

Moreover, the present system is characterized by being a plan management system in which a production plan is automatically adjusted based on a profit growth and cash flow CF increase.

Moreover, the present system is characterized by being a plan management system in which various priority processing of a production plan can be performed by people though the above-mentioned contents is a basis.

Moreover, the present system is characterized by being a plan management system which can present starting time and date and ending time and date of each business, in order to carry out outsourcing of various business.

Moreover, the present system is characterized by being a plan management system having a strict change management and quality cost management, which can pursue a change of specification and a change history with a plurality of persons concerned, in addition to the management basic data of a progress actual result management of 59 items, in a development process with a high risk as an investment.

Moreover, the present system has a feature that it can be advanced to be a structure of a next-generation plan management system where sending and receiving of all item data, except for registering original data, can be thoroughly automatically performed by defining a document composition.

As stated above, according to the business profit improvement support system of the Embodiment 6, it is a feature that the business profit improvement support system comprises:

a memory part for storing holonic information which reforms a process of business;

a plan management part for making sales process information, development process information, materials process information, production process information, physical distribution process information, and settlement-of-accounts process information cooperate mutually, and for performing a plan management of the process of the business by dynamically changing the sales process information, the development process information, the materials process information, the production process information, the physical distribution process information and the settlement-of-accounts process information; and

a display part for displaying the holonic information stored in the memory part, and the sales process information, the development process information, the materials process information, the production process information, the physical distribution process information and the settlement-of-accounts process information which were dynamically changed by the plan management part, and for prompting a user to perform a profit improvement of the business by way of urging a process reform of the business.

As stated above, according to the product producing business reform support system of the Embodiment 6, it is a feature that the product producing business reform support system comprises:

a memory part for storing a prescribed product composition management model including prescribed plan data;

a plan management part for generating the sales process information, development process information, materials process information, production process information, physical distribution process information, and settlement-of-accounts process information based on the prescribed plan data included in the prescribed product composition management model stored in the memory part, and for performing a plan management for a product producing business, by way of integrating each of the prescribed plan data with generated sales process information, development process information, materials process information, production process information, physical distribution process information, and settlement-of-accounts process information to be unitary; and

a display part for displaying the sales process information, the development process information, the materials process information, the production process information, the physical distribution process information, and the settlement-of-accounts process information which were generated by the plan management part, and for prompting a user to perform a reform of the product production business.

It is a feature that the prescribed product composition management model stored in the memory part includes a plurality of original data which contains each of the prescribed plan data, and the plan management part inputs data of a minimum item suitable for a use, corresponding to each of the prescribed plan data from the prescribed product composition management model stored in the memory part, and extends the each of the prescribed plan data based on inputted data one by one.

It is a feature that the plan management for the product producing business is a plan management applicable to development business and production business of hardware and software in common.

It is a feature that management intensity of registration of the original data of the product composition management model and each of the prescribed plan data can be adjusted by setting up a security level.

It is a feature that the plan management part performs a plan management in which it is possible to directly connect to a concrete activity in real time and in feed forward and to be reflected in profit or loss of the business, by grasping a plan value and an actual result value of the product producing business.

It is a feature that the plan management part performs a plan management which can notify a user of a deviation between a plan value and an actual result value, as an alarm, at any place and time in order to prompt the user to take an urgent action and grasp an actual result history of the urgent action.

It is a feature that the plan management part performs a plan management which can pursue a concrete activity history, in a specific item, for executing a plan.

It is a feature that the plan management part performs a plan management which can grasp actual result costs and quality costs synchronizing with a progress in a plan execution.

It is a feature that the plan management part manages a progress actual result management of the product producing business,

the prescribed product composition management model stored in the memory part includes information of direct material cost, processing cost and expense, as management basic data, and

the plan management part performs a plan management which can grasp a progress actual result management of the product producing business in hardware and software by breakdown of the direct material cost, the processing cost, and the expense, as the management basic data.

It is a feature that the plan management part manages data directly linking to a prescribed management, and the display part issues an alarm in real time when the data, directly linking to the prescribed management and managed by the plan management part, deviates from a prescribed plan value, in order to prompt a future measure and improvement.

It is a feature that the production plan information is automatically adjusted with giving priority to a profit growth and a cash flow increase.

It is a feature that the production plan management part can make a user perform various priority processing.

It is a feature that the display part is structured to be able to present a start time/date and an end time/date of each business, in order to carry out outsourcing of various business.

It is a feature that the plan management part manages a progress actual result management of the product producing business,

the prescribed product composition management model stored in the memory part includes information of direct material cost, processing cost and expense, as management basic data, and

the plan management part performs a change management and a quality cost management which can pursue a change of specification and a change history with a plurality of users, in a case of a development process with a high risk as an investment.

It is a feature that the product producing business reform support system can be advanced to be a structure of a next-generation plan management system where sending and receiving of all item data, except for registering original data, can be thoroughly automatically performed by defining a document composition.

In the above explanation, the business profit improvement support system or the product producing business reform support system in each of the Embodiments can be a computer apparatus, such as a server apparatus.

In the above explanation, what is explained as a “- part” in each of Embodiments can be partly or totally structured by a program which can be operated by a computer. These programs are executed by a CPU (Central Processing Unit) of a computer. Moreover, these programs can be created by C language, for instance. It is also acceptable to apply HTML, SGML, or XML. It is also acceptable to perform a screen display using JAVA (registered trademark).

Moreover, what is explained as a “- part” in each of Embodiments can be realized by firmware stored in ROM (Read Only Memory). It is also acceptable to execute by software, hardware, or a combination of software, hardware and firmware.

Moreover, the program which executes each of Embodiments can be stored in a recording medium, such as a magnetic disk drive and FDD (Flexible Disk).

Moreover, as to a display part, it is also acceptable to use a CRT display apparatus, other display apparatus, or an apparatus for outputting, such as a printer. As to the recording medium, a recording apparatus by other recording medium, such as an optical disc, CD, can be used instead of a magnetic disk drive.

### INDUSTRIAL APPLICABILITY

According to a preferred Embodiment of the present invention, it is possible to provide a structure where a business failure can be prevented, the current business contents, plan and target is analyzed and judged, from the viewpoint of market competitive power, whether it is satisfactory to promote the current business, course amending is requested if necessary, and an exact activity can be led to people and an organization.

According to a preferred Embodiment of the present invention, it is possible to have a business analysis plot which strictly performs an assessment and an analysis for ranking the business in the current market.

According to a preferred Embodiment of the present invention, after grasping the ranking of the business analysis plot, it is possible to raise four sorts of holons which can carry out a profit improvement and a reform of the business in a reasonable (economic rationality) form, as four sorts of solid strategies.

According to a preferred Embodiment of the present invention, it is possible to have the following processes: to plan activity items based on breakdown measures depending upon four sorts of holons (solid strategy), to perform giving priority to activities in view of a quantitative effect prediction and an expected risk, to decide the plan being the optimum at the current point (simulation is suitably carried out), and to register it in the profit improvement amount as management data.

According to a preferred Embodiment of the present invention, in executing the activity of the profit improvement, it is possible to have a dynamic production plan adjustment control and an investment risk adjustment control as an adjustment function used as a key, and to conquer a difficult subject linking directly to profit growth.

According to a preferred Embodiment of the present invention, it is possible to perform a management measure and an activity again which can be suitably reacted by a series of cycles, depending upon a change and a reform of the market conditions, even at the time of activity execution, and to continuously realize a business profit improvement.

Moreover, since items are intensively and advancedly systematized based on the framework and the architecture of the present system, as long as the document composition of data is appropriately defined, all of the present system can be automatic, except for an original data registration in which people intervene.

1. A business profit improvement support system which prompts a user to perform a market analysis evaluation of business and supports profit improvement of the business comprising:
an input part for inputting prescribed information;
a processing part for calculating a value of a prescribed parameter based on the prescribed information inputted by the input part, and determining a ranking of the prescribed parameter based on the value calculated, and
a display part for prompting the user to input the prescribed information by the input part, displaying the ranking of the prescribed parameter determined by the processing part in a graph, and prompting the user to perform the market analysis evaluation of the business.

2. The business profit improvement support system of claim 1, wherein the prescribed parameter includes, with reference to the business, a competitive dominance degree and a market growth degree.

3. The business profit improvement support system of claim 2,
wherein the prescribed information includes, with reference to the business, ranking information on a sales volume growth degree and ranking information on a profit growth degree, and
the processing part calculates a value of the market growth degree, by using the ranking information on the sales volume growth degree and the ranking information on the profit growth degree and depending upon a prescribed standard, and determines ranking of the market growth degree based on a calculated value.

4. The business profit improvement support system of claim 2,
wherein the prescribed information includes, with reference to the business, ranking information on a plurality of sales volume growth degrees and ranking information on a plurality of profit growth degrees,
the input part inputs ranking information on one sales volume growth degree in the ranking information on the plurality of sales volume growth degrees and ranking information on one profit growth degree in the ranking information on the plurality of profit growth degrees,
the processing part allots a prescribed value to each of the ranking information on the plurality of sales volume growth degrees, the ranking information on the plurality of profit growth degrees, ranking information on each sales volume growth degree in the ranking information on the plurality of sales volume growth degrees, and ranking information on each profit growth degree in the ranking information on the plurality of profit growth degrees respectively,
obtains an added value by adding a multiplied value calculated by multiplying a value allotted to the ranking information on the plurality of sales volume growth degrees by a value allotted to the ranking information on the one sales volume growth degree inputted by the input part, and a multiplied value calculated by multiplying a value allotted to the ranking information on the plurality of profit growth degrees by a value allotted to the ranking information on the one profit growth degree inputted by the input part, and
ranks the market growth degree at a position to which the added value belongs.

5. The business profit improvement support system of claim 2,
wherein the prescribed information includes, with reference to the business, ranking information on a customer evaluation, ranking information on cash flow, and ranking information on a profit improvement rate, and
the processing part calculates a value of the competitive dominance degree by using the ranking information on the customer evaluation, the ranking information on the cash flow, and the ranking information on the profit improvement rate and depending upon a prescribed standard, and determines a ranking of the competitive dominance degree based on a calculated value.

6. The business profit improvement support system of claim 2,
wherein the prescribed information includes, with reference to the business, ranking information on a plurality of customer quality evaluations, ranking information on a plurality of customer costs evaluations, ranking information on a plurality of customer delivery deadline evaluations, ranking information on a plurality of cash flow, and ranking information on a plurality of profit improvement rates,
the input part inputs ranking information on one customer quality evaluation in the ranking information on the plurality of customer quality evaluations, ranking information on one customer costs evaluation in the ranking information on the plurality of customer costs evaluations, ranking information on one customer delivery deadline evaluation in the ranking information on the plurality of customer delivery deadline evaluations, ranking information on one cash flow in the ranking information on the plurality of cash flow and ranking information on one profit improvement rate in the ranking information on the plurality of profit improvement rates, and
the processing part allots a prescribed value to each of the ranking information on the plurality of customer quality evaluations, ranking information on each customer quality evaluation in the ranking information on the plurality of customer quality evaluations, the ranking information on the plurality of customer costs evaluations, ranking information on each customer costs evaluation in the ranking information on the plurality of customer costs evaluations, the ranking information on the plurality of customer delivery deadline evaluations, ranking information on each customer delivery deadline evaluation in the ranking information on the plurality of customer delivery deadline evaluations, the ranking information on the plurality of cash flow, ranking information on each cash flow in the ranking information on the plurality of cash flow, the ranking information on the plurality of profit improvement rates, and ranking information on each profit improvement rate in the ranking information on the plurality of profit improvement rates respectively,
obtains an added value by adding a multiplied value calculated by multiplying a value allotted to the ranking information on the plurality of customer quality evaluations by a value allotted to the ranking information on the one customer quality evaluation inputted by the input part,
a multiplied value calculated by multiplying a value allotted to the ranking information on the plurality of customer costs evaluations by a value allotted to the ranking information on the one customer costs evaluation inputted by the input part,
a multiplied value calculated by multiplying a value allotted to the ranking information on the plurality of customer delivery deadline evaluations by a value allotted to the ranking information on the one customer delivery deadline evaluation inputted by the input part,
a multiplied value calculated by multiplying a value allotted to the ranking information on the plurality of cash flow by a value allotted to the ranking information on the one cash flow inputted by the input part, and
a multiplied value calculated by multiplying a value allotted to the ranking information on the plurality of profit improvement rates by a value allotted to the ranking information on the one profit improvement rate inputted by the input part, and
ranks the competitive dominance degree at a position to which the added value belongs.

7. The business profit improvement support system of claim 1, further comprising:
a memory part for storing a first holonic information which improves throughput of business, a second holonic information which improves assets turnover of the business, a third holonic information which reforms a process of the business, and a fourth holonic information which reforms a product of the business, wherein
the input part inputs a current value corresponding to at least one of the first through the fourth holonic information stored in the memory part from an external apparatus, and inputs a target value corresponding to the current value, from a user, and
the processing part calculates an improvement value corresponding to the current value and the target value, based on the current value and the target value inputted by the input part.

8. The business profit improvement support system of claim 7,
wherein the first holonic information includes, with reference to the business, at least one of part material cost reduction information, production process improvement information, and sales volume growth information based on a sales promotion,
the second holonic information includes, with reference to the business, at least one of production process lead time improvement information, inventory improvement information based on a production plan adjustment, and funds collection information,
the third holonic information includes, with reference to the business, at least one of reform process domain range information, process lead time reduction information, and business costs reform information based on a process cost reduction, and
the fourth holonic information includes, with reference to the business, at least one of product development strategy information, continuous development information, and new development information.

9. The business profit improvement support system of claim 7,
wherein the display part prompts a user to perform a business profit improvement activity based on the first through the fourth holonic Information corresponding to the target value, and to input progress information based on the business profit improvement activity,
the input part inputs the progress information, and
the processing part calculates a target value corresponding to the progress information, based on the progress information inputted by the input part.

10. The business profit improvement support system of claim 9,
wherein the processing part calculates, based on the current value inputted by the input part and a calculated target value corresponding to the progress information, an improvement value corresponding to the current value and the calculated target value corresponding to the progress information.

11. The business profit improvement support system of claim 9,
wherein the display part displays a calculated target value corresponding to the progress information and calculated by the processing part, and prompts a user to input recognition information for a displayed target value corresponding to the progress information,
the input part inputs the recognition information from the user, and
the processing part converts the current value inputted by the input part into the calculated target value corresponding to the progress information, based on the recognition information inputted by the input part.

12. The business profit improvement support system of claim 11,
wherein the display part displays a converted current value converted by the processing part and a calculated improvement value corresponding to the current value and the calculated target value corresponding to the progress information.

13. The business profit improvement support system of claim 1,
wherein the business profit improvement support system supports profit improvement of the business, based on a production plan of a product corresponding to the business,
the business profit improvement support system further comprising:
a production plan adjustment control part for controlling the production plan, based on at least one of demand information, component material information, production load information, and physical distribution information.

14. The business profit improvement support system of claim 13,
wherein the production plan adjustment control part calculates a production throughput value of the product, based on at least one of the component material information, the production load information, and the physical distribution information, and when a plurality of the products exist, controls the production plan to give priority to the product with a calculated production throughput value being large.

15. The business profit improvement support system of claim 14,
wherein the component material information includes part procurement lead time information,
the production load information includes lead time information on a plurality of production processes, and restriction time information on between a production process and a production process in the plurality of production processes,
the physical distribution information includes delivery time information, and
the production plan adjustment control part calculates the production throughput value of the product, based on the part procurement lead time information, the lead time information on the plurality of production processes, the restriction time information on between a production process and a production process in the plurality of production processes, and the delivery time information.

16. The business profit improvement support system of claim 1,
wherein the business profit improvement support system supports profit improvement of the business based on investment measures corresponding to the business,
the business profit improvement support system further comprising:
an investment adjustment control part for controlling the investment measures, based on investment amount information and accumulated profit information.

17. The business profit improvement support system of claim 16,
wherein the business profit improvement support system allots a prescribed value to be corresponding to a plurality of periods in progression and each of the plurality of periods,
the input part inputs an investment amount and a profit amount corresponding to each of the plurality of periods,
the investment adjustment control part calculates an accumulated profit amount which accumulates, per period, a multiplied value calculated by multiplying the profit amount corresponding to each of the plurality of periods by the prescribed value corresponding to the plurality of periods, and
the display part displays the plurality of periods, an investment amount corresponding to each of the plurality of periods, and the accumulated profit amount calculated by the investment adjustment control part.

18. The business profit improvement support system of claim 17,
wherein the display part displays the plurality of periods, the investment amount corresponding to each of the plurality of periods, and the accumulated profit amount calculated by the investment adjustment control part, in a second dimension coordinate in which one is a time axis and another is an investment amount axis and accumulated profit amount axis.

19. The business profit improvement support system of claim 7,
wherein the first holonic information includes, with reference to the business, at least one of defect removal rate improvement information and software development man-day improvement information, and
the second holonic information includes, with reference to the business, at least one of software part circulation number-of-times information and funds collection information.

20. The business profit improvement support system of claim 1, further comprising:
a memory part for storing a first holonic information which improves throughput of the business, a second holonic information which improves assets turnover of the business, a third holonic information which reforms a process of the business, and a fourth holonic information which reforms a product of the business, wherein
the input part inputs expected risk information corresponding to at least one of the first through the fourth holonic information stored in the memory part,
the processing part calculates a prescribed value based on the expected risk information inputted by the input part, and
the display part displays the prescribed value calculated by the processing part, with at least one of the first through the fourth holonic information corresponding to the prescribed value, stored in the memory part, and prompts a user to perform profit improvement of the business.

21. The business profit improvement support system of claim 20,
wherein the expected risk information is at least one of maturity degree information on an object model and difficulty degree information on the object model.

22. The business profit improvement support system of claim 21,
wherein the maturity degree information on the object model relates to development of software, and includes
first level information which shows a ranking indicating that, after a specification of the software having been determined, the software corresponding to the specification having been determined can be realizable by using an existing software,
second level information which shows a ranking indicating that, after a specification of the software having been determined, the software corresponding to the specification having been determined is similar to an existing software,
third level information which shows a ranking indicating that, after a specification of the software having been determined, the software corresponding to the specification having been determined needs new software development,
fourth level information which shows a ranking indicating that, after an outline of a specification of the software having been determined, the software corresponding to the outline of the specification having been determined needs new software development, and
fifth level information which shows a ranking indicating that an outline of a specification of the software has not been determined.

23. The business profit improvement support system of claim 21,
wherein the difficulty degree information on the object model relates to development of software and includes a plurality of difficulty degree ranking information, based on a plurality of logic degree rankings of the software and a plurality of data amount rankings of the software.

24. The business profit improvement support system of claim 20,
wherein the expected risk information includes maturity degree information on an object model, and difficulty degree information on the object model,
the maturity degree information on the object model includes a plurality of maturity degree ranking information,
the difficulty degree information on the object model includes a plurality of difficulty degree ranking information,
the input part inputs one of the plurality of maturity degree ranking information and one of the plurality of difficulty degree ranking information, and
the processing part allots a prescribed value to each of the plurality of maturity degree ranking information, allots a prescribed value to each of the plurality of difficulty degree ranking information, and calculates a value by at least multiplying a value corresponding to the one of the plurality of maturity degree ranking information inputted by the input part by a value corresponding to the one of the plurality of difficulty degree ranking information inputted by the input part.

25. The business profit improvement support system of claim 24,
wherein the processing part includes a prescribed adjustment value for adjusting adequacy of a calculated value, and calculates a value by multiplying the value corresponding to the one of the plurality of maturity degree ranking information inputted by the input part, the value corresponding to the one of the plurality of difficulty degree ranking information inputted by the input part, and the prescribed adjustment value together.

26. A product producing business reform support system comprising:
an order-receiving plan management part for managing order-receiving plan information which changes;
a production plan management part for generating production plan information based on the order-receiving plan information managed by the order-receiving plan management part, and managing the production plan information corresponding to a change of the order-receiving plan information;
a production implementation management part for generating production implementation information based on the production plan information managed by the production plan management part, and managing the production implementation information corresponding to a change of the production plan information; and
a display part for displaying at least one of the order-receiving plan information managed by the order-receiving plan management part, the production plan information managed by the production plan management part, and the production implementation information managed by the production implementation management part, and for prompting a user to perform a product producing business reform.

27. The product producing business reform support system of claim 26, further comprising an equipment management part for generating equipment control information which controls production equipment based on the production implementation information managed by the production implementation management part, and for managing the equipment control information to be corresponding to a change of the production implementation information.

28. The product producing business reform support system of claim 26, further comprising a business year plan management part for managing business year plan information, and outputting managed business year plan information to the order-receiving plan management part as one order-receiving plan information in the order-receiving plan information which changes.

29. The product producing business reform support system of claim 28, further comprising a development plan management part for inputting the business year plan information from the business year plan management part, managing development plan information on a product based on inputted business year plan information, and outputting managed development plan information to the order-receiving plan management part.

30. The product producing business reform support system of claim 26, wherein the product producing business reform support system inputs a plurality of prescribed information individually from an external apparatus.

31. A product producing business reform support system comprising:
a business year plan management part for generating business year plan information based on business strategy information in a first period and managing the business year plan information in a second period within the first period;
an order-receiving plan management part for generating order-receiving plan information based on the business year plan information managed by the business year plan management part, and managing the order-receiving plan information in a third period within the second period;
a production plan management part for generating production plan information based on the order-receiving plan information managed by the order-receiving plan management part, and managing the production plan information in a fourth period within the third period;
a production implementation management part for generating production implementation information based on the production plan information managed by the production plan management part, and managing the production implementation information in a fifth period within the fourth period;
an equipment management part for generating equipment control information which controls production equipment, based on the production implementation information managed by the production implementation management part, and managing the equipment control information in a sixth period within the fifth period; and
a display part for displaying at least one of the order-receiving plan information managed by the order-receiving plan management part, the production plan information managed by the production plan management part, the production implementation information managed by the production implementation management part, and the equipment control information managed by the equipment management part, and prompting a user to perform a product producing business reform.

32. The product producing business reform support system of the claim 26, wherein the order-receiving plan information includes expected order plan information which expects an order amount based on business year plan, market order plan information in which an order amount is undecided, and decided order plan information in which an order amount is decided, the expected order plan information changes to the market order plan information, and the market order plan information changes to the decided order plan information, and
the order-receiving plan management part manages product information, cost information and inventory information corresponding to managed order-receiving plan information, and dynamically changes the product information, the cost information, and the inventory information corresponding to the order-receiving plan information, based on a change of the order-receiving plan information, in a case of the order-receiving plan information being the expected order plan information, in a case of the order-receiving plan being the market order plan information, and in a case of the order-receiving plan being the decided order plan information.

33. The product producing business reform support system of the claim 26, wherein the order-receiving plan information includes expected order plan information which expects an order amount based on business year plan,
the order-receiving plan management part stores an order amount, an order-not-decided amount, and a lost order amount corresponding to the expected order plan information, per prescribed unit, and
the display part displays the order amount, the order-not-decided amount, and the lost order amount stored by the order-receiving plan management part, in a graph per prescribed period, and prompts a user to perform sales reinforcement.

34. The product producing business reform support system of the claim 33, wherein the production plan management part manages cost information corresponding to production plan information managed, and
the display part displays the production plan information and the cost information managed by the production plan management part, in a graph per prescribed period, and prompts a user to perform a product producing business reform.

35. The product producing business reform support system of the claim 34, wherein the production plan management part manages the cost information on a product corresponding to managed production plan information per prescribed period, inputs cost actual result information on the product produced before the prescribed period managed, and
the display part displays the cost information managed by the production plan management part and the cost actual result information in a graph to be overlapped, per prescribed period, and prompts a user to perform a product producing business reform.

36. The product producing business reform support system of the claim 35, wherein the production plan management part stores a target value of a cost amount of the product corresponding to the managed production plan information, and
the display part further displays the target value stored by the production plan management part, in the graph, and prompts a user to perform a product producing business reform.

37. The product producing business reform support system of claim 36, further comprising:
an input part for inputting prescribed information; and
a processing part for calculating a value of a prescribed parameter based on the prescribed information inputted by the input part, and deciding a ranking of the prescribed parameter based on the value calculated,
wherein the display part prompts a user to input the prescribed information by the input part, displays the ranking of the prescribed parameter decided by the processing part, in a graph, and prompts the user to perform a market analysis evaluation of business of the product, and
the input part inputs the target value of the cost amount of the product from a user, based on the market analysis evaluation of the business and outputs it to the production plan management part.

38. The product producing business reform support system of claim 26, wherein the production plan management part sets up a scheduled cost amount of the product corresponding to managed production plan information, and after receiving an order of the product, manages a cost amount required for the product, and
the display part displays warning information in the case that the costs amount managed by the production plan management part exceeds the scheduled cost amount set up by the production plan management part, and calls a user's attention.

39. The product producing business reform support system of the claim 26, wherein the production plan information includes expected production plan information which expects a production quantity based on a business year plan and decided production plan information in which order-receiving is decided, and the expected production plan information changes to the decided production plan information, and
the production plan management part manages product information, cost information, inventory information, and manufacture lead time information corresponding to managed production plan information, and dynamically changes the product information, the cost information, the inventory information, and the manufacture lead time information corresponding to the production plan information, based on a change of the production plan information, in a case of the production plan information being the expected production plan information and in a case of the production plan information being the decided production plan information.

40. The product producing business reform support system of the claim 26, further comprising a production plan adjustment control part for generating prescribed priority processing information for adjusting and controlling a production plan based on a prescribed priority processing standard,
wherein the production plan management part inputs the prescribed priority processing information generated by the production plan adjustment control part, and generates production plan information based on input prescribed priority processing information.

41. The product producing business reform support system of claim 26, further comprising:
an input part for inputting prescribed information; and
a processing part for calculating a value of a prescribed parameter based on the prescribed information inputted by the input part, and deciding a ranking of the prescribed parameter based on the value calculated,
wherein the display part prompts a user to input the prescribed information by the input part, displays the ranking of the prescribed parameter decided by the processing part, in a graph, and prompts the user to perform a market analysis evaluation of business of a product,
the input part inputs prescribed priority processing information from a user, based on the market analysis evaluation of the business, and
the production plan management part inputs the prescribed priority processing information inputted by the input part, and generates production plan information based on input prescribed priority processing information.

42. The product producing business reform support system of claim 26, wherein the production implementation management part includes:
an automatic planning part for automatically generating the production implementation information based on prescribed priority processing information; and
a manual adjustment part for performing a manual adjustment of the production implementation information generated by the automatic planning part, based on adjustment information inputted by a user, and
wherein the display part displays the production implementation information generated by the automatic planning part and prompts a user to input the adjustment information.

43. The product producing business reform support system of claim 42, wherein the production implementation management part inputs production implementation actual result information which was used when producing a product before, and
the display part displays at least one of the production implementation information generated by the automatic planning part and the production implementation information which was performed manual adjustment by the manual adjustment part, with the production implementation actual result information, on a same screen to be in a chart display.

44. The product producing business reform support system of the claim 26, further comprising a procurement plan management part for generating procurement plan information based on the production plan information managed by the production plan management part, and managing the procurement plan information to be corresponding to a change of the production plan information.

45. The product producing business reform support system of the claim 44, wherein the procurement plan management part inputs a procurement lead time and a work starting time/date, calculates a difference of time/date between an inputted work starting time/date and an inputted procurement lead time, and decides a procurement order date based on the difference of time/date calculated.

46. The product producing business reform support system of the claim 44, wherein the procurement plan information includes a number of orders for a prescribed component material, an accumulated order number indicating an accumulated number of orders for the prescribed component material in a past, and a price of the prescribed component material,
the procurement plan management part changes the number of orders for the prescribed component material, the accumulated order number indicating the accumulated number of orders for the prescribed component material in the past, and the price of the prescribed component material, to be corresponding to a change of the production plan information, and
the display part displays the number of orders for the prescribed component material, the accumulated order number indicating the accumulated number of orders for the prescribed component material in the past, and the price of the prescribed component material which were changed by the procurement plan management part, and prompts a user to predict an improvement of the price of the prescribed component material, based on the number of orders for the prescribed component material and the accumulated order number indicating the accumulated number of orders for the prescribed component material in the past.

47. The product producing business reform support system of the claim 26, further comprising an estimation plan management part for generating estimation plan information based on an annual plan information managed by the annual plan management part, and managing the estimation plan information to be corresponding to a change of the annual plan information.

48. The product producing business reform support system of the claim 47, wherein the estimation plan management part further generates estimation plan information based on new business negotiation information.

49. The product producing business reform support system of the claim 47, wherein the estimation plan information is revised a plurality of times, the estimation plan management part manages the estimation plan information revised the plurality of times, and the display part displays the estimation plan information managed by the estimation plan management part and revised the plurality of times, side by side in order of revision, and prompts a user to perform a service improvement relating to an estimation.

50. A business profit improvement support system comprising:
a memory part for storing holonic information which reforms a process of business;
a plan management part for making sales process information, development process information, materials process information, production process information, physical distribution process information, and settlement-of-accounts process information cooperate mutually, and for performing a plan management of the process of the business by dynamically changing the sales process information, the development process information, the materials process information, the production process information, the physical distribution process information and the settlement-of-accounts process information; and
a display part for displaying the holonic information stored in the memory part, and the sales process information, the development process information, the materials process information, the production process information, the physical distribution process information and the settlement-of-accounts process information which were dynamically changed by the plan management part, and for prompting a user to perform a profit improvement of the business by way of urging a process reform of the business.

51. A product producing business reform support system comprising:
a memory part for storing a prescribed product composition management model including prescribed plan data;
a plan management part for generating the sales process information, development process information, materials process information, production process information, physical distribution process information, and settlement-of-accounts process information based on the prescribed plan data included in the prescribed product composition management model stored in the memory part, and for performing a plan management for a product producing business, by way of integrating each of the prescribed plan data with generated sales process information, development process information, materials process information, production process information, physical distribution process information, and settlement-of-accounts process information to be unitary; and
a display part for displaying the sales process information, the development process information, the materials process information, the production process information, the physical distribution process information, and the settlement-of-accounts process information which were generated by the plan management part, and for prompting a user to perform a reform of the product production business.

52. The product producing business reform support system of the claim 51, wherein the prescribed product composition management model stored in the memory part includes a plurality of original data which contains each of the prescribed plan data, and
the plan management part inputs data of a minimum item suitable for a use, corresponding to each of the prescribed plan data from the prescribed product composition management model stored in the memory part, and extends the each of the prescribed plan data based on inputted data one by one.

53. The product producing business reform support system of the claim 51, wherein the plan management for the product producing business is a plan management applicable to development business and production business of hardware and software in common.

54. The product producing business reform support system of claim 52, wherein management intensity of registration of the original data of the product composition management model and each of the prescribed plan data can be adjusted by setting up a security level.

55. The product producing business reform support system of claim 51, wherein the plan management part performs a plan management in which it is possible to directly connect to a concrete activity in real time and in feed forward and to be reflected in profit or loss of the business, by grasping a plan value and an actual result value of the product producing business.

56. The product producing business reform support system of claim 51, wherein the plan management part performs a plan management which can notify a user of a deviation between a plan value and an actual result value, as an alarm, at any place and time in order to prompt the user to take an urgent action and grasp an actual result history of the urgent action.

57. The product producing business reform support system of claim 51, wherein the plan management part performs a plan management which can pursue a concrete activity history, in a specific item, for executing a plan.

58. The product producing business reform support system of claim 51, wherein the plan management part performs a plan management which can grasp actual result costs and quality costs synchronizing with a progress in a plan execution.

59. The product producing business reform support system of claim 51, wherein the plan management part manages a progress actual result management of the product producing business,
the prescribed product composition management model stored in the memory part includes information of direct material cost, processing cost and expense, as management basic data, and
the plan management part performs a plan management which can grasp a progress actual result management of the product producing business in hardware and software by breakdown of the direct material cost, the processing cost, and the expense, as the management basic data.

60. The product producing business reform support system of claim 51, wherein the plan management part manages data directly linking to a prescribed management, and
the display part issues an alarm in real time when the data, directly linking to the prescribed management and managed by the plan management part, deviates from a prescribed plan value, in order to prompt a future measure and improvement.

61. The product producing business reform support system of claim 26, wherein the production plan information is automatically adjusted with giving priority to a profit growth and a cash flow increase.

62. The product producing business reform support system of claim 61, wherein the production plan management part can make a user perform various priority processing.

63. The product producing business reform support system of claim 26, wherein the display part is structured to be able to present a start time/date and an end time/date of each business, in order to carry out outsourcing of various business.

64. The product producing business reform support system of claim 51, wherein the plan management part manages a progress actual result management of the product producing business,
the prescribed product composition management model stored in the memory part includes information of direct material cost, processing cost and expense, as management basic data, and
the plan management part performs a change management and a quality cost management which can pursue a change of specification and a change history with a plurality of users, in a case of a development process with a high risk as an investment.

65. The product producing business reform support system of claim 52, wherein the product producing business reform support system can be advanced to be a structure of a next-generation plan management system where sending and receiving of all item data, except for registering original data, can be thoroughly automatically performed by defining a document composition.
